(19) United States
(12) Patent Application Publication
(10) Pub. No.: US 2017/0300657 A1
(43) Pub. Date: Oct. 19, 2017

(54) Computerized Event Simulation Using Synthetic Populations

(71) Applicant: Virginia Polytechnic Institute and State University, Blacksburg, VA (US)

(72) Inventors: Christopher L. Barrett, Blacksburg, VA (US); Madhav V. Marathe, Blacksburg, VA (US)

(21) Appl. No.: 15/487,929

(22) Filed: Apr. 14, 2017

Related U.S. Application Data
(60) Provisional application No. 62/322,791, filed on Apr. 14, 2016.

(51) Int. Cl. G06F 19/00; G06F 17/30

(52) U.S. Cl. CPC G06F 19/3437; G06F 17/30424; G06F 19/345

(57) ABSTRACT

Systems, methods, and computer-readable media for simulating the course of an event are provided. A processing unit can receive attributes of a synthetic population and select a synthetic-population graph from a data library based at least in part on the attributes. The processing unit can receive data of an intervention designed to affect the course of the event. The processing unit can then simulate the course of the event in the synthetic-population graph to produce an estimate of the event, based at least in part on the intervention. The event can include an epidemic, and the intervention can include vaccination, facility closures, or medication, in some examples. In some examples, the data library can include a social-contact graph determined at least in part by a broker software module.

### CROSS-REFERENCE TO RELATED APPLICATIONS

This application is a nonprovisional application of, and claims priority to and the benefit of, U.S. Provisional Patent Application Ser. No. 62/322,791, filed Apr. 14, 2016, and entitled “Epidemic Analysis System,” the entirety of which is incorporated herein by reference.

### BACKGROUND

The progress of an epidemic or other extended-duration event can be subject to a wide variety of influences. Consequently, it can be difficult to forecast the progress of such events. Moreover, it can be difficult to determine, based on information about an event, whether or how the progress or consequences of an event can be modified.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items. The attached drawings are for purposes of illustration and are not necessarily to scale. For brevity of illustration, in the diagrams herein, an arrow beginning with a diamond connects a first component or operation (at the diamond end) to at least one second component or operation that is or can be included in the first component or operation.

FIG. 1 is a block diagram illustrating an analysis system according to some implementations.

FIG. 2 is a block diagram illustrating components of an analysis system according to some implementations.

FIG. 3 is a dataflow diagram illustrating an example process for determining an epidemic estimate.

FIG. 4 is a dataflow diagram illustrating example processes for determining or reporting epidemic estimates.

FIG. 5 is a dataflow diagram illustrating example processes for determining an epidemic estimate.

FIG. 6 is a dataflow diagram illustrating an example process for determining an estimate of the course of an event.

FIG. 7 is a dataflow diagram illustrating example processes for determining an event estimate.

FIG. 8 is a dataflow diagram illustrating example processes for determining an event estimate.

FIG. 9 is a dataflow diagram illustrating example processes for determining or reporting event estimates.

FIG. 10 is a dataflow diagram illustrating an example process for determining an epidemic estimate.

FIG. 11 is a dataflow diagram illustrating an example process for determining an epidemic estimate.

FIG. 12 shows an example user interface providing an overview of experiment status.

FIG. 13 shows an example user interface providing results of an experiment.

FIG. 14 shows an example user interface providing an overview of experiment status, and showing different disease models than those shown in FIG. 12.

FIG. 15 shows an example user interface permitting a user to specify parameters of an experiment.

FIG. 16 shows an example user interface after selection of parameters on FIG. 15.

FIG. 17 shows an example user interface providing permitting a user to specify additional parameters of an experiment.

FIG. 18 shows an example user interface permitting a user to specify data of an intervention.

FIG. 19 shows an example user interface permitting a user to specify details of a trigger.

FIG. 20 shows an example user interface permitting a user to specify a sweep of parameters of a simulation.

FIG. 21 shows an example user interface providing an overview of “cells,” i.e., different sets of experimental conditions to be tested.

FIG. 22 shows an example user interface permitting a user to specify initial conditions of an experiment.

FIG. 23 shows an example user interface permitting a user to specify parameters of at least one analysis to be performed.

FIG. 24 shows an example user interface permitting a user to specify which cells are to be used in an analysis.

FIG. 25 shows an example user interface presenting results (e.g., analysis) of an experiment.

FIG. 26 shows another example user interface presenting results (e.g., analysis) of an experiment.

FIG. 27 shows an architectural diagram of an example analysis system.

FIG. 28 shows a database schema of job and heartbeat tables in a cluster-management system.

FIG. 29 shows a class diagram of an Application Programming Interface, API, for submitting jobs to a cluster.

FIG. 30 shows a class diagram of an API for scheduling jobs.

FIG. 31 shows a class diagram of an API for defining rules to be used in executing jobs.

FIG. 32 shows a class diagram of an API for use in executing jobs.

FIG. 33A shows a portion of a class diagram of an API for a high-performance computing (HPC) cluster.

FIG. 33B shows a portion of a class diagram of an API for a high-performance computing (HPC) cluster.

FIG. 34 shows a flow of operations involved in executing a job, e.g., using components shown in FIG. 27.

FIG. 35 shows an architectural diagram of an example analysis system.

FIG. 36 shows an example synthetic-population graph (left) including, as components, a social-contact graph (center) and a people-location graph (right).

FIG. 37 shows an example of spread of an epidemic through a synthetic-population graph over time. Circles represent nodes and lines represent edges. Lightly-hatched circles represent uninfected entities, medium-density circles represent infected entities, and darkly-hatched circles represent recovered entities.

FIG. 38 illustrates an organizational chart for a situation analysis system, according to at least one example embodiment.

FIG. 39A illustrates a flow diagram showing the flow and structure of information using the situation analysis system, according to at least one example embodiment.

FIG. 39B illustrates a flow diagram of a process that may be used by the situation analysis system to construct a synthetic population, according to at least one example embodiment.

FIG. 39C illustrates an example of the flow of information described in FIGS. 2A and 2B using the situation analysis system, according to at least one example embodiment.

FIG. 39D illustrates an example of the flow of information that may be used to allocate spectrum, according to at least one example embodiment.

FIG. 40 illustrates a hierarchical block diagram showing components of a synthetic data set subsystem of the situation analysis system, according to at least one example embodiment.

FIG. 41A illustrates a flow diagram showing an example data retrieval and broker spawning process that may be performed by the synthetic data set subsystem, according to at least one example embodiment.

FIGS. 41B through 41D illustrate three example broker structures showing different ways the synthetic data set subsystem may partition information using brokers, according to at least one example embodiment.

FIG. 41E illustrates a diagram of a control structure relating to a management module of the synthetic data set subsystem, according to at least one example embodiment.

FIG. 42 illustrates a flow diagram for a process that may be used by a population construction module of the synthetic data set subsystem to create and/or modify a synthetic population, according to at least one example embodiment.

FIG. 43 illustrates a sample user interface that may be utilized by a user to interact with the situation analysis system, according to at least one example embodiment.

### DETAILED DESCRIPTION

### Overview

Various examples relate generally to the field of computerized analysis systems. Various examples relate to systems for analyzing events or other complex situations, such as for conducting epidemiological studies.

Various example embodiments provide systems and methods for performing epidemiological disease studies using graph simulations (e.g., social-interaction graph simulations). Example implementations provide a specialized, high-level interface to a sophisticated, population-based, synthetic information platform and may be geared toward the quantitative evaluation of the combined effects of behavior, interventions, resource management, and policy in domains such as public health and national security. The embodiments presented herein may be modified for use for a large class of infectious diseases and may be applied to any type of population segment. Various embodiments provide the ability to carry out experiments for situation assessment, forecasting, decision support, intervention efficacy analysis, and various other purposes. For example, some implementations herein may be used to evaluate interventions that can be employed by public health analysts or others to address epidemics.

Various examples can permit estimating the course of an event, e.g., an extended event that goes on over a period of time, or a point-in-time event that has consequences that extend over time or occur after the event itself. For point-in-time events, the “course of the event” as used herein includes a time period after the event during which the consequences of the event occur or play out. Events can include epidemics, e.g., Ebola, influenza, SARS, Zika, or other infectious diseases. Additionally or alternatively, events can include life-changing events, such as changing jobs, relocating, adding a child to a family (e.g., by birth or adoption), marriage, or other events that significantly affect an entity over time.

Example event analysis systems herein can support running numerous simulations of experiments that generate distributions of outcomes to gain an appreciation of the time-varying state (the dynamics) of an event such as an epidemiological event. The system may support exploration of the variability of outcomes in a stochastic process. The outcome of experiments may be provided as analysis reports showing, e.g., distributions of numerous replicates of an experiment. Such reports can be viewable in the form of plotted graphs, in some examples.

Examples herein can permit bioinformatics researchers to design experiments and create analysis for epidemiological disease studies based on social-interaction graph simulations. Examples can enable improved readiness, planning, and decision making in the domains of public safety and national security by delivering sophisticated modeling and simulation capabilities directly into the hands of the analyst. According to various implementations, the analysis system allows analysts to view results immediately and interactively, greatly speeding up the interpretation of results. It also may allow multiple interventions of a single type and/or allow independent applications access to simulation results, allowing for special-case analysis tools to be developed. The system may be useful in training of military, medical, rescue operation, and/or other personnel, who may have use for timely, accurate reporting of experiment results. The system may also be useful in training and coordinating activities with civilian authorities, medical personnel/infrastructure, and other teams.

The systems and methods of the present disclosure may conduct analyses through interaction with various information resources. For example, information about population characteristics, disease characteristics, intervention options, and/or various other types of information may be retrieved from one or more of a variety of information sources. In some implementations of the present disclosure, the analysis system may incorporate and/or work in coordination with a system that incorporates components designed to transmit requests for information to different information sources and retrieve the information from those sources to perform various tasks.

In some examples, an “experiment” defines and specifies an event, along with all the required parameters for simulating the event using data defined in a data library. The parameters can include the number of replicates, duration, region affected, conditions when the event occurred, effect(s) of the event, the trigger which caused the event, or intervention strategy (both type and application on sub-population(s) of the selected region). Once all the required parameters are defined, the experiment can be run to provide estimate(s) of consequences of the event, as described herein.

### Illustrative Systems

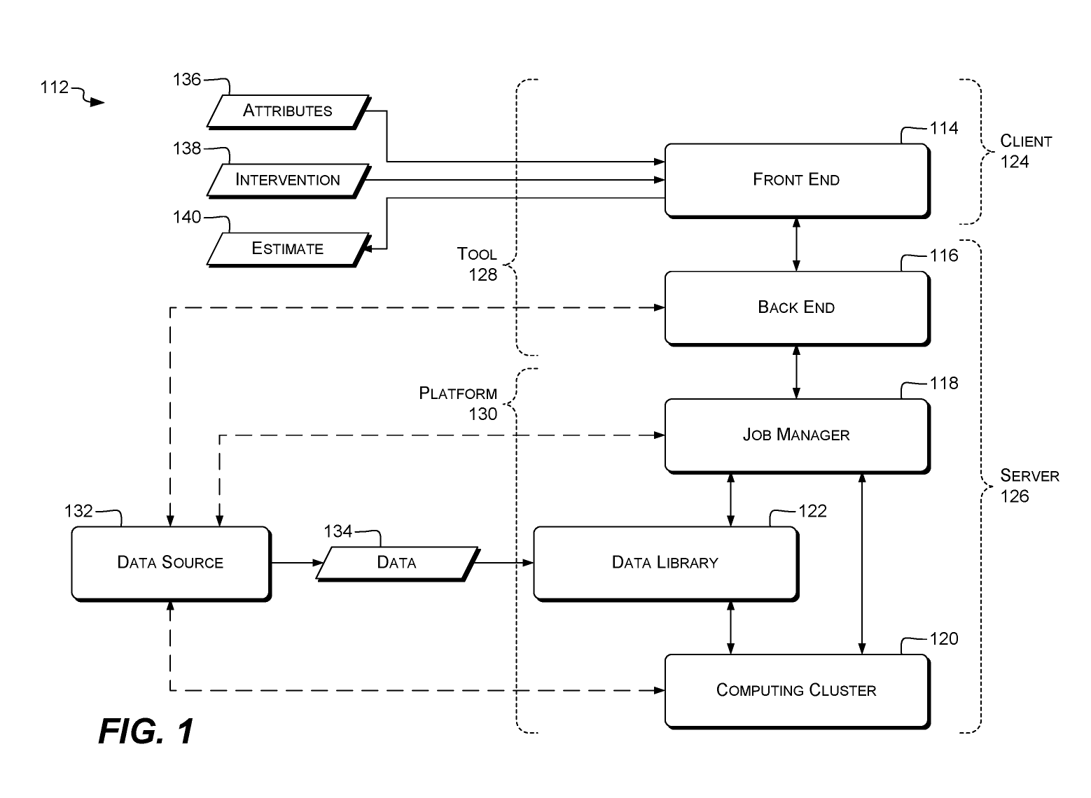

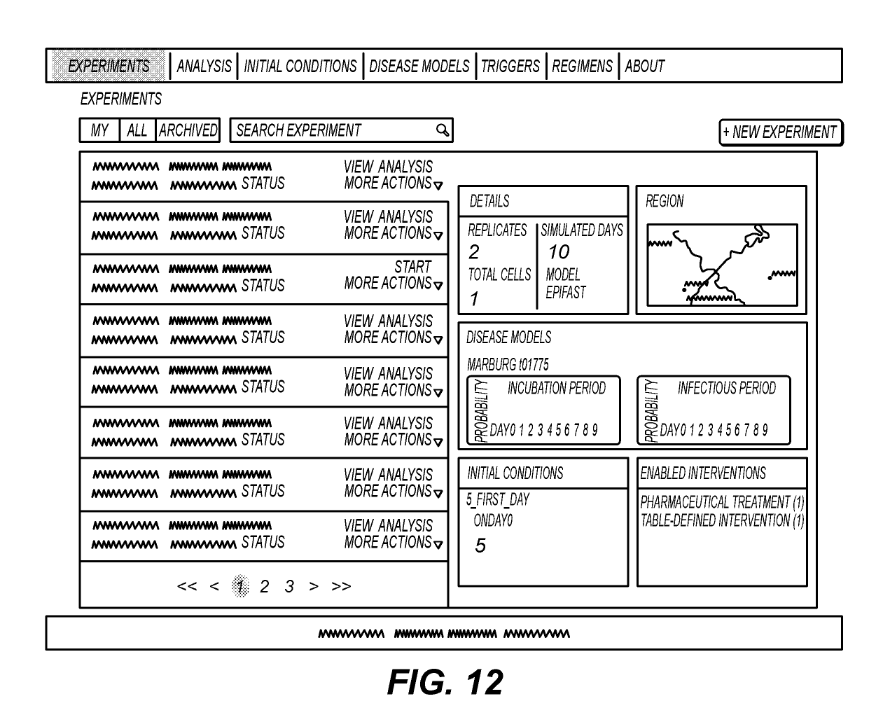

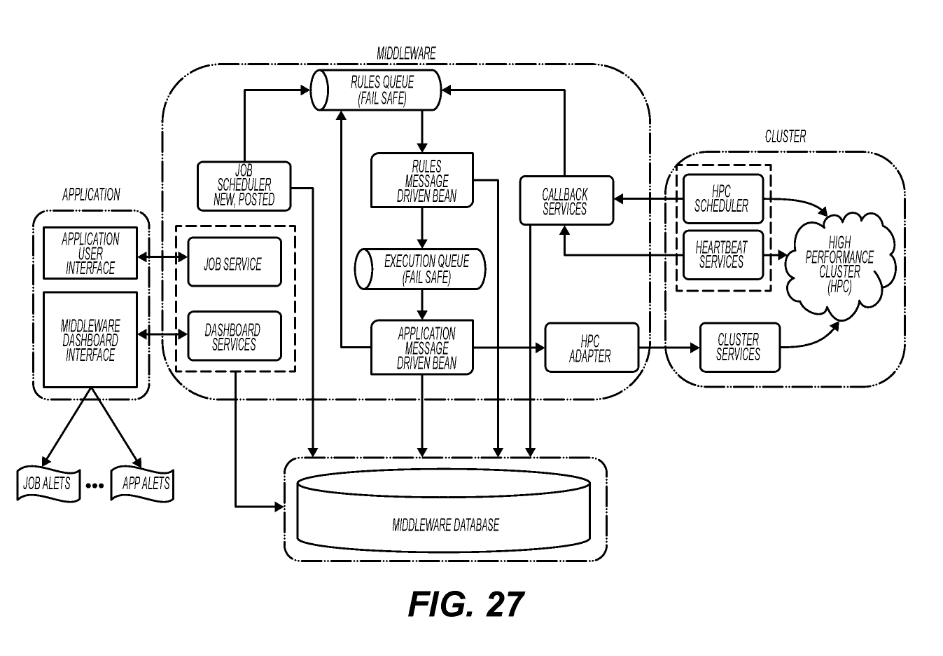

FIG. 1 is a block diagram illustrating a system 112 according to some examples. The system includes various computing devices and services, which can be connected with each other via, e.g., a telecommunications network such as the Internet or a private Ethernet. Front end 114 can include, e.g., a Web browser executable on a user's computer, a smartphone app, or a native (e.g., Win32) PC application. Back end 116 can include, e.g., a Hypertext Transfer Protocol (HTTP) server or code executing thereon (e.g., a servlet or Common Gateway Interface script), a Web Services server, or another server configured to exchange data with the front end 114. A job manager 118 can interact with a computing cluster 120 to provide responses to requests. For example, job manager 118 can include middleware configured to receive requests from the back end 116, determine and run corresponding jobs on the cluster 120, and provide the results to the back end 116 for transmission to the front end 114. Examples of the front end 114 are described herein with reference to FIGS. 12-26 and 35. Examples of the back end 116, the job manager 118, and the computing cluster 120 are described herein with reference to FIGS. 27-36.

The job manager 118 and the computing cluster 120 can communicate at least partly via, or can share access to, a data library 122. Data library 122 can include data of a synthetic population. For example, data library 122 can include a graph comprising nodes representing synthetic entities, such as people, plants, animals, cells in a body, or other entities capable of interacting. Data library 122 can include edges linking the nodes. The edges can include labels, e.g., indicating that two linked entities interact in certain locations or contexts, or with certain frequencies.

As shown, in some examples, front end 114 is a client 124 of services provided by a server 126. Server 126, which can represent one or more intercommunicating computing devices, can include at least one of each of: back end 116, job manager 118, cluster 120, or data library 122. In some examples, server 126 can include a single data library 122 and multiple back ends 116, job managers 118, or clusters 120. In some examples, client 124 and server 126 are disjoint sets of one or more computing devices.

System 112 can include at least two types of functionality, illustrated as tool 128 and platform 130. Tool 128 can include front end 114 and back end 116. Platform 130 can include job manager 118, cluster 120, and data library 122. In some examples, tool 128 implements a solution for a specific use case. For example, tool 128 can provide facilities for estimating the progress of an epidemic, for estimating the progress of another type of event, or for performing other specific analyses. Platform 130 can provide services usable by various tools 128, e.g., computational resources and access to the data library 122. Although only one tool 128 is shown, multiple tools 128 can access the platform 130 sequentially or concurrently. In some examples, multiple tools 128 can interact with each other directly or via services provided by platform 130. In some examples, one tool 128 writes to the data library 122 and a different tool 128 reads from the data library 122.

In some examples, a specific tool 128, or the platform 130, can interact with a data source 132, as shown by the dashed lines. The data source can be or include, e.g., a Web server, sensor, or other source of data 134 to be loaded into data library 122. The platform 130 can load the data 134 into the data library 122.

In some examples herein, tool 128 is a tool for forecasting the progress of an event, e.g., an extended event that goes on over a period of time, or a point-in-time event with extended consequences. An example of such an event is an epidemic among human, animal, or plant populations. As discussed in more detail below, the front end 114 can receive attributes 136 of a synthetic population, e.g., a subset of the data library 122. The tool 128 can select a synthetic-population (SP) graph from the data library 122, e.g., using services provided by the job manager 118. The front end 114 can receive data of an intervention 138 designed to affect a course of the event, e.g., to counteract or mitigate the event. The tool 128 can then simulate the course of the event in the SP graph to produce an estimate 140 of the event, based at least in part on the intervention 138. The front end 114 can present the estimate 140, e.g., via a user interface such as a Web page.

The illustrated computing devices, e.g., front end 114, back end 116, job manager 118, or devices of cluster 120, can be or include any suitable computing devices configured to communicate over a wireless and/or wireline network. Examples include, without limitation, mobile devices such as a mobile phone (e.g., a smart phone), a tablet computer, a laptop computer, a portable digital assistant (PDA), a wearable computer (e.g., electronic/smart glasses, a smart watch, fitness trackers, etc.), a networked digital camera, and/or similar devices. Other examples include, without limitation, devices that are generally stationary, such as televisions, desktop computers, game consoles, set top boxes, rack-mounted servers, and the like. As used herein, a message “transmitted to” or “transmitted toward” a destination, or similar terms, can be transmitted directly to the destination, or can be transmitted via one or more intermediate network devices to the destination.

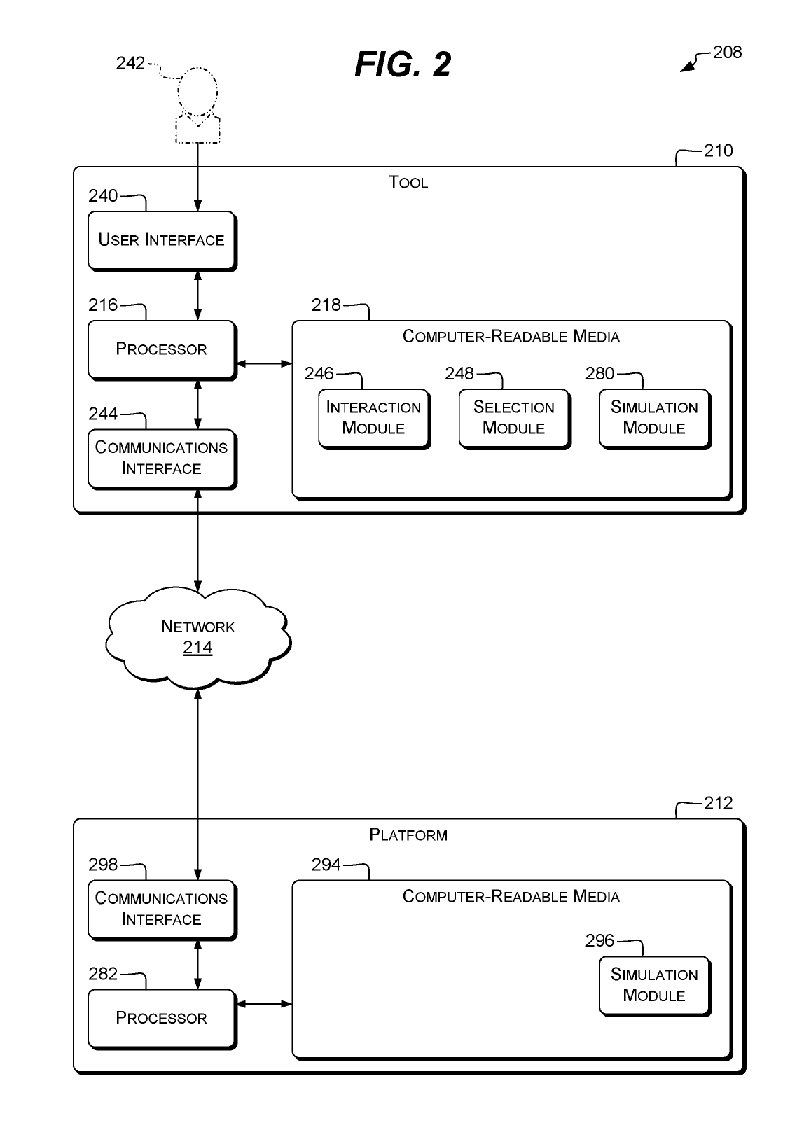

FIG. 2 is a block diagram illustrating a system 208 permitting event analysis according to some implementations. The system 208 includes a tool 210, which can represent tool 128. Solely for brevity of explanation, tool 210 is shown as an integrated computing device without distinguishing front end 114 from back end 116. Tool 210 can be coupled to platform 212, which can represent platform 130, via network 214, e.g., a cellular network or a wireline data network. In some examples, network 214 can include at least one cellular network, IEEE 802.1* network such as an 802.11 (WIFI) or 802.15.1 (BLUETOOTH) network, wired Transmission Control Protocol/Internet Protocol (TCP/IP) or IPv6 network, Asynchronous Transfer Mode (ATM) network, Public Switched Telephone Network (PSTN), or optical network (e.g., Synchronous Optical NETwork, SONET).

Tool 210 can be or include a wireless phone, a wired phone, a tablet computer, a laptop computer, a wristwatch, or other type of computing device as noted above. Tool 210 can include at least one processor 216, e.g., one or more processor devices such as microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs). Tool 210 can further include one or more computer readable media 218, such as memory (e.g., random access memory, RAM, solid state drives, SSDs, or the like), disk drives (e.g., platter-based hard drives), another type of computer-readable media, or any combination thereof.

The tool 210 can further include a user interface (UI) 240 configured for communication with a user 242 (shown in phantom). User 242 can represent an entity, e.g., a system, device, party, and/or other feature with which tool 210 can interact. For brevity, examples of user 242 are discussed herein with reference to users of a computing system; however, these examples are not limiting. The user interface 240 or components thereof, e.g., the electronic display device, can be part of the front end 114 (e.g., as illustrated in FIG. 1) or integrated with other components of tool 210.

User interface 240 can include one or more input devices, integral and/or peripheral to tool 210. The input devices can be user-operable, and/or can be configured for input from other computing devices of tool 210 or separate therefrom. Examples of input devices can include, e.g., a keyboard, keypad, a mouse, a trackball, a pen sensor and/or smart pen, a light pen and/or light gun, a game controller such as a joystick and/or game pad, a voice input device such as a microphone, voice-recognition device, and/or speech-recognition device, a touch input device such as a touchscreen, a gestural and/or motion input device such as a depth camera, a grip sensor, an accelerometer, another haptic input, a visual input device such as one or more cameras and/or image sensors, a pressure input such as a tube with a pressure sensor, a Braille input device, and the like. User queries can be received, e.g., from user 242, via user interface 240.

User interface 240 can include one or more result devices configured for communication to a user and/or to another computing device of or outside tool 210. Result devices can be integral and/or peripheral to tool 210. Examples of result devices can include a display, a printer, audio speakers, beepers, and/or other audio result devices, a vibration motor, linear vibrator, Braille terminal, and/or other haptic result device, and the like. Actions, e.g., presenting to user 242 information of or corresponding to a result of an analysis (e.g., estimate 140), can be taken via user interface 240.

The computing device 210 can further include one or more communications interface(s) 244 configured to selectively communicate via the network 214. For example, communications interface(s) 244 can include or operate one or more transceivers or radios to communicate via network 214. In some examples, communications interface(s) 244, or an individual communications interface 244, can include or be communicatively connected with transceivers or radio units for multiple types of access networks.

The computer readable media 218 can be used to store data or to store components that are operable by the processor 216 or instructions that are executable by the processor 216 to perform various functions as described herein. The computer readable media 218 can store various types of instructions and data, such as an operating system, device drivers, etc. Stored processor-executable instructions can be arranged in modules or components. Stored processor-executable instructions can be executed by the processor 216 to perform the various functions described herein.

The computer readable media 218 can be or include computer storage media. Computer storage media can include, but are not limited to, random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or memories, storage, devices, or any other tangible, non-transitory medium which can be used to store the desired information and which can be accessed by the processor 216. Tangible computer-readable media can include volatile and nonvolatile, removable and non-removable media implemented in any method or technology for storage of information, such as computer readable instructions, data structures, program modules, or other data. In contrast to computer storage media, computer communication media can embody computer-readable instructions, data structures, program modules, or other data in a modulated data signal, such as a carrier wave, or other transmission mechanism. As defined herein, computer storage media does not include computer communication media.

The computer readable media 218 can include processor-executable instructions of an interaction module 246 or a selection module 248. The computer readable media 218 can additionally or alternatively include processor-executable instructions of a simulation module 280 or other modules or components. In some example, the processor-executable instructions of the modules 246, 248, or 280 can be executed by the processor 216 to perform various functions described herein, e.g., with reference to at least one of FIG. 1-11 or 12-43.

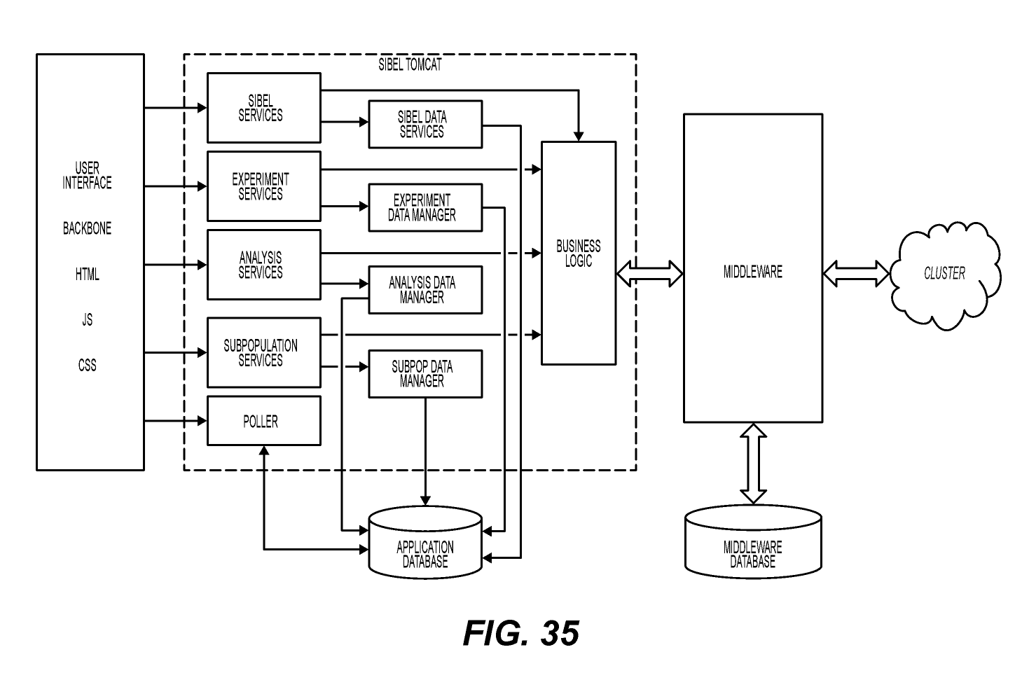

The platform 212 can include at least one processor 282. The platform 212 can include one or more computer readable media (CRM) 294. The computer readable media 294 can be used to store processor-executable instructions of a simulation module 296 or other modules or components. The processor-executable instructions of the module 296 or other modules can be executed by the processor 282 to perform various functions described herein, e.g., with reference to at least one of FIG. 1-11 or 12-43. Examples of assignments of functions to the modules 246, 248, 280, or 296 are described herein with reference to FIG. 35.

In some examples, processor 282 and, if required, CRM 294 are referred to for brevity herein as a “processing unit.” Similarly, processor 216 and, if required, CRM 218 can be referred to as a “processing unit.” For example, a processing unit can include a CPU or DSP and instructions executable by that CPU or DSP to cause that CPU or DSP to perform functions described herein. Additionally or alternatively, a processing unit can include an ASIC, FPGA, or other logic device(s) wired (physically or via blown fuses or logic-cell configuration data) to perform functions described herein.

The platform 212 can include one or more communications interface(s) 298, e.g., of any of the types described above with reference to communications interface(s) 244. For example, platform 212 can communicate via communications interface(s) 298 with tool 210.

### Illustrative Processes

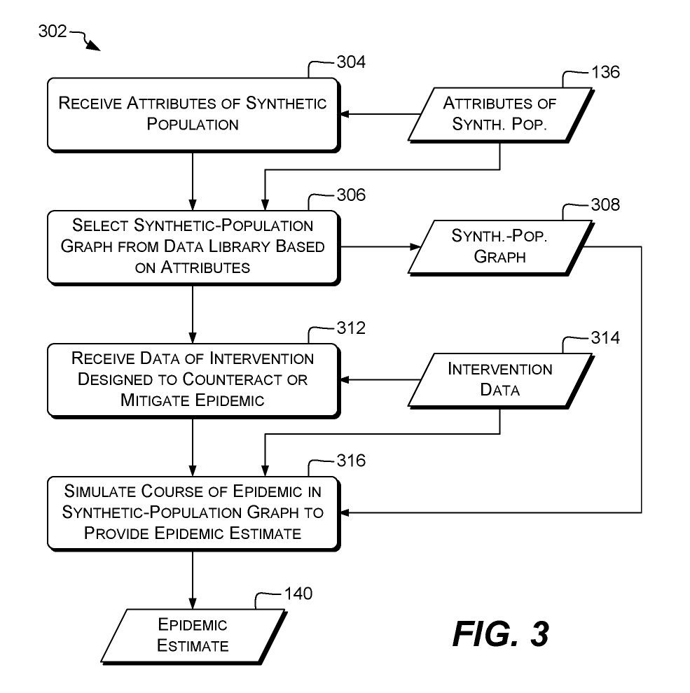

FIG. 3 Illustrates an example process 302 for determining an epidemic estimate, and associated data items. In some examples, operations described below with reference to FIG. 3-11, 34, 38, 39B, or 42 can be performed by a server 126 including one or more computing devices or processors, e.g., in response to computer program instructions of modules 246, 248, 280, or 296.

Operations shown in FIG. 3-11, 34, 38, 39B, or 42 can be performed in any order except when otherwise specified, or when data from an earlier step is used in a later step. Any operation shown in multiple figures can be as discussed with reference to the first figure in which that operation is shown. For clarity of explanation, reference is made in the discussion of the flowcharts to various components shown in FIG. 1, 2, 27, 34, 35, 38, 40, 41E, or 42 that can carry out or participate in the steps or operations of the example method. It should be noted, however, that other components can be used; that is, example method(s) shown and described herein are not limited to being carried out by the identified components.

At block 304, server 126 can receive attributes 136 of (e.g., designating or defining) a synthetic population (referred to as “synth. pop.,” “s. p.,” or “SP” throughout this description and figures). This can be performed, e.g., by the user interface or the experiment component shown in FIG. 35. The attributes can specify, e.g., a geographic area in which the epidemic is taking place, or which people are in vulnerable populations. The attributes 136 can be part of a set of initial conditions.

The initial conditions can include, e.g., an option to upload or otherwise specify a set of synthetic entities to be initially marked as infected with a disease. This can provide users, e.g., researchers, an increased degree of control at simulating specific situations, e.g., travelers carrying diseases between countries. Initially-infected entities can be indicated by identification or by characteristics of those to be marked as infected before the beginning of the simulation. In some examples, the synthetic entities initially marked as infected can be selected at random (or pseudorandom, and likewise throughout this document) from an entire synthetic population or from sub-populations thereof matching specified conditions.

At block 306, server 126 can select a synthetic-population (SP) graph 308 from the data library 122 based at least in part on the attributes 136. This can be performed, e.g., by the subpopulation-services or subpopulation data manager components shown in FIG. 35. The SP graph 308 can include nodes representing synthetic entities, and edges between at least some of the nodes. The SP graph 308 can include labels associated with some of edges, referred to as labeled edges herein. All edges can be labeled, or fewer than all.

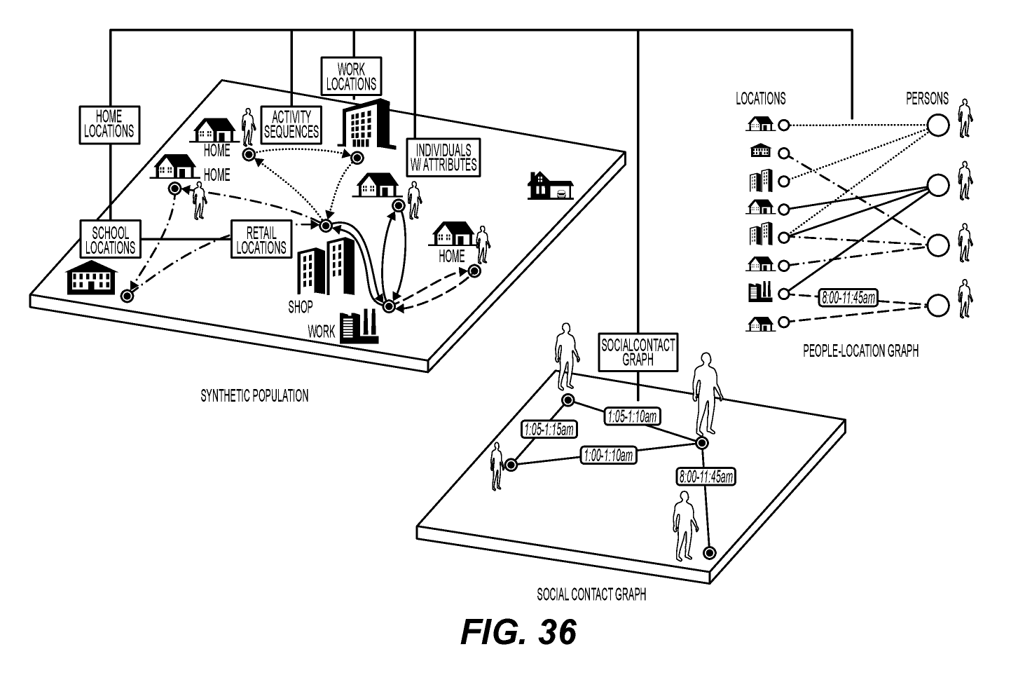

In some examples, the SP graph 308 is or comprises a social-interaction graph. In such a graph, labels can represent, e.g., locations at which the connected entities come into contact or interact, such as home, work, or school. An example SP graph 308, and components thereof, is shown in FIG. 36.

At block 312, server 126 can receive data 314 of an intervention (or at least one intervention) designed to counteract or mitigate an epidemic. This can be performed, e.g., by the user interface or the experiment component shown in FIG. 35. That an intervention is “designed to” have a particular effect does not require that the intervention be known to have that effect. Various examples permit simulating a variety of interventions to determine their relative levels of effectiveness against the epidemic. Data 314 can indicate a single intervention or any combination of interventions. Data 314 can include respective triggers for at least one of the indicated interventions, though this is not required. An intervention without a trigger is considered to run for the entire duration of the simulation, in some examples. Additionally or alternatively, an intervention without a specific trigger and be run based on default trigger conditions, e.g., specified in user preference files.

In some examples, the data 314 can indicate intervention(s) to be applied during the experiment and/or trigger(s) to initiate the intervention(s). Such interventions may include, but are not limited to: 1) table-defined intervention; 2) vaccination; 3) adding social distance; 4) closing offices; 5) closing schools; 6) providing pharmaceutical treatment; 7) providing pharmaceutical prophylaxis; and 8) dynamic sequestration. Examples of table-defined interventions can include scaling infection risks per activity type by user-specified values in a table of parameters. Table-defined interventions can permit simulating the effects of interventions not expressly provided by the system, given values for those parameters. For example, parameters of a table-defined intervention pertinent to an epidemic, e.g., influenza, can indicate how likely infected entities are to wear face masks or to turn away from others while sneezing. In some implementations, the data 314 can specify a duration of intervention, providing control over how long the intended intervention should be applied rather than assuming the intervention is applicable for the remainder of the simulation from the time of triggering. This can permit creating more practical scenarios for some simulations. In some implementations, the data 314 can specify a rate of administration for interventions such as vaccinations. The data 314 can additionally or alternatively specify at least one of: an efficacy level indicating how effectively an intervention reduces the spread of an epidemic; or a compliance rate indicating how likely entities are to cooperate with the intervention (e.g., how many people will accept vaccination).

At block 316, server 126 can simulate the course of the epidemic in the SP graph 308 to produce an epidemic estimate 140, based at least in part on the intervention indicated by the data 314. This can be performed, e.g., by the experiment component or the analysis component shown in FIG. 35, interacting with at least one of the application database, business logic, middleware, middleware database, or cluster shown in FIG. 35, or similar components shown in FIG. 27.

In some examples, the epidemic estimate 140 can include at least one of the following. For example, estimate 140 can include at least one of the following for each tested condition. Estimate 140 can include a curve indicating a number of the nodes marked as infected over the course of the simulation. The number can be per time interval, as in a conventional epicurve, or cumulative. The number can represent total infections or new infections per time interval. Estimate 140 can include an R curve indicating an estimated or actual reproductive number of the epidemic over the course of the simulation. Estimate 140 can include a curve indicating a slope of any of the above-described curves as a function of simulation time. Estimate 140 can include an estimated generation time of the epidemic. Estimate 140 can include an estimated growth rate of the epidemic.

In some examples, block 316 can include presenting, via a user interface (e.g., running on front end 114), a display of the experiment status while the experiment is running. An experiment status indicator can be updated on the user interface as the simulation progresses to keep the user informed as to the progress of the experiment. In some implementations, the status may include a progress bar that informs the user of a current state of the experiment, how much of the experiment is completed, how much of the experiment remains, time elapsed since the beginning of the experiment, estimated time to completion of the experiment, etc.

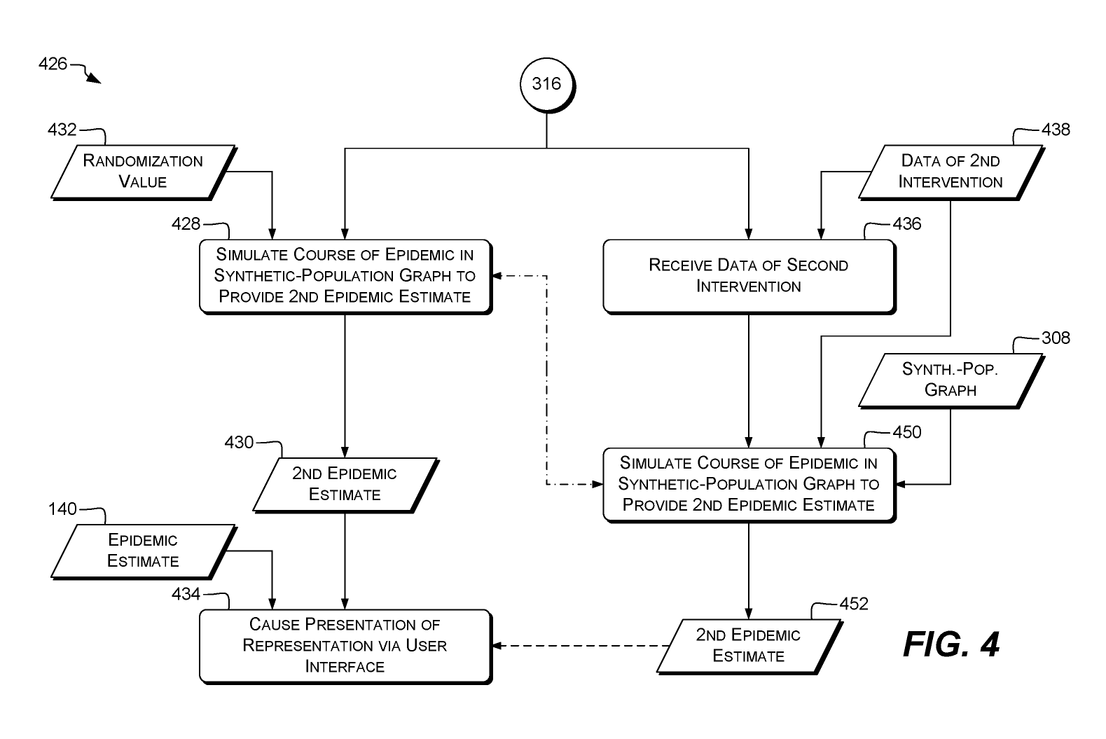

FIG. 4 illustrates example processes 426 for determining and reporting epidemic estimate(s), and associated data items.

In some examples, replicates of the experiment are run, e.g., as discussed herein with reference to blocks 428 and 434. In some examples, different interventions are tested, e.g., as discussed herein with reference to blocks 436 and 450. In some examples, block 316 can be followed by block 428 or block 436.

At block 428, server 126 can simulate the course of the epidemic in the synthetic-population graph to produce at least one second epidemic estimate 430. This can be performed, e.g., by the experiment component shown in FIG. 35. In some examples using block 428, block 316 can include determining the epidemic estimate further based at least in part on a first randomization value. Block 428 can include determining each second epidemic estimate 430 based at least in part on the intervention indicated by the data 314 and on a respective randomization value 432. At least one of the respective randomization values 432 can be different from the first randomization value. The randomization values can influence the course of the simulation of a stochastic disease model, e.g., by serving as seeds for pseudorandom number generators. In this way, at least one of the estimates 430 can differ from the estimate 140 even though both start from the same initial conditions.

An experiment can involve one or more simulations. Each simulation can be executed, e.g., by process(es) or job(s) running on an HPC cluster, under control of configuration file used to manage the execution of a series of jobs on a distributed HPC cluster. Job configurations can be stored, e.g., by the job manager 118. Job manager 118 can permit back end 116 to interface to the databases that hold the synthetic population data and the results of studies on those data, e.g., data library 122.

In various examples, series of random or pseudorandom numbers between some limits with a distribution that is indistinguishable from random on the margins are generated. These numbers can be used as randomization values 432 to influence Experiment Replicates. For example, the simulations that produce epidemic estimate 140 and second epidemic estimate 430 can be respective replicates. In some examples of pseudorandom number generation, a seed number is input to an iterative calculation that then produces the series of pseudorandom numbers. Some such generators will produce identical sequences when they start with the same seed number, permitting deterministically retrying experiments or replicates. Some examples use the Scalable Parallel Random Number Generators Library (SPRNG) from Florida State University to provide randomization values 432.

In some examples, each experiment can involve simulating interactions among perhaps millions of nodes mediated through numerous complex networks which might themselves be time-varying. For some events, the course of these interactions over time can vary greatly with initial conditions. Running replicates as in block 428 can permit analyzing the range of variability in events and the dependence on initial conditions.

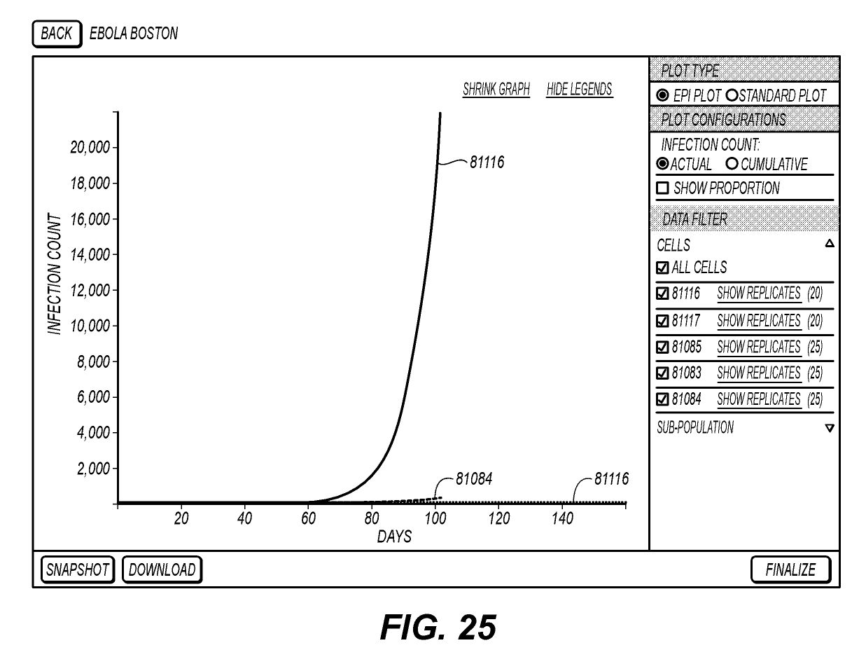

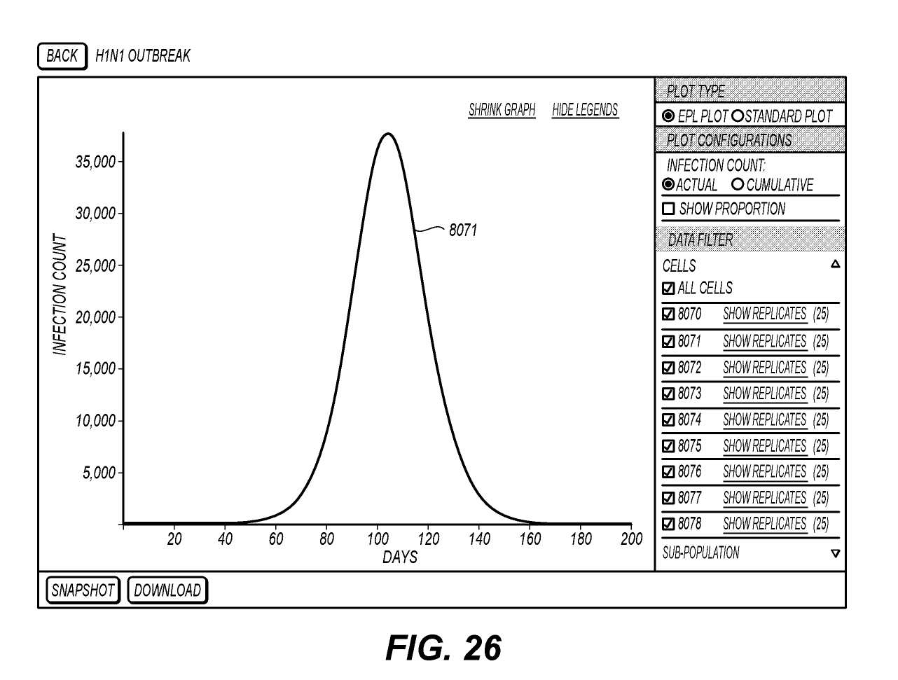

At block 434, server 126 can cause presentation of a representation via a user interface (e.g., running on front end 114). This can be performed, e.g., by the analysis component shown in FIG. 35. For example, the server 126 can transmit data of the representation to the client 124, e.g., formatted in JavaScript Object Notation (JSON), Extensible Markup Language (XML), or other data formats. The representation can be based at least in part on the epidemic estimate 140 and at least one of the second epidemic estimates 430. This can permit users 242 to see ranges of variability in the results of a particular intervention. Examples of representations are shown in FIGS. 25 and 26.

At block 436, server 126 can receive data 438 of a second intervention, e.g., different from the intervention represented by data 314. In some examples, data 438 can indicate at least one second intervention that is not indicated in data 314 (which may itself indicate at least one intervention).

At block 450, server 126 can simulate the course of the epidemic in the SP graph 308 to produce a second epidemic estimate 452 based at least in part on the second intervention(s) indicated by data 438. Block 450 can additionally or alternatively include running the simulation further based at least in part on at least one intervention indicated in data 314. That is, block 450 can simulate alternative intervention(s) not previously simulated, or can simulate additional intervention(s) used together with some intervention(s) previously simulated. In some examples, as indicated by the dashed arrow, block 450 can be followed by block 434. This can permit a representation to be provided via the user interface based on the epidemic estimate 140 and the second epidemic estimate 452. Additionally or alternatively, block 434 can include causing a representation to be presented, that representation based on at least one of, or all of, epidemic estimate 140, second epidemic estimate 430 (from replicates), and second epidemic estimate 452 (from alternative interventions). Examples are discussed herein, e.g., with reference to FIGS. 25 and 26.

As represented by the dash-dot arrow, block 428 can be used together or in conjunction with block 450. This can permit any number of replicates of any number of interventions to be simulated. Block 434 can then include causing representations to be presented of any of the results. Accordingly, in some examples, the system can provide representations or other outputs indicating how alterations in an intervention, e.g., changes in the rate of administration of a medicine or vaccine, affect spread of a disease in a simulation.

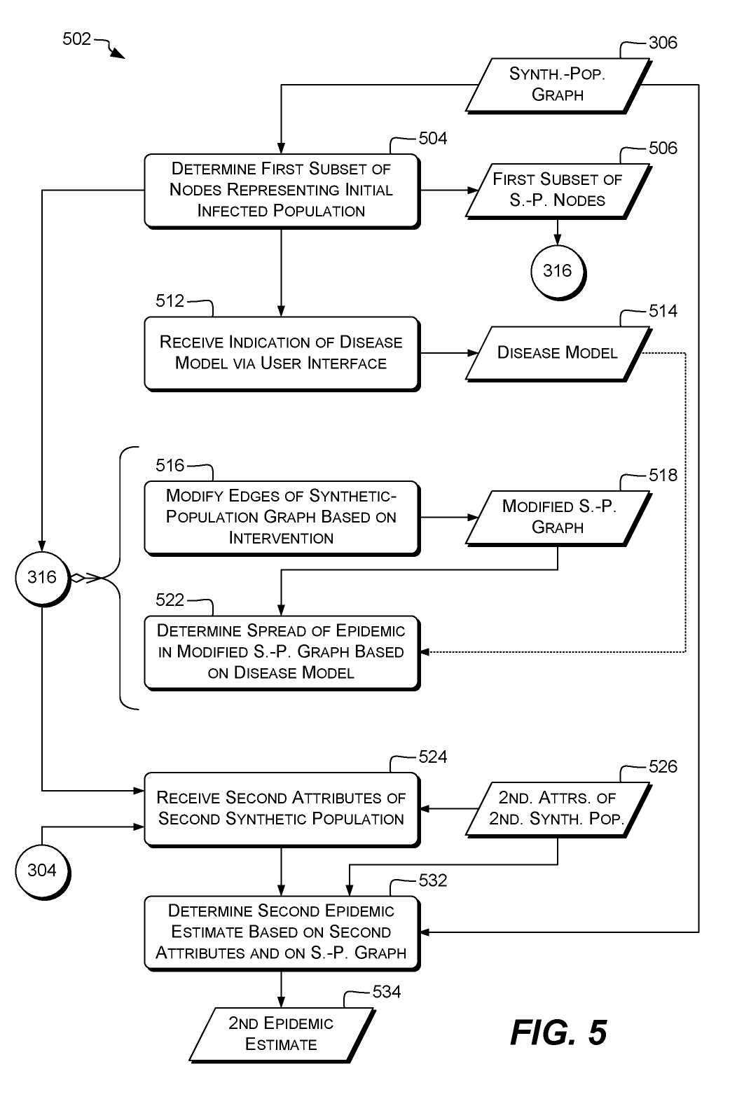

FIG. 5 illustrates example processes 502 for determining and reporting epidemic estimate(s), and associated data items. Operations of processes 502 can be performed, e.g., by the experiment component or the analysis component shown in FIG. 35. In some examples, block 306 or block 316 can be followed by block 524.

Operations of processes 502 are described with reference to server 126. Additionally or alternatively, operations of blocks 512, 524, or 532 can be performed by client 124. For example, the front end 114 can be configured to perform at least some client-side filtering or processing of epidemic estimate 140. Given a sufficiently capable client 124, this can reduce the network bandwidth required to perform such filtering or processing.

At block 504, server 126 can determine a first subset 506 of nodes of the SP graph 308. The first subset of nodes can represent an initial infected population. Examples of initial conditions specifying an initial infected population are discussed herein, e.g., with reference to block 304. Block 504 can be followed by block 316 of simulating the course of the epidemic. Block 316 can include blocks 516 and 522. Block 316 can include block 512. In some examples, blocks 516 and 522 are used without block 504. Block 504 can be followed by block 512, in some examples.

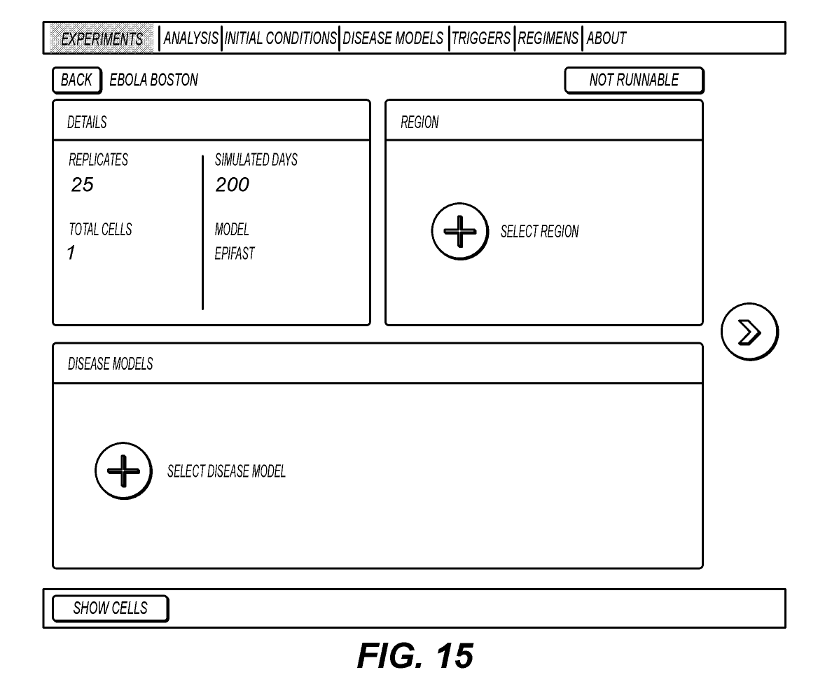

At block 512, server 126 can receive an indication of a predetermined disease model 514 via a user interface. For example, client 124 can receive the indication via user interface 240, and provide the indication to server 126. In some of these examples, server 126 can also receive the data 314 of the intervention via the user interface. For example, a user 242 can specify the data 314 and the disease model 514 via a Web interface of tool 128, e.g., as discussed herein with reference to FIGS. 15-22. In some examples, the indication of the disease model 514 can comprise the disease model 514 itself. In some examples, the indication of the disease model 514 can comprise a name, Uniform Resource Locator (URL), Universally Unique Identifier (UUID), or other identifier of a disease model 514 stored in a memory, e.g., CRM 294 of platform 212.

At block 516, server 126 can modify edges of the synthetic-population graph based at least in part on the intervention indicated by the data 314 to produce a modified synthetic-population graph 518. For example, if the data 314 indicate that a particular workplace should be closed, edges to that workplace labeled “work,” or edges between entities labeled with that particular workplace, can be removed from the SP graph 308 to produce the modified SP graph 518. In the modified SP graph 518, the particular workplace, being closed, is not a factor in transmitting infections between entities.

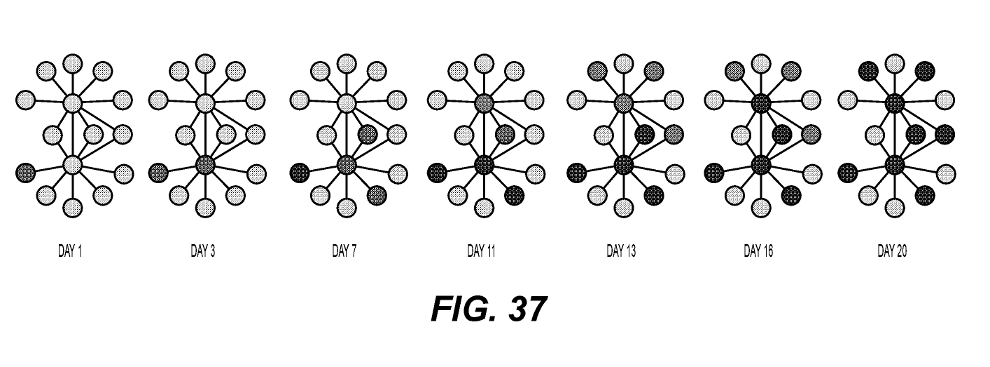

At block 522, server 126 can determine spread of the epidemic in the modified synthetic-population graph 518 based at least in part on a predetermined disease model 514. For example, server 126 can propagate the infection from nodes marked as infectious along edges connected to those nodes. Nodes can have states according to epidemiological models such as the SIR model, in which each node is Susceptible, Infected, or Recovered, or the SEIR model, in which each node is Susceptible, Exposed but not infectious, Infectious, or Recovered. Block 522 can additionally or alternatively include removing nodes from the graph, e.g., in the event of simulated travel by a synthetic entity out of the area of the simulation, or of death and burial of the synthetic entity corresponding to a node. Examples of the spread of a disease through a network are shown in FIG. 37.

At block 524, server 126 can receive second attributes 526 of (e.g., designating or defining) a second synthetic population. For example, the second synthetic population indicated by the second attributes 526 can be a subset of the synthetic population represented by SP graph 308.

At block 532, server 126 can determine a second epidemic estimate 534 based at least in part on the second attributes 526 and the SP graph 308. For example, the second epidemic estimate 534 can report the progress of the epidemic among synthetic entities connected with a specific workplace or school, among synthetic entities in a certain age range, or among synthetic entities that responded to the intervention in a particular way (e.g., took medicine vs. did not take medicine). In some examples, block 532 can permit users 242 to quickly visualize experiment outputs without having to create an analysis for every experiment and validate the simulation results.

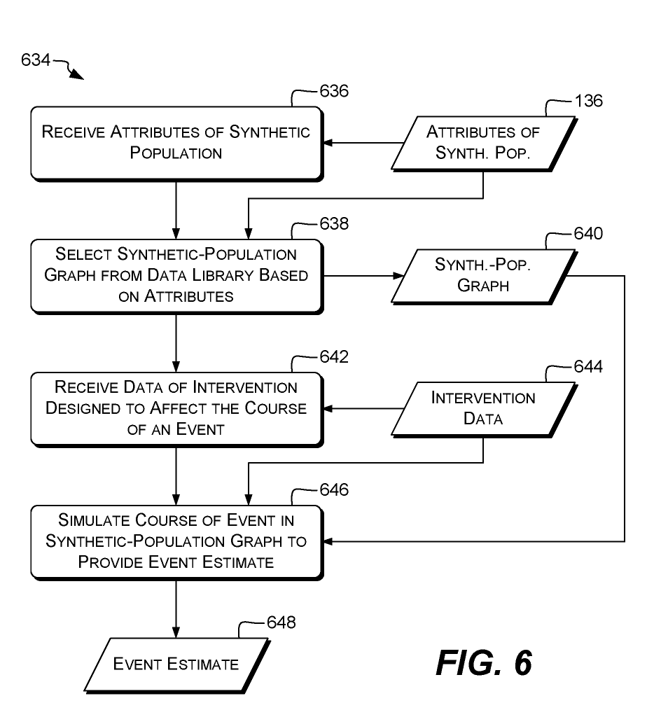

FIG. 6 illustrates an example process 634 for determining an estimate of an event, and associated data items.

At block 636, server 126 can receive the attributes 136 of a synthetic population. Examples are discussed herein, e.g., with reference to block 304.

At block 638, server 126 can select a synthetic-population (SP) graph 640 from the data library 122 based at least in part on the attributes 136. Examples are discussed herein, e.g., with reference to block 306. In some examples, the SP graph 640 comprises nodes, edges between at least some of the nodes, and labels associated with at least some of the edges. In some examples, the SP graph 640 includes parameters associated with at least some of the nodes. Examples are discussed herein, e.g., with reference to data library 122 or block 306. Parameters and edges can be associated with the same subsets of the nodes of the SP graph 640, although this is not required. In some examples, both node parameters and edge labels are used; in other examples, either node parameters or edge labels (but not both) are used.

At block 642, server 126 can receive data 644 of an intervention designed to affect the course of an event. As discussed above, an event can continue over a period of time, or can be a point-in-time event that results in or leads to consequences that extend over time. Examples are discussed herein, e.g., with reference to block 312.

As used herein, “consequences” are any results or outcomes of the event, or changes in event state or state of systems affected by the event. The “course of an event” refers to the progress of the event itself or its consequences, as determined via simulation as described herein. The term “consequence” is used herein without regard to whether any particular consequence may be considered by any party to be beneficial or harmful. Consequences themselves can be ongoing or point-in-time. For example, the spread of a disease can be a consequence of an epidemic, since it involves changes in the state of the epidemic (the event) itself. In another example, closure of schools and offices can be a consequence of an electric blackout (an event), since it involves changes in the state of systems (the schools or offices) affected by the event.

At block 646, server 126 can simulate the course of the event in the SP graph 640 to produce an estimate 648 of the event, based at least in part on the intervention indicated by the data 644. Examples are discussed herein, e.g., with reference to block 316. The estimate 648 can include, e.g., estimate(s) of the nature or range of one or more consequence(s) of the event.

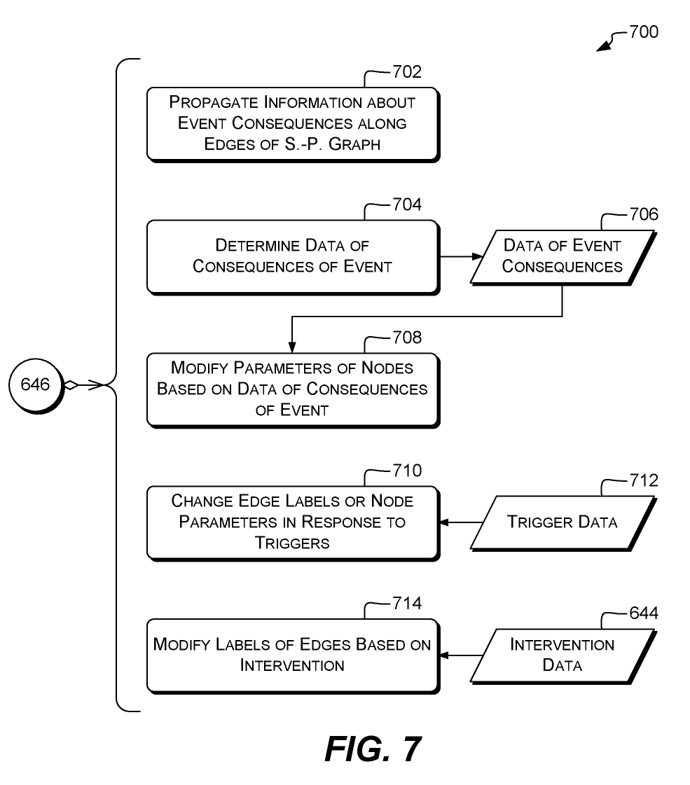

FIG. 7 shows processes 700 of simulating the course of an event, and associated data items. In some examples, block 646 can include at least one of blocks 702, 704, 708, 710, or 714, in any combination or in any order.

At block 702, server 126 can selectively propagate information about consequences of the event along edges of a first subset of the edges based at least in part on at least some corresponding labels of the labels of the SP graph 640. For example, in an epidemic, server 126 can propagate information about infection along edges labeled with the homes or workplaces of infected entities. In a simulation of a power outage, server 126 can propagate information about power losses along edges labeled with particular distribution lines or particular generation plants.

At block 704, server 126 can determine data 706 of consequences of the event. For example, the data 706 can indicate which nodes are infected, e.g., as in FIG. 35.

At block 708, server 126 can selectively modify at least some of the parameters of at least some of the nodes based at least in part on the data 706 of the consequences of the event. For example, server 126 can update the parameters of the nodes to reflect the results of the simulation, as in the left-to-right progress in FIG. 35.

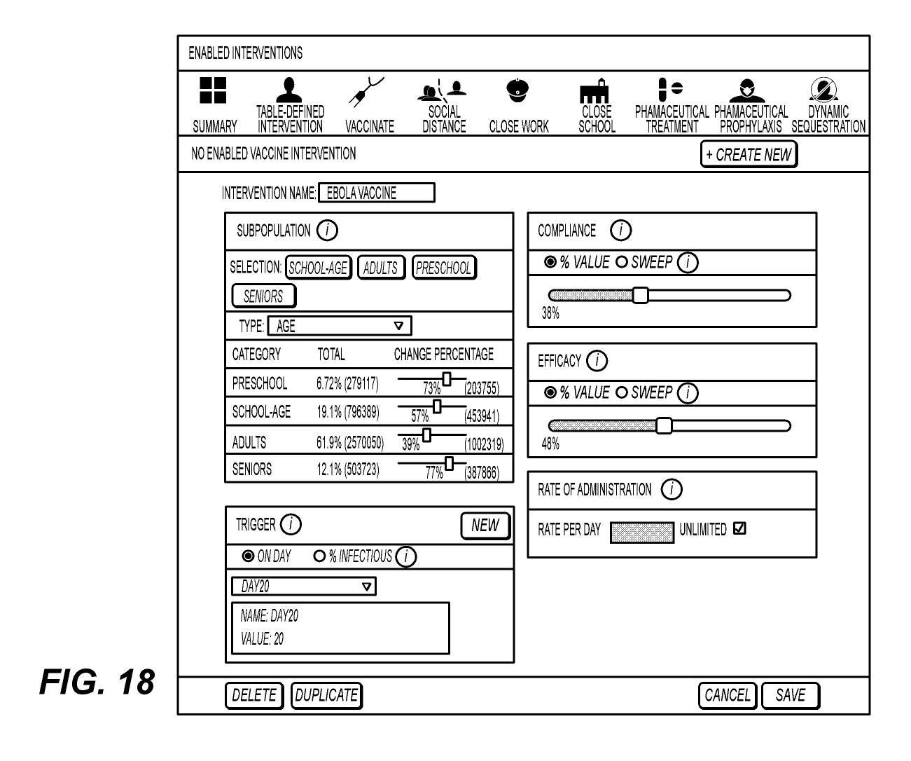

At block 710, server 126 can change edge labels or node parameters in response to triggers, e.g., as discussed herein with reference to FIG. 18, 19, or 24. Triggers can be indicated by data 712. For example, a node can have a trigger indicating that the represented synthetic entity will be seek prophylactic medication when a certain percentage of the population has been infected by an epidemic, but not before. If the simulation results indicate that the certain percentage has been reached, server 126 can update parameters of that node to indicate that the node is now eligible for such medication. A corresponding intervention indicated by data 644 can then be applied to that node.

At block 714, server 126 can selectively modify at least some of the labels of the SP graph 640 based at least in part on the intervention represented by data 644. For example, if simulation determines that a particular synthetic entity will work from home in response to the spread of disease, server 126 can alter label(s) on edge(s) from the node representing that entity to node(s) representing that entity's co-workers to reflect a reduced probability of transmission of the disease.

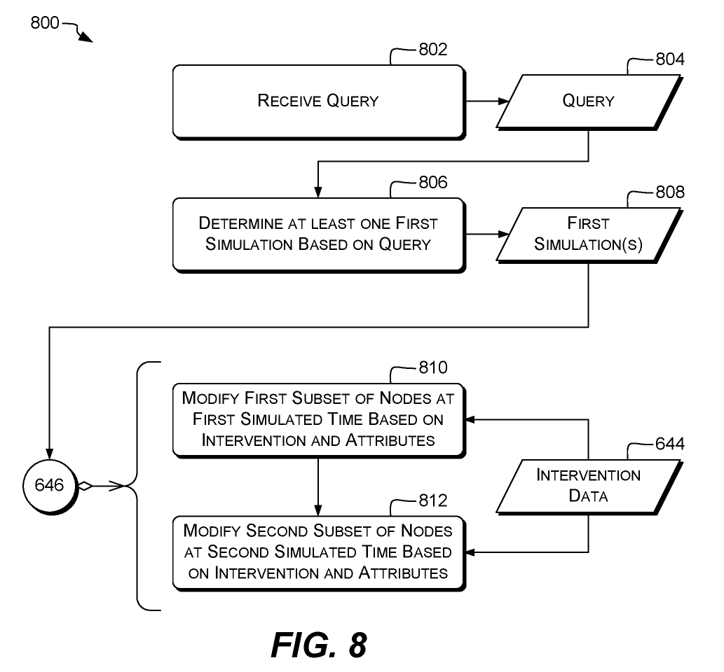

FIG. 8 shows processes 800 of simulating the course of an event, and associated data items. In some examples, block 646 can include blocks 810 or 812.

At block 802, server 126 can receive a query 804. Server 126 can receive the query 804, e.g., from a front end 114 or user interface 240. The query can include, e.g., attributes 136 of a synthetic population, desired outputs or result plots, or analyses or transformations to be performed on simulation results.

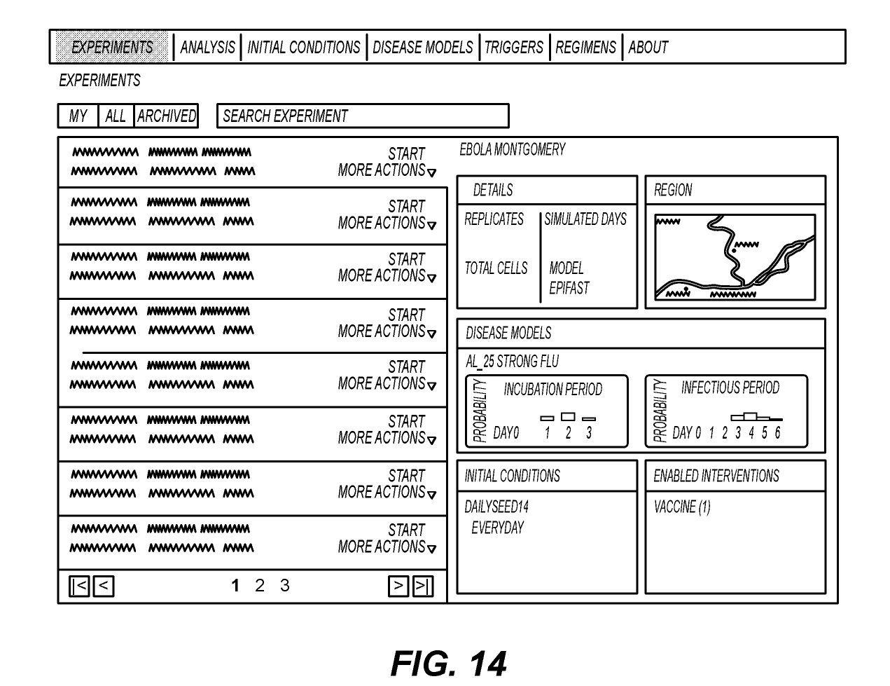

At block 806, server 126 can determine at least one first simulation 808 based at least in part on the query. The term “first simulation” is for clarity of identification and does not require a specific order of execution of multiple simulations. The first simulation can be of any of the types described herein, e.g., with reference to FIG. 12-17, 37, 39C, 39D, 41E, or 43. Block 806 can include, e.g., determining input or output parameters of the simulation 808, models to be used while running the simulation 808, or data sources providing data for the simulation 808. In some examples using block 806, simulating at block 646 can include running the at least one first simulation 808. In some examples, block 806 can include determining the at least one first simulation 808 including multiple simulations differing in one or more parameters. Examples are discussed herein, e.g., with reference to at least FIG. 14, 20, or 21.

At block 810, which can be included in block 646, server 126 can modify a first subset of nodes of the SP graph 640 at a first simulated time based at least in part on the intervention indicated by data 644 and on attributes of nodes of the first subset of nodes.

At block 812, server 126 can modify a second, different subset of nodes of the SP graph 640 at a second, different simulated time based at least in part on the intervention indicated by data 644 and on attributes of nodes of the second subset of nodes. Using blocks 810 and 812 can permit simulating differences between synthetic entities. For example, in an epidemic, different entities may have different thresholds for when they will seek care. Accordingly, the nodes representing those entities can change state at different times as the event progresses.

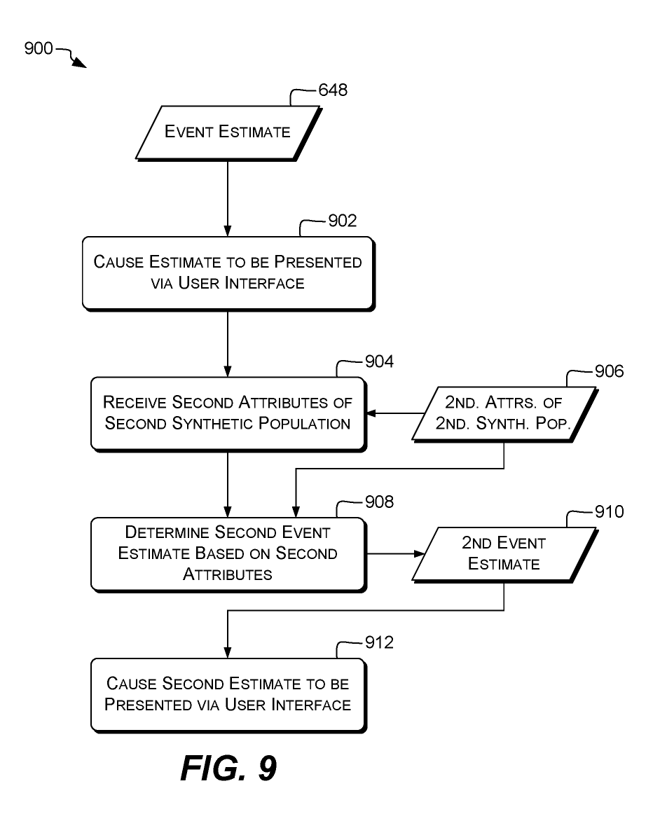

FIG. 9 shows processes 900 of simulating the course of an event, and associated data items. In some examples, block 646 can be followed by block 902.

Operations of processes 900 are described with reference to server 126. Additionally or alternatively, operations of blocks 902, 904, 908, or 912 can be performed by client 124. For example, the front end 114 can be configured to perform at least some client-side filtering or processing of estimate 648. Given a sufficiently capable client 124, this can reduce the network bandwidth required to perform such filtering or processing.

At block 902, server 126 can cause the estimate 648 of the event to be presented via a user interface. Examples are discussed herein, e.g., with reference to block 434.

At block 904, server 126 can receive second attributes 906 of a second synthetic population. Examples are discussed herein, e.g., with reference to block 524.

At block 908, server 126 can determine a second estimate 910 of the event based at least in part on the second attributes and on at least one of the estimate of the event or the synthetic population. This can permit, e.g., dynamic filtering of result curves or other components of estimate 648 to a particular subpopulation. Examples are discussed herein, e.g., with reference to block 532.

At block 912, server 126 can cause the second estimate 910 of the event to be presented via a user interface. Examples are discussed herein, e.g., with reference to block 434.

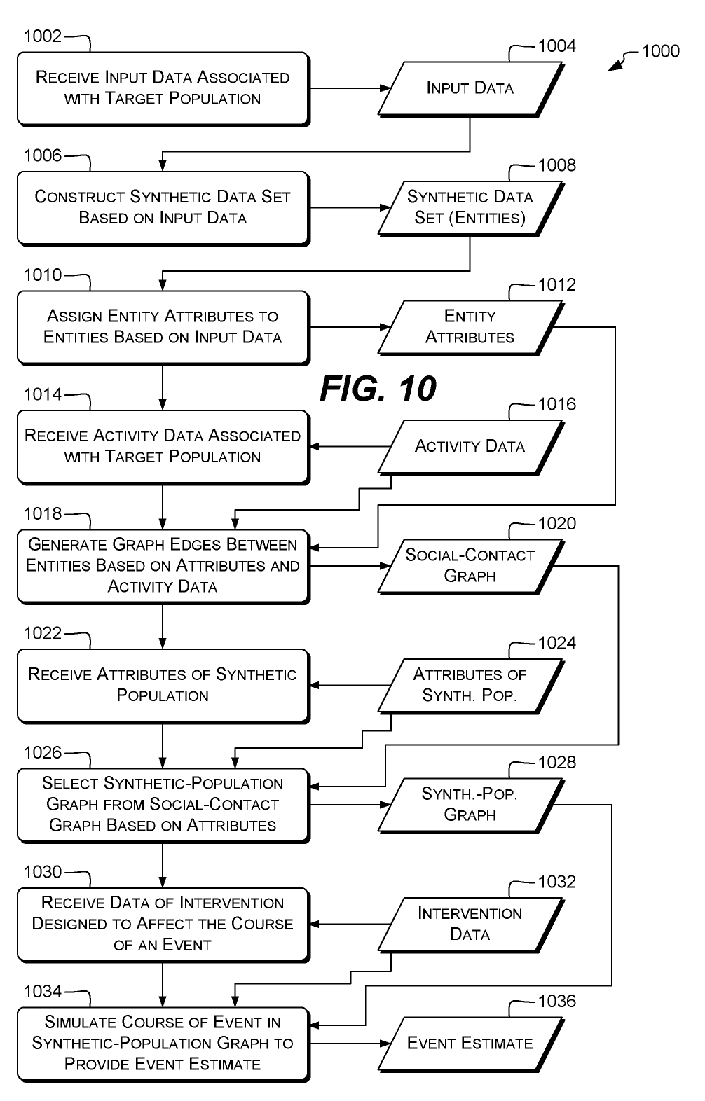

FIG. 10 illustrates an example process 1000 for determining an estimate of an event, and associated data items.

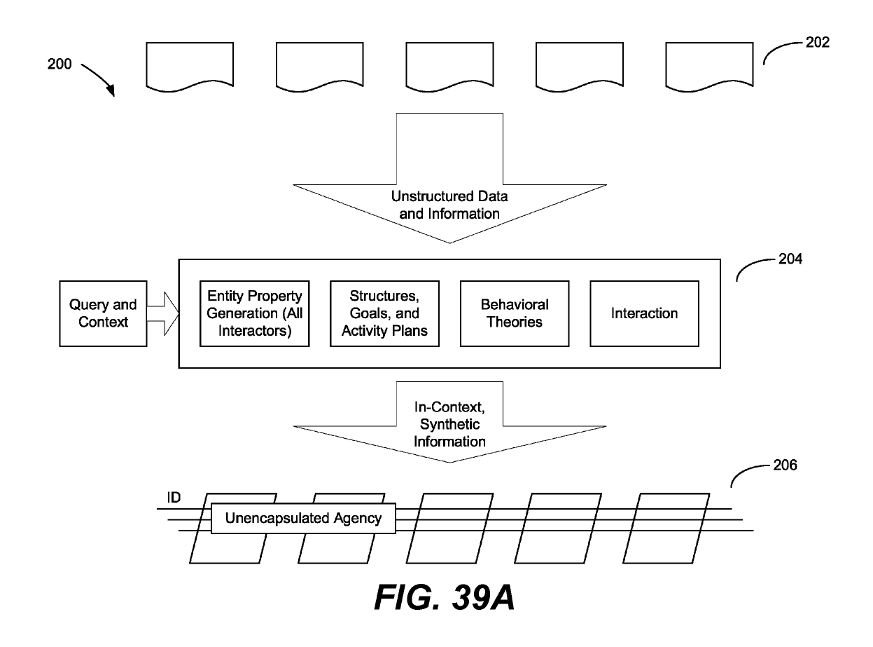

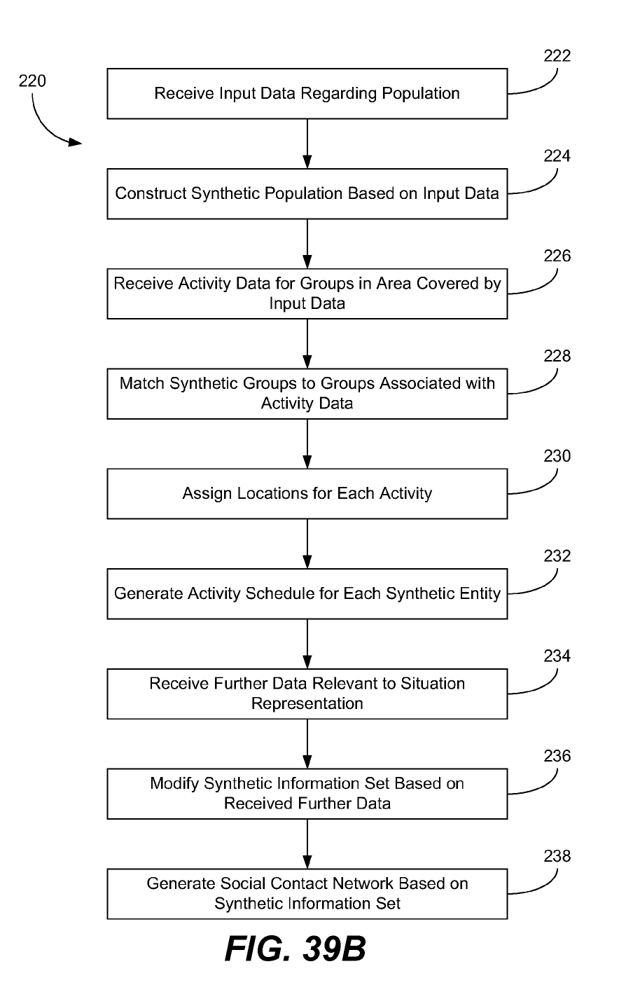

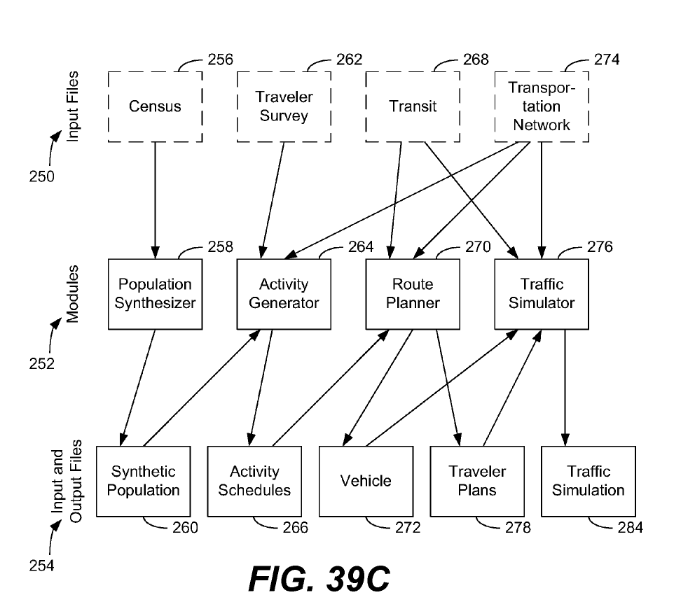

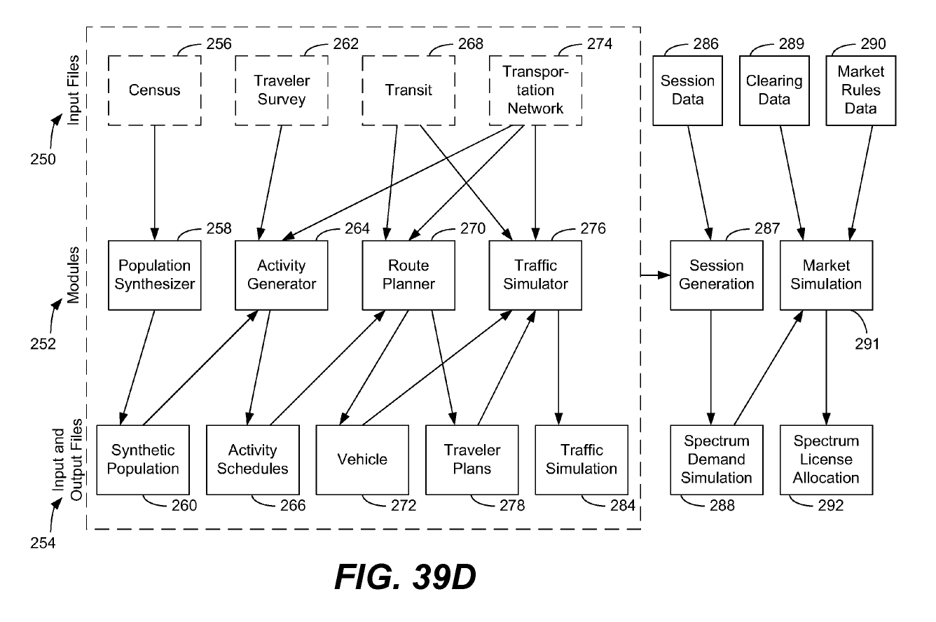

At block 1002, server 126 can receive input data 1004 associated with a target population. For example, the input data 1004 can include data or persons, locations, activity sequences, or social contacts, as shown in FIG. 36. Additionally or alternatively, the input data 1004 can include types of data discussed below with reference to blocks 202 and 204, FIG. 39A, or block 222, FIG. 39B. Other examples of input data are described herein with reference to FIGS. 39C and 39D.

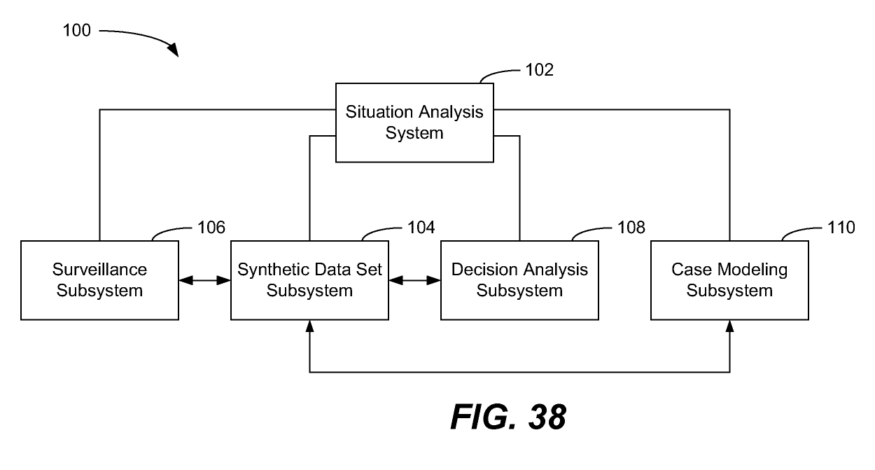

At block 1006, server 126 can construct a synthetic data set 1008 based on the input data 1004. The synthetic data set 1008 can include data of a plurality of synthetic entities corresponding with the target population. For example, the synthetic data set 1008 can be, or be included in, a data library 122 or other structure representing synthetic entities, e.g., as nodes in a graph. Examples are discussed herein, e.g., with reference to FIGS. 38-42.

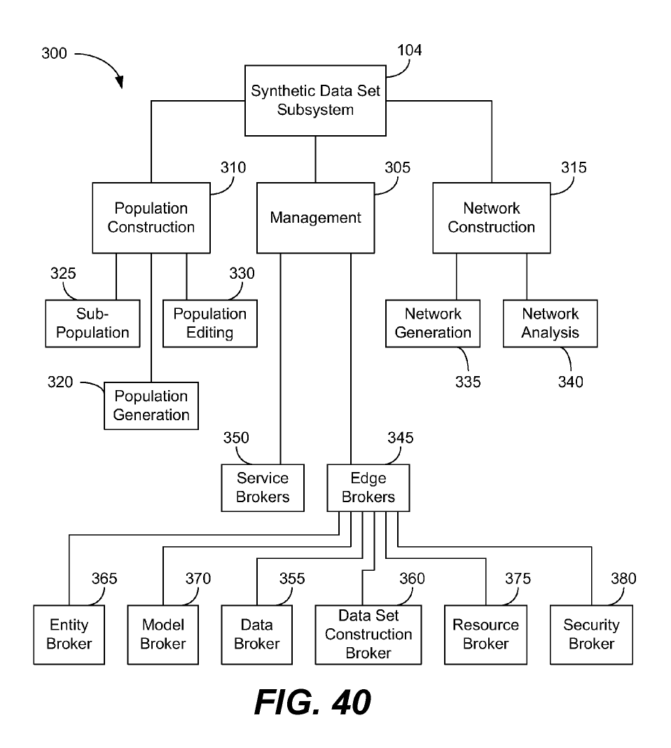

At block 1010, server 126 can assign entity attributes 1012 to individual entities of the plurality of synthetic entities in the synthetic data set 1008 based at least in part on the input data 1004. For example, the entity attributes 1012 can include occupation, age, or demographics for synthetic people, or genus or genotype for synthetic insects. Examples are discussed herein, e.g., with reference to population construction module 310, FIG. 40.

At block 1014, server 126 can receive activity data 1016 associated with the target population. For example, the activity data 1016 can include data indicating what activities members of the target population undertake, and during which hours of the day. Examples are discussed herein, e.g., with reference to step 226, FIG. 39B.

At block 1018, server 126 can generate a social-contact graph 1020 by generating graph edges between individual entities of the plurality of synthetic entities based at least in part on corresponding ones of the entity attributes 1012 and on the activity data 1016. For example, server 126 can generate edges between nodes tagged with entity attributes 1012 indicating the corresponding entities have a common workplace, or are in a common location at the same times of day or at different times of day. Examples are discussed herein, e.g., with reference to network construction module 315, FIG. 40.

At block 1022, server 126 can receive population attributes 1024 of a synthetic population. Examples are discussed herein, e.g., with reference to block 636.

At block 1026, server 126 can select a synthetic-population graph 1028 from the social-contact graph 1020 based at least in part on the population attributes 1024. For example, server 126 can select a subset of social-contact graph 1020 matching the population attributes 1024. Examples are discussed herein, e.g., with reference to block 638. In some examples, the synthetic-population graph 1028 comprises nodes, parameters associated with at least some of the nodes, and edges between at least some of the nodes, e.g., as discussed herein with reference to SP graph 640.

At block 1030, server 126 can receive data 1032 of an intervention designed to affect the course of an event. Examples are discussed herein, e.g., with reference to block 642.

At block 1034, server 126 can simulate the course of the event in the SP graph 1028 to produce an estimate 1036 of the event. The simulation can be based at least in part on the intervention indicated by the data 1032. Examples are discussed herein, e.g., with reference to block 646.

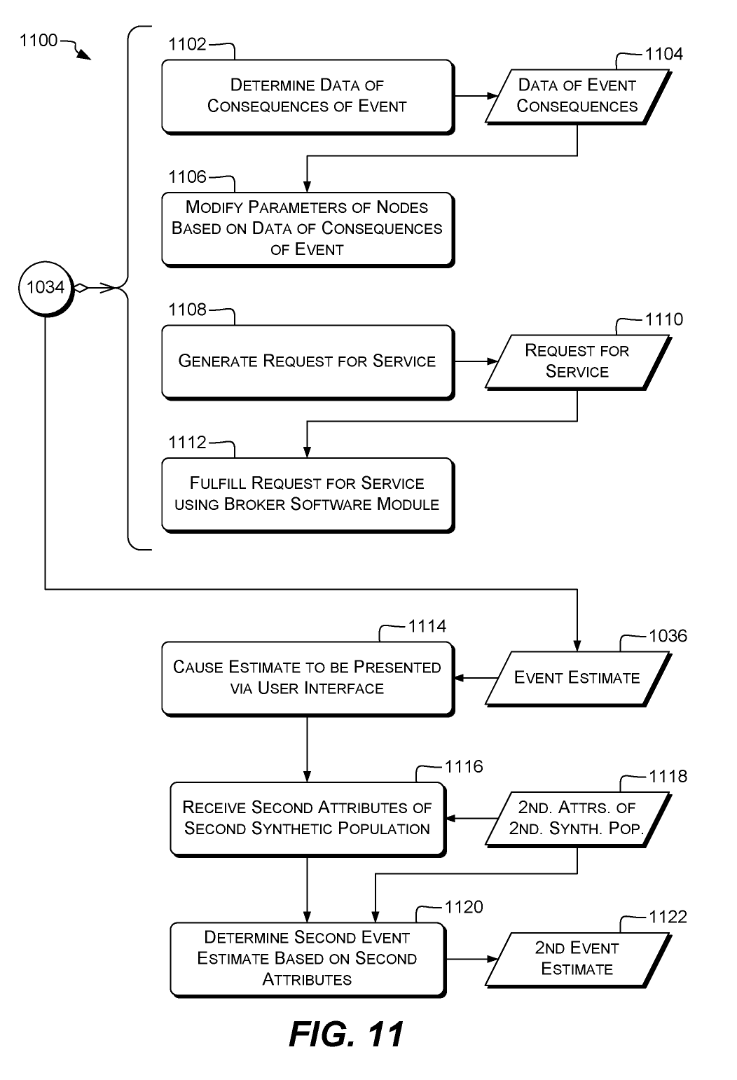

FIG. 11 illustrates example processes 1100 for determining or presenting estimates of an event, and associated data items. In some examples, block 1034 can include blocks 1102 and 1106, or blocks 1108 and 1112.

At block 1102, server 126 can determine data 1104 of consequences of the event. Examples are discussed herein, e.g., with reference to block 704 and data 706.

At block 1106, server 126 can selectively modify at least some of the parameters based at least in part on the data 1104 of the consequences of the event. Examples are discussed herein, e.g., with reference to block 708. This can permit modeling changes in entities' behavior patterns over time, e.g., in response to the event.

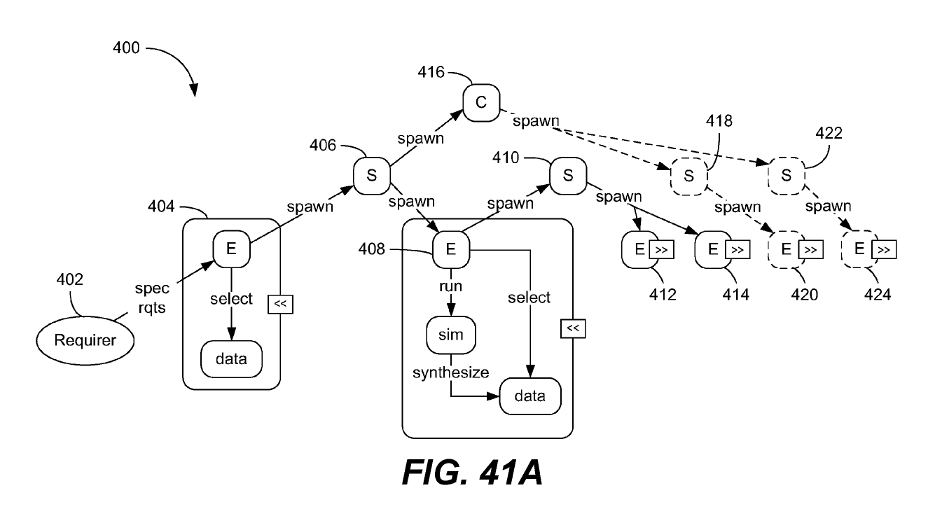

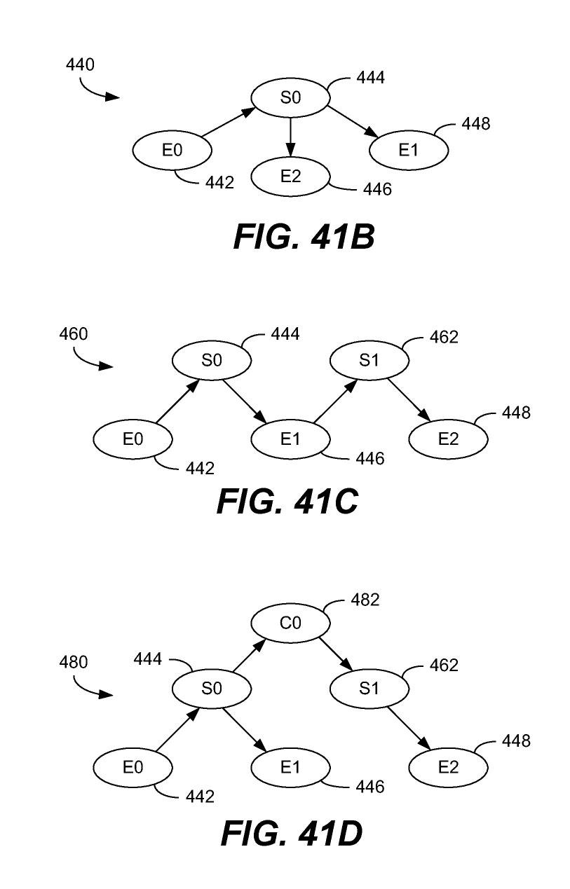

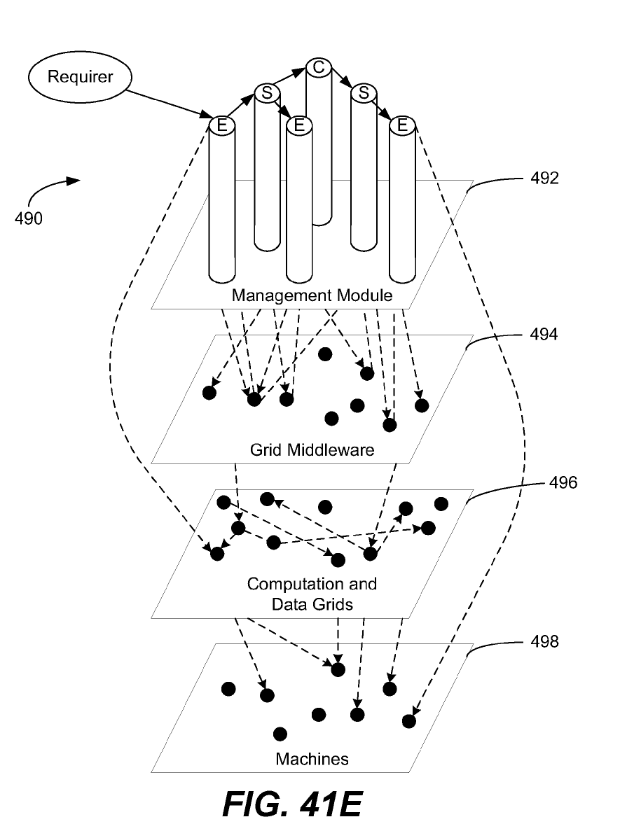

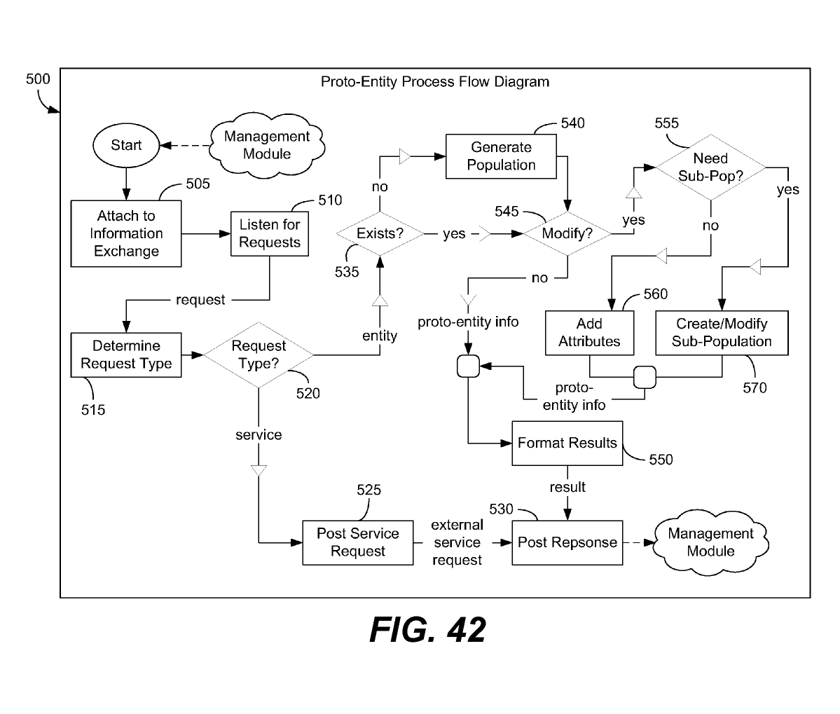

At block 1108, in association with (e.g., as part of or in cooperation with) at least one of the constructing (block 1006), the assigning (block 1010), the generating (block 1018), or the simulating (block 1034), server 126 can generate a request 1110 for a service. For brevity of explanation, block 1108 and block 1112 are described herein with reference to simulating (block 1034), but this is not limiting. Examples of generating requests for services are discussed herein, e.g., with reference to management module 305 and service brokers 350, FIG. 40; process 400, including block 402, FIG. 41A; or steps 510, 515, and 520, FIG. 42.

At block 1112, server 126 can fulfill, by a broker software module, the request 1110 for the service. Examples are discussed herein, e.g., with reference to management module 305, edge brokers 345, and service brokers 350, FIG. 40; FIG. 41A; or step 530, FIG. 42. In some examples, the broker software module is selected from the group consisting of: a data broker configured to manage data used in constructing the synthetic data set; a data set construction broker configured to manage at least one of construction and modification of one or more input data sets; and an entity broker configured to manage at least one of creation and modification of the synthetic population. Examples are discussed herein, e.g., with reference to management module 305, FIGS. 41A-41D, and FIG. 42. In some examples, the broker can be a broker of a type other than the three types expressly listed in this paragraph, e.g., of another type shown in FIG. 40. A “broker software module,” as used herein, can refer to processor-executable instructions or to a logic configuration (e.g., of an FPGA) configured to perform broker functions such as those described herein.

At block 1114, server 126 can present the estimate 1036 of the event via a user interface. Examples are discussed herein, e.g., with reference to block 902.

At block 1116, server 126 can receive second population attributes 1118 of a second synthetic population. For example, the second population attributes 1118 can indicate entities composing a subset of the simulated SP graph 1028. Examples are discussed herein, e.g., with reference to block 904 and attributes 906.

At block 1120, server 126 can determine a second estimate 1122 of the event based at least in part on the second population attributes and on at least one of the estimate of the event or the synthetic population. Examples are discussed herein, e.g., with reference to block 908 and estimate 910. Block 1120 can include, or be followed by a separate block involving, causing the second estimate 1122 to be presented via a user interface, e.g., user interface 240 or UIs shown in FIG. 25 or 26.

### Illustrative Examples

Experiments as described herein can be used in determining the course of events, e.g., to assist personnel working in public health epidemiology. Various examples can be used for a large class of infectious diseases in the world. This includes any population segment in the world, and various kind of infectious diseases that spread via person to person contact. Various examples provide a rich class of realistic interventions that can be employed by public health analysts to carry out computational experiments. These experiments can be carried out for, e.g.: (i) situation assessment, (ii) forecasting, (iii) decision support, or (iv) determining efficacy of one or more interventions.

Various examples include a Web-based front end 114 developed for experiment designs and analysis for epidemiological disease studies based on realistic social network simulations. The front end can communicate with a back end 116. Various examples provide cards preview and slider graphs. Various examples are accessible over the Internet using the web address/URL of the server where it is deployed.

Data and results accessible using the tool can be from previously conducted studies and analyses, or can be generated on-line as required, using high performance computing (HPC) capabilities. Datasets generated by the tool can be retained and cataloged automatically.

Various examples support running numerous simulations of experiments that generate distributions of outcomes to gain an appreciation of the time-varying state (the dynamics, or “course”) of an event, e.g., an epidemiological event. Various examples support exploration of the variability of outcomes in stochastic processes. The outcomes of experiments can be used in analysis reports, e.g., showing a distribution of numerous replicates of an experiment, e.g., generally viewable in the form of plotted graphs.

Various aspects can facilitate both the planning and course of action analysis activities of analyst. Various aspects can be used in the training of military/medical personnel/NGO/Rescue Operation teams, or in training and coordinating activities with civilian authorities and medical personnel/infrastructure and other required teams. Various examples can be used by Public Health System Officials, Government Authorities involved in Policy decision making, Scientists and Researchers, Clinicians and Epidemiologists, Surveillance Department Officials, or Students. Various examples can be used for emergency crisis planning.

Throughout the discussion of FIGS. 12-37, some actions are described as being taken “by the user” for brevity. These refer to the systems 112 or 208, or components of either of those, taking action in response to activation of a user-interface control, e.g., by a user. For example, language such as “the user starts an experiment” denotes that the system receives a command to start an experiment and does so. That command may come from a user via front end 114. Additionally or alternatively, that command may come from an outside system, e.g., a computational agent, a broker (e.g., as discussed herein with reference to FIGS. 38-43), or another automated system.

FIG. 12 shows an example user interface providing an overview of experiment status. The illustrated UI can be an entry point to, e.g., functions such as Create Experiment, Run Experiment, Analyze Results, and Generate Movies. The menu bar across the top can provide access to various collections of data. The system can respond to activation of the “New Experiment” button to perform functions to Create New Experiment: an experiment can be created as a New Experiment or by duplicating an existing experiment. The user can enter name and details for the experiment, and specify characteristics of the experiment like the number of simulated days, number of replicates, the geographic region, a particular disease transmission model, selection and specification of interventions, such as vaccination of a subpopulation, efficacy of the vaccination, etc., and save it. Once the new experiment has been created it will be included in the list of experiments (listbox, left panel). If required, the user can also edit the created experiment by selecting it at a later stage to establish numerous conditions of the experiment, including number of replications, and interventions, etc.

To run an experiment: After the experiment has been created and edited, the user can cause the system to execute the experiment by selecting the experiment from the Experiment List Grid (left side) and clicking START. The status of the experiment, e.g., New, Starting, Queued, Running, Completed, or Failed, is represented below the Experiment Name. Also shown in FIG. 12 are disease models used to run the Experiment (right, center row). Each run generates data that are stored together and identified as the “cells” that are results of the experiment and are available through Analysis page.

Also shown are My/All/Archived Filters, e.g., above the Lists for Experiments, Analyses, Initial Conditions, Disease Models, Triggers and Regimens. These toggle the display in a list grid (left side) between MY List, which displays the list of objects created/owned by the current logged in user, ALL List, which displays the list of all available objects to the user i.e., objects of all users both active and archived, and Archive List, which displays the list of Archived objects owned by current logged in user. A filter specified by the user remains in effect for the session or until changed by the user. Hence, each time the user returns to any of the menus, the information listed will be displayed per the most recent filter specified during this session.

The right-hand side of FIG. 12 shows a “card”-format preview of experiment characteristics. Example cards can include: Details (showing a preview of replicates, simulated days, total cells and model values of the experiment); Region (showing a Geographic region selected for the Experiment); Disease Model (showing a preview of the selected Disease Model of the experiment along with its Incubation period and Infectious period probability bar graphs); Initial Conditions (showing a preview of the selected initial condition of the experiment along with the infected people details for On Day, Every Day or Daily Seed); or Interventions (preview of the selected interventions for the Experiment). On selecting any experiment with all cards edited and saved the short preview display will have all the cards populated as shown in FIG. 12 or 14. If not all parameters of an experiment have been defined, some cards may be empty as shown in FIG. 15.

To Run an Experiment, the user can select it from the list on the left and click the START link. The displayed status (included in the list) will update as the experiment progresses, e.g., as discussed herein with reference to FIGS. 27-35. Status values can include the following. New—just created, not yet executed experiment. Running—currently executing on the HPC cluster. Completed—simulations completed, and data ready for analysis on the HPC cluster. Failed—The experiment terminated before completing. For failed experiments, a “restart” link can be displayed in the list instead of or in addition to a “start” link. A “View Errors” link can additionally or alternatively be displayed for experiments with Failed status. On clicking on the link, the Cells page can be presented. For all cells with failed status, a “view error” link can be displayed next to the cell name. On clicking on the view error link, the error log can be displayed. The error log can give details of the failure of cell execution to permit debugging. Throughout the process, the Experiment status can be shown in the Progress bar in the detailed card preview (e.g., FIGS. 15-17).

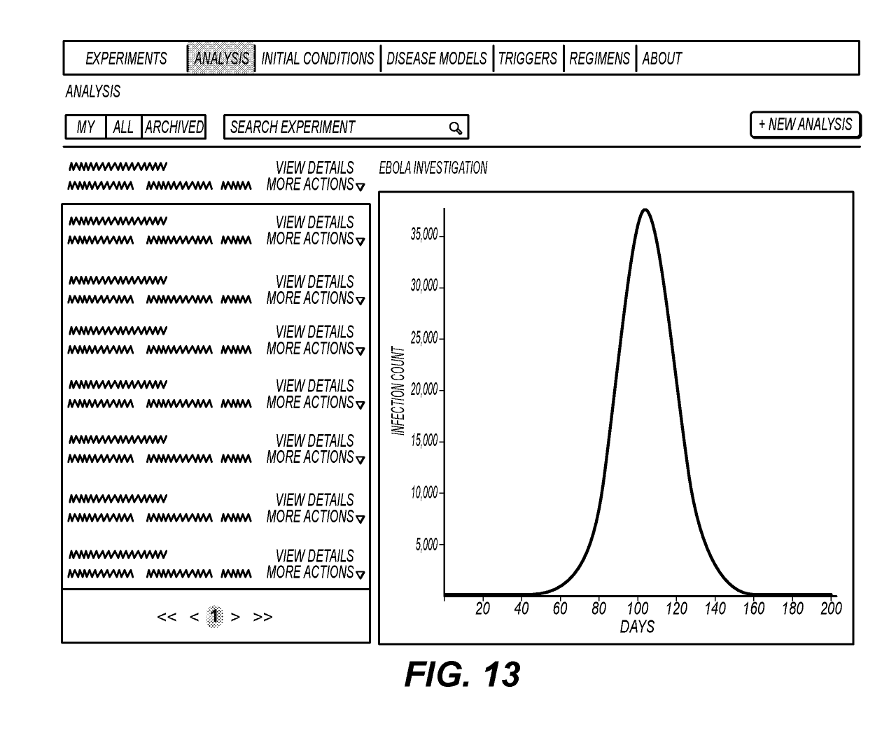

FIG. 13 shows an example user interface providing results of an experiment. When an experiment is completed, generated data are stored together and identified as the Results of the experiment, available through the Analysis page. Clicking the Analyses menu at the top (second from left) brings up the Analysis List Grid (left panel). The system can respond to user commands to create a new analysis or duplicate an existing analysis. Users can edit an experiment to change details and select the cells of the experiment completed in previous step. New and existing Analyses can be listed in the Grid (left side). When an Analysis is finalized, the user may access the results via the View details section of the analysis (right side, graph).

FIG. 14 shows an example user interface providing an overview of experiment status, and showing different disease models than FIG. 12. The grid view on the left can be searched for text entered “search experiment” box or can be sorted by timestamp, owner, name, status (e.g., new, running, completed, or failed), or other criteria. An “archive” control is available for all experiments in My List of a user. To archive an experiment, the user can click on “more options” and select “Archive.” The user can move an experiment back to the “my experiments” list using the “Restore” option available for all archived experiments.

A “View Cells” option can be available for an experiment. Clicking View Cells causes the system to read the parameters selected for independent variables in the experiment, e.g., the combination of intervention specifications and the parameter(s) to be swept, and to generate the required cells. These cells comprise the specification of the conditions for the experiment to be run, considering combinations of all the sweep and non-sweep values. Examples are discussed herein, e.g., with reference to block 806.

FIG. 15 shows an example user interface permitting a user to specify parameters of an experiment. As discussed herein with reference to FIG. 12, not all parameters of the experiment have been provided. The short preview cards display only the Details card populated and all other cards (e.g., Region, Disease Model, Initial Conditions and Interventions) empty with a “+” sign indicating the user may add information to those cards. Clicking on any card can summon a corresponding detailed view; examples of detailed views are discussed below. In some examples, a newly created experiment will have only the Details card completed until the user adds other parameters.

The illustrated “not runnable” display in the upper-right can represent a Progress bar displayed to indicate the experiment definition state and run state. For each card defined (Details/Region/Initial Condition/Disease Model/Intervention), the % complete shown on the progress bar can increase by a corresponding amount, e.g., 20% for a five-card experimental setup. The experiment state text in the progress bar can change from Incomplete to Runnable only when all required parameters (e.g., Details, Region, Initial Condition, and Disease Model) are defined. The progress bar can turn from Red to Yellow to Green in the order of its readiness for simulation. For a completely defined experiment all cards will be defined/selected in the detailed preview. On the right side top corner the Progress Bar will indicate “Runnable” state in a green color. In some examples, the user has a choice of creating a new, e.g., disease model, or of using an existing disease model, and likewise for regions, initial conditions, and interventions.

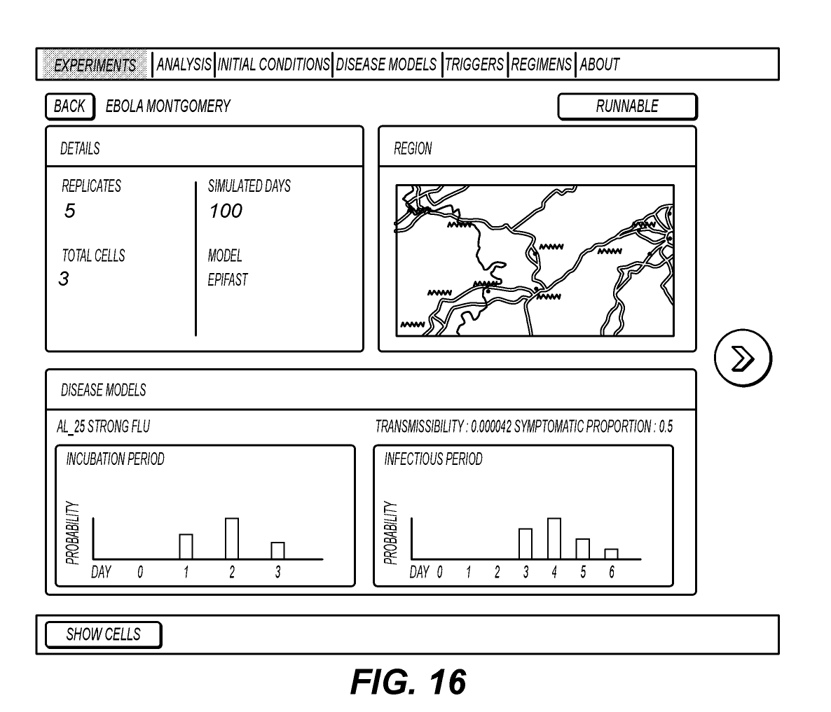

FIG. 16 shows an example user interface after selection of parameters on FIG. 15. The “DETAILS” card can show (or permit user entry of) details, e.g., at least one of the following.

Name: A unique name to identify the Experiment. A system generated name is prepopulated. The user can retain the default name or provide a new Name.

Description: An optional text field to describe or provide additional information for the experiment.

Status: Provides the state of the experimental run. For a new experiment it will be pre-populated as “New.”

Owner: the name of the user who created the experiment. It is a pre-populated field. For new experiment it will be pre-populated with the logged-in users username.

Model: A selection, e.g., a drop-down list, of simulation engine types. To facilitate simple experimental designs, Epifast can be used; to facilitate complex experimental designs, EpiSimdemics can be used.

Replicates: The number of times the experiment will be run. Default value can be 25. Each run will use a different random number seed (randomization value 432), e.g., defined by the Initial Conditions Daily Seed. In some examples, each replicated experimental run is identical to all others for the parameters of the experiment—Initial Conditions, Disease Models, etc.—but varies in terms of the random number seed used to establish the initial state of the simulation based on the parameters for the Initial Conditions.

Total Cells: Total number of cells in this particular Experiment. It is dependent on the Intervention and Triggers values. For Experiments without Interventions the Total cell count is always 1, in some examples. The system may impose a maximum cell count.

Simulated Days: Duration of the simulation period. Default value can be 200.

The “REGION” card can show (or permit selection of) the geographical region in which the simulation will take place, i.e., the region which is affected by the simulated event. The “REGION” card can include at least one of the following.

Search region: Allows searching for a specific region, e.g., by entering first few characters or entire name of the region.

List: a list of all the available regions. Regions can include, e.g., cities, counties, U.S. states or other subnational entities, CDC or other statistical regions, countries, blocs (e.g., the EU or ECOWAS areas), continents, regions defined by polygons in coordinate space, or any combination of any of those.

Map: an enlarged view of the selected region, depicted in or as a map. The region can be zoomed in or out as desired. The user can select, on the map, regions to be included in the simulation area, e.g., nearby geographical areas to which an epidemic may spread.

Disease Models represent how an event affects a synthetic entity, e.g., how pathogens affect a synthetic person. The “DISEASE MODEL” card can show (or permit user entry of) details, e.g., at least one of the following.

Name: a name of the model

Transmissibility, symptomatic proportion, or other statistics or parameters that apply to the event as a whole without regard to the time at which consequences of the event begin to apply to a particular synthetic entity.

Incubation period, infectious period, and other values that depend on the onset of the event with respect to a particular synthetic entity. In FIG. 16, once a synthetic entity is infected by the flu (day 0), the virus will incubate for up to three days, and the synthetic entity will be infectious with given daily probabilities from days 3-6.

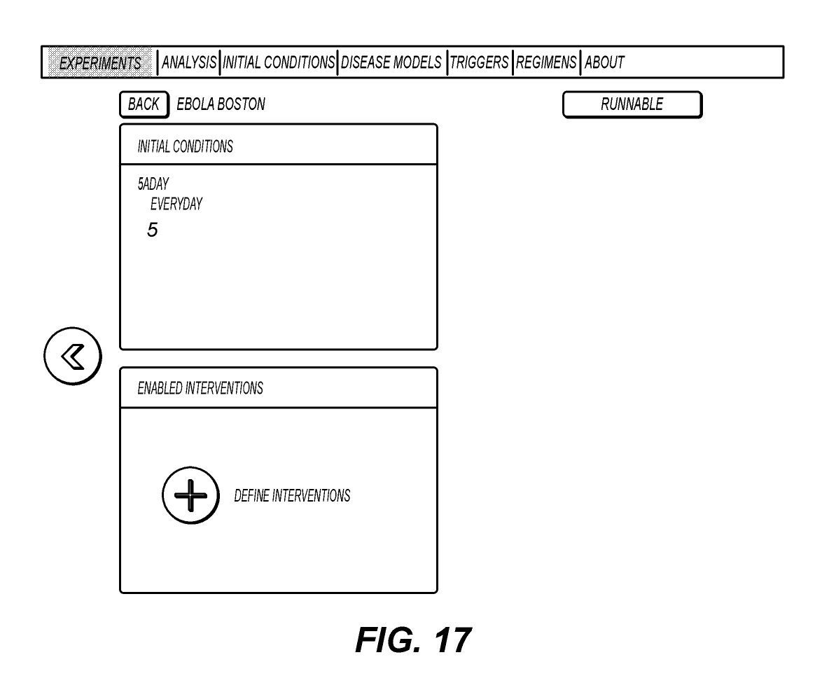

FIG. 17 shows an example user interface providing permitting a user to specify additional parameters of an experiment. In some examples, FIGS. 16 and 17 correspond to a single experiment. As shown in FIG. 16, the experiment is “RUNNABLE” even though an intervention is not defined on FIG. 17. This can permit simulating the course of an event in the absence of interventions.

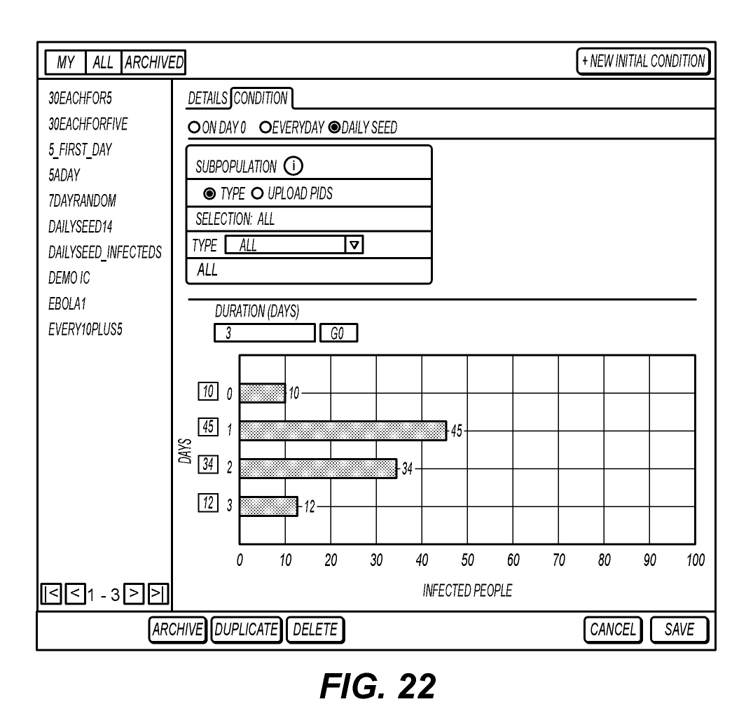

Initial conditions are a way to define the onset conditions of an epidemic or other event. The “INITIAL CONDITIONS” card can show (or permit user entry of) details, e.g., as discussed herein with reference to FIG. 22.

Interventions permit studying effects of different strategies, like treatments on population, or distancing measures on controlling pathogens or disease spread in the population. Simulations can be performed on realistic socio-technical networks of synthetic populations, in which each synthetic individual is represented by a node and edges (e.g., directed or undirected) represent activity between nodes. Examples of such networks are described herein with reference to, e.g., FIG. 1, 3, 5, 6, 9, 10, 11, or 36-42. Simulations of interventions over these complex directed graphs of population can include removal of edges and contacts amongst nodes, or changes to edge labels or parameters. Simulation can alternate between modifying edges and evaluating the effects of the resultant graph. Examples are discussed herein, e.g., with reference to blocks 516, 522, 646, 810, or 812, or FIG. 7. Over the course of a simulation, R (reproductive number) estimates can vary. R values can be estimated, to permit analyzing effectiveness of particular intervention strategies for a particular event.

Various examples permit analyzing complex, high-variability scenarios on entity-interaction networks to gain evidence for proposed hypotheses or to effectively plan and prepare for events.

The “ENABLED INTERVENTIONS” card can show (or permit user entry of) details, e.g., of choices or parameters of at least one of the following types of interventions. Any number of interventions of any types (in any combination) can be used, in some examples. Types can include: Vaccinate; Social Distance; Close Work; Close School; Pharmaceutical Treatment; Pharmaceutical Prophylaxis; Table-defined Intervention; or Dynamic Sequestration. Examples are discussed herein, e.g., with reference to block 312 or data 314.

The “ENABLED INTERVENTIONS” card can show (or permit user entry of) details, e.g., of at least one of the following:

Name of the intervention: a user-defined name for convenience in referring to particular intervention data 314,

Sub-population: data indicating the interaction of demographics with the dynamics of disease propagation and the impact of disease on socio-technical systems. Subpopulations can include a type and a category. Subpopulations can be selected from the population, e.g., by age, county of residence, or occupational category (e.g., public-safety-critical worker or not). For, e.g., Age, Subpopulation selection can be based on age category, and the categories can include preschool, school-age, adult, seniors, etc.

Trigger: After the onset of an epidemic event, interventions may be triggered by conditions that emerge during the event. For example, the simulation can determine that intervening by Closing Work should be performed in response not, not before, the onset of the event. The set of conditions to initiate the onset of an intervention is referred to as a Trigger. Specification of triggers is possible for each individual intervention.

Compliance: Compliance refers to the probability that an individual might be selected for inoculation or other intervention. For example, a compliance rate of 90% means that 10% of the individuals will not be inoculated.

Efficacy: It refers to the probability of transmission of the disease (or propagation of other consequences of an event) after having been inoculated. The efficacy can be specified as the percentage of the population on which the inoculation is 100% effective, or is at least a threshold percentage effective.

FIG. 18 shows an example user interface permitting a user to specify data of an intervention, e.g., data 314, 644, or 1032. As shown, the interface permits entering values such as those described above with reference to FIG. 17. As shown, the available intervention types are listed across the top. Examples of the fields available for specific interventions can be as follows. One or more interventions can be created of each type, each intervention having respective parameters. Interventions can be edited until the experiment is started. Different Intervention components e.g. Subpopulation, compliance, Trigger, Delay, Efficacy, Regimen and Diagnostic rate can be edited separately for all the interventions attached to the experiment.

For any intervention, a duration can be specified as a value or sweep. The controls (e.g., sweep, value, initial, final, and increment settings) can function as described below for vaccinations. For regimen-based interventions such as pharmaceutical prophylaxis and pharmaceutical treatment, regimen duration can be used as the duration of the intervention. Duration for vaccination can be the number of simulation days for the experiment.

Intervention type: Vaccination

Vaccinate represents immunizing a selected set of population. It is possible to specify a percentage of the population that complies with this intervention (i.e., the percentage who are vaccinated), a trigger for when the vaccination is applied during the course of the pandemic, and the efficacy of the vaccination. To add a new Vaccinate intervention click on Create New+ button on the Vaccinate Intervention Page. A vaccinate intervention form opens with textbox for name and separate cards to specify detail of sub-population, compliance, trigger and efficacy.

Sub-population: To support simulation and analysis, pre-defined subpopulations in the selected geographic region for the experiment are included for selection for vaccinate intervention plan.

Sub-population Type: The population of a region is logically grouped according to age, working group, infection prone group etc. All the available sub-population Types in the example Region will be listed and available for selection.

Sub-population Categories: The population groups are further classified as categories with specific range/conditions. Example: for Age as the Type, the Categories available are, e.g., Pre-school, School-Age, Adults, or Seniors, along with the % of sub-population. A percentage of the selected sub-population categories can be selected, e.g., using a slider. The selected sub-population percentage can be displayed below the slider.

Compliance: the user can set compliance by specifying % Value or using Sweep. “% Value” defines compliance as a single set point value, e.g., X %. It indicates that X % of individuals in the experiment's selected subpopulations should comply with the intervention. Specification of this value will define a single cell for the experiment. “Sweep” defines as a range of values from an initial value to a final value by an increment, e.g., 20 to 50 by 10. The Initial Value is the starting value for sweep process to generate cells. The Final value will not be exceeded by any cell. The increment will be added to each cell value to create the next subsequent cell.

Trigger: the condition to trigger the intervention. A condition of “On Day” defines the onset of the intervention on specific days, e.g., as a percentage of the elapsed time of the event or as sweep values. A condition of “% Infectious” defines the onset of the intervention when the percent of infectious individuals in the specified subpopulation reaches the indicated value (or values, for a sweep). A trigger delay can be specified, indicating the trigger delay specified in days after beginning of the experiment. It can be a single value or a swept value. For example, for cholera, the delay can be set for 31 simulated days, after which the trigger will be applied.

Intervention Efficacy: as noted above, e.g., the percent of the population on which the intervention is 100% effective. Can be a single or swept value.

Rate of Administration: the number of doses of intervention to be delivered each day to a fraction of subpopulation, following the trigger event. During simulation, the sub population can be divided into groups based on the user specified rate. The intervention can be applied to each group on consecutive days for the entire duration of intervention specified after the specified trigger. The intervention rate can be set to unlimited for some or all interventions. In case user selects the rate of administration as unlimited, the entire sub population can be treated as a single group, and intervention can be applied on a single day as specified by the trigger. For example: an intervention and trigger in an epidemic analysis can be to vaccinate school-age kids at rate of 3000/day. If there are 30000 school-age kids in population and the trigger fires on day 10, then there can be 10 vaccinate interventions: one each for days 10-20, each with a respective 3000 of the 30000 school kids, and the specified compliance rate can be applied each day.

In some examples, triggers are the set of conditions that is obtained to initiate the onset of an intervention which may be triggered by conditions that emerge during the event are called a Trigger. Triggers are the reusable component for interventions of any experiment. At least the following two types of triggers can be available. On Day: Specification of an “On Day” trigger means that an intervention is applied on the day specified—that day being the number of days after the onset of the event. “% Infectious”: Specification of a “% Infectious” trigger means the intervention will be applied as soon as the percentage of individuals in the subpopulation exceeds the trigger threshold on a single day. Either the On Day value or the % Infectious value can be single-point or sweep. The % Infections trigger for an experiment can be specified with respect to a Subpopulation, % of that subpopulation that is infected, and Delay. Subpopulation selections as discussed herein can be used. Multiple subpopulations can be selected. The Delay can represent the number of days (≧0) from onset of the disease to when the trigger conditions will begin to be checked. That is, a trigger will not fire until the number of days specified in the Delay has passed. For Delay and other time ranges herein, days are used for convenience of explanation. However, other time scales can be used, e.g., minutes, hours, weeks, or months.

Intervention type: Social Distance

This type represents limiting non-essential activities in an individual's daily schedule to reduce the probability of disease transmission. Non-essential activities are those that occur at locations in the model other than home, work, and school. The edges in a social network graph that represent these non-essential activities are probabilistically removed based on the compliance rate. Similar to the Vaccinate Intervention, Sub-population, Compliance, and Trigger can be set for Social Distance.

Duration represents the time/duration in days for which an intervention can be applied during the experiment run. This parameter is available to the user for social distance and similar interventions such as close work, close school, dynamic sequestration, or table-defined interventions.

Intervention type: Close Work

Intervention Close Work represents the closure of work places and the elimination of work activities to reduce disease transmission. All edges in the social network graph that represent work contacts are probabilistically removed based on the compliance rate.

Intervention type: Close School

Intervention Close School represents closure of schools and the elimination of school activities to reduce disease transmission. All edges in the social network graph that represent school contacts (including college) are probabilistically removed based on the compliance rate.

Intervention type: Pharmaceutical Treatment

Intervention Pharmaceutical Treatment represents, e.g., antiviral drugs that can diminish the infection to a level sufficient for the natural immunological responses of a body to defeat it.

Diagnostic Rate represents the proportion of the infectious individuals who get diagnosed, and thus are treated. This is for treatment purposes only. For individuals who are diagnosed, the treatment starts on the first day of infectiousness and ends once the regimen is completed. The remaining controls (Sweep, Value, Initial, Final, and Increment) can function in the same way as specified for Intervention: Vaccination. However, units are calculated in percentage of the selected subpopulations for diagnosis, in some examples.

Regimen: A prescribed course of medical treatment for the restoration of normal health of an individual. Regimen parameters allow the user to set choose a number of Available Doses, or Unlimited Doses, as a constraint on the total number of doses for both treatment and prophylaxis. This constraint can be related to stock available or limitations with respect to age, sex, or genetic profile of the population. For a particular regimen, the user can specify: Name (Name of the Regimen. E.g., Tamiflu Treatment); Duration (Number of days for which medication is prescribed. If used as prophylaxis, individual is considered as protected for this duration.); Units per Day (Number of pills individual consumes per day); Infection Efficacy (Reduction in the probability of infection); or Transmission Efficacy (Reduction in the probability of transmission).

Intervention type: Pharmaceutical Prophylaxis

Pharmaceutical Prophylaxis is application of medication that specifically fights a viral infection. Pharmaceutical Prophylaxis for sequestered subpopulations can have unintended consequences by masking the symptoms of some infected individuals, and allowing their introduction into small sequestered groups. The result can be a greater infection rate within the protected subpopulation.

Intervention type: Table-defined Intervention

This permits a customized intervention to be applied. A table-defined intervention can allow risk of infection through each activity type to be scaled independently. The five activity types can include home, work, school, shopping, and other. The edges in the network graph that represent contacts due to the five activity types (e.g., edges labeled with those activity types) are scaled per the user-provided values for the factor. Similar to social distance interventions, subpopulation, compliance, trigger, duration, and rate of administration can be set for table-defined interventions. The scaling Factor can be a collection of numeric values (e.g., reals) that sets the scaling factor for each of the five activity types. Edges can be scaled equally or differently depending on edge direction in a directed graph. An Infectivity multiplier can apply to the “in” edges of the network graph due to the five activity types of the individual affected by the intervention. A susceptibility multiplier can apply to the “out” edges of the network graph due to the five activity types of the individual affected by the intervention.

Intervention type: Dynamic Sequestration

This implies isolating healthy individuals from susceptible population to attempt to protect them from infection. This involves sequestering a specified sub-population randomly in specific group sizes on a particular day specified, followed by simulating disease spread. The selected Group Size can indicate the number of individuals in a sequestered group. Group size can be defined as a value or a sweep.

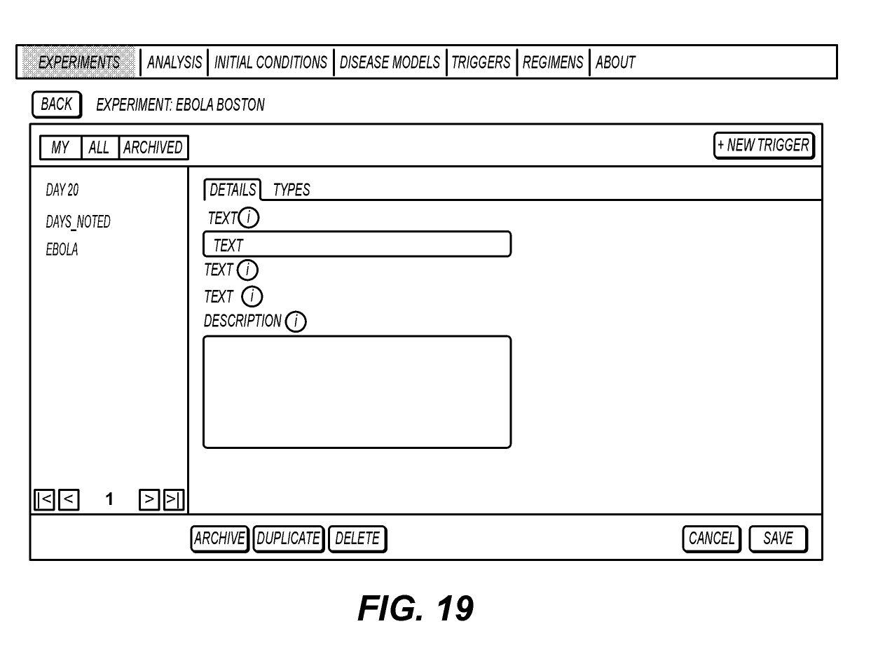

FIG. 19 shows an example user interface permitting a user to specify details of a trigger. The example UI can permit user entry of parameters such as those described herein with reference to, e.g., FIG. 18.

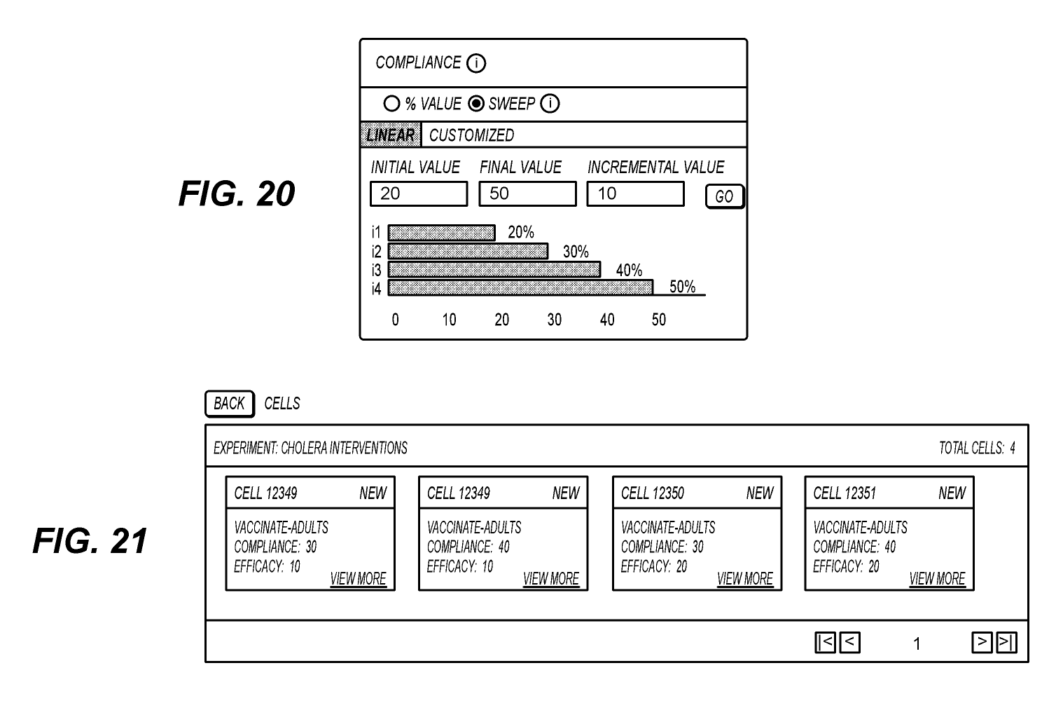

FIG. 20 shows an example user interface permitting a user to specify a sweep of parameters of a simulation. As discussed above, the user interface can permit specification of initial, final, and increment values. Additionally or alternatively, the user interface can permit specification of specific values to be tested (“customized”). The sweep is a short-hand way of specifying several experimental cells that vary by one parameter. Interventions, Initial Conditions, Disease Model, and triggers for an experiment as may be specified by a sweep. The sweep can be specified either as a linear sweep or Customized sweep.

Linear sweep is specified as a range of values with Initial value, Final value and increment value. Initial Value: Starting value for sweep process to generate a range of cells. Final Value: Ending value for the parameter to be set during a sweep. The final cell generated by the sweep will not exceed this Final Value. The final cell generated in the sweep will be set at the Final Value, regardless of the increment size. Increment: Size of the change in percentage of population to be used during sweep generation of cells. This increment will be added to each cell value to create the next subsequent cell.

If a sweep is specified, the system will generate a set of experimental cells that begin at the Initial value, and represent each level of the parameter above the Initial value incremented up to and including the Final value. For example, if the analyst were to sweep Infectious from 30% to 70% in increments of 10%, the cells generated would represent percentages of 30, 40, 50, 60, and 70, respectively.

Customized sweeps permit entering arbitrary (but bounded with in the range permitted by the simulation) values, e.g., entered as comma separated values. The system generates cells with each of the specified sweep value. For example if the analyst were to sweep “% Infectious” as “15,38,90”, the cells generated would represent percentage of 15%, 38% and 90%.

FIG. 21 shows an example user interface providing an overview of “cells,” i.e., different sets of experimental conditions to be tested. Examples of testing different sets of conditions are described herein with reference to blocks 436 and 450, FIG. 4. In some examples, activation of a “View Cells” command (e.g., from the “More Actions” dropdown on FIG. 12 or 14) causes the system to read the parameters selected for independent variables in the experiment—the combination of intervention specifications and the parameter to be swept—and generate the cells of the experiment. These cells comprise the specification of the conditions for the experiment to be run, including all combinations of all the sweep and non-sweep values. The illustrated example shows four cells generated from a sweep of compliance values over the set {30,40} and a sweep of efficacy values over the set {10,20}. In some examples, the illustrated UI shows only those parameter values that differ amongst the cells of an experiment. The “view more” link can be activated to summon a display of all the parameters defined for the intervention, e.g., in a pop-up window.

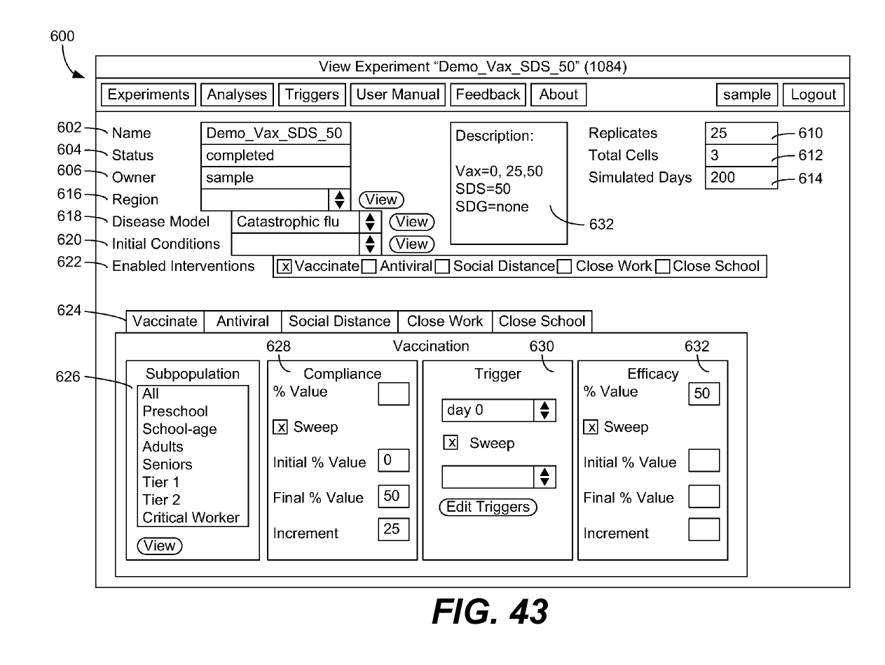

FIG. 22 shows an example user interface permitting a user to specify initial conditions of an experiment. Examples of specifying an initial infected population and other initial conditions are described herein with reference to blocks 304 and 504. Initial Conditions can allow the user to specify a number of affected (e.g., infected) individuals in a population, to mark the event (e.g., disease) onset. In some examples, e.g., of epidemics, a mixed Population of Infected and susceptible individuals is setup to start with the simulation experiments of event progression. Examples are discussed herein, e.g., with reference to blocks 306, 504, or 1026, or FIG. 37 or 43. Random selection of individuals as per configuration parameters can occur at a specified time during each iteration, so different iterations (replicates) can set up different initial infected populations. Accordingly, cell outcomes can differ per the set conditions, permitting variability analysis.

Initial conditions can be defined in at least one of the following ways, described in the context of epidemic simulations. Similar initial conditions can be used to determine initial populations affected by events other than epidemics. The “upload pids” option can permit selecting specific nodes or subpopulations to be initially infected. The “subpopulation” box can permit the initial infected population to be selected from a subset of the full synthetic population (e.g., selected by age, risk level for an event or epidemic such as high-influenza-risk, or criticality of profession); alternatively, type “all” can indicate the full synthetic population. Ways of defining initial conditions can include: Day 0: Specify the number of people infected on day 0; specific nodes will be selected randomly. The number marks the infected count at the beginning of the Infectious disease period. Every day: Specify the number of people (or other entities) newly infected per day (e.g., 0.5 people per day). This defines the infected count per day as disease progresses. Daily Seed: Specify the numbers of people infected on specific observed days. This represents infected count reported on particular days of infectious period. Daily-seed values can be entered or displayed graphically via the bar graph (FIG. 22, bottom).

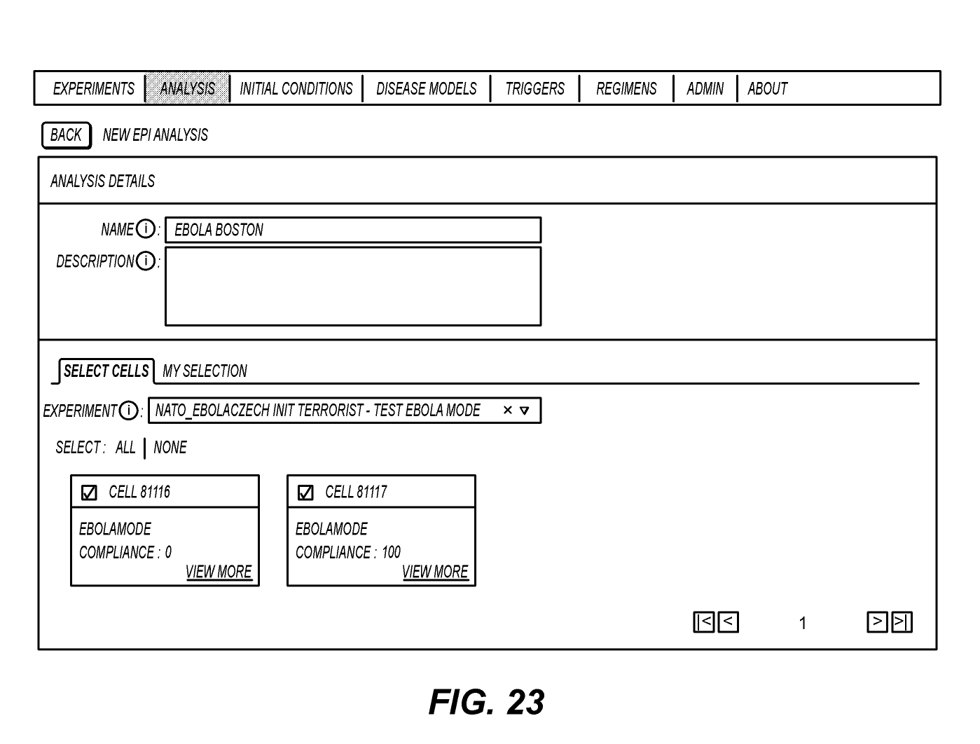

FIG. 23 shows an example user interface permitting a user to specify parameters of at least one analysis to be performed. Each cell (independent run within the experiment, as noted above) is associated with experiment results. For example, each Cell can include data of a distribution outcome of the specified replicates of parameters configured in experiments. Cells from an experiment or different experiments can be analyzed individually or aggregated to perform analysis. Visualization can be provided in the form of a wide range of graphs to support analysis and decisions. For example, analysis may be conducted for: Increasing Situational Awareness regarding various emerging Infectious diseases; Study of new strain disease characteristics and its impact on disease spread in populations; Predictions of a next wave of an epidemic or pandemic in populations; Assessing and comparing the consequences of proposed interventions; Understanding the differential impacts of interventions; supporting Decision making by prioritizing intervention strategies applied; preparing and Planning vaccination strategies in case of a Pandemic; Antiviral stock planning; Developing targeted surveillance for efficient situation preparedness; or determining relationships between epicurves and R values. The illustrated user interface can permit a user to enter parameters of analyses to be performed, e.g., to select an experiment and cell(s) of that experiment for display or analysis.

In some examples, animations of the data over the duration of the simulation can be provided, e.g., as computer-generated movies. For example, a movie can show a result plot, e.g., an epicurve, that fills in from left to right as (accelerated) simulation time progresses.

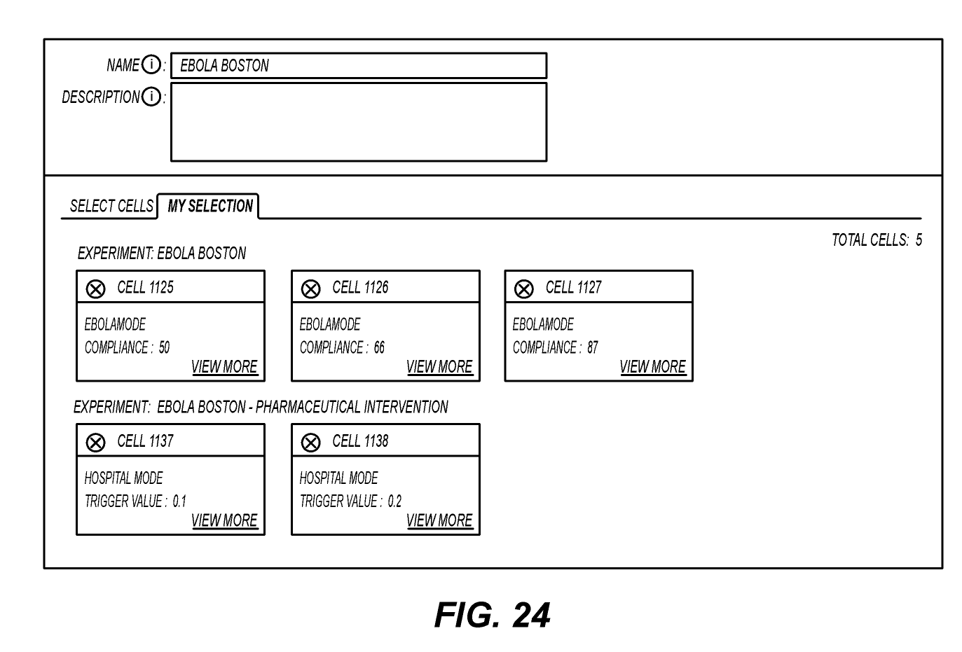

FIG. 24 shows an example user interface permitting a user to specify which cells should be used in an analysis. As shown, the analysis will draw data from three cells of a first experiment and two cells of second, different experiment.

FIG. 25 shows an example user interface presenting results of an experiment, e.g., as discussed herein with reference to blocks 434, 902, 912. The illustrated user interface permits a user to specify particular cells, replicates, or sub-populations to be displayed or analyzed (“Data Filter” panel) and permits the user to specify the manner of showing the results (“Plot Type” and “Plot Configurations” panels). The Shrink Graph control permits the user to shrink the plotted infection graph. This can be useful in cases where the amount of data to be plotted is large and so the data overlays the legends of the plots. In such cases the user can shrink the graph so the legends are legible. The Hide/Unhide legend control permits the user to hide/show a legend of the cells/replicates plotted in the graph. The “Snapshot” control can permit the user to download the application view displayed at a particular point of time in the form of an image. In some examples, curves such as those shown in FIGS. 25 and 26 can be generated by the back end 116 and sent to the front end 114. Additionally or alternatively, the curves (or at least some of the curves) can be generated by the front end 114.

The Plot Configurations panel can permit user control of at least one of the following. Infection Count: Plot actual infection count or cumulative infection count of the selected cells for a day range. Show proportion: Plot proportionate of the actual or cumulative infection count of the selected cells for a day range.

The Data Filter panel can permit user control of at least one of the following. Cells: Plots the infection data for the cells selected from the list by the user. For each cell user can select the option to view the infection data for the replicates of the cells. User can select a set of the replicates for which the infection data should be plotted. Sub Population: User can also view the infection data for different sub population categories for each of the selected cell.

The Download Data control permits the user to the download the analysis results in the form of, e.g., a spreadsheet file. The downloaded analysis data can include at least some of the below data for each cell of the analysis. For example, an analysis with 2 cells can have multiple spreadsheets with infection data (e.g., mean infection data, sheets for infection data of replicates for each cell, and a sheet for infection data of all the sub population category for each cell). Mean infection data: The means of the infection data of all the replicates of each cell for the experiment duration. Infection data for replicates: The infection data for all the replicates of each cell for the experiment duration. There can be separate sheets with the replicates infection data of each cell.

For example, an analysis is run with two cells, identified as 1 and 2, for a duration of 200 days. Each cell has 25 replicates. There can be two separate spreadsheets, one for cell identifier 1, and one for cell identifier No 2. The sheets can be named 1_reps and 2_reps. 1_reps sheet can have infection data for each day of the experiment duration for all the 25 replicates of the cell with identifier 1.

Mean Subpopulation Infection data: The mean of the infection data for each sub population category for each cell for the experiment duration. There can be separate sheets with sub population infection data for each cell. Continuing the example above, there can be two separate sheets, one for cell identifier 1 and one for cell identifier No 2. The sheet for cell 1 can be named 1_meanSubPopInfection data with mean of the infection data for each sub population category for all the 25 replicates of cell identifier 1.

FIG. 26 shows another example user interface presenting results of an experiment, e.g., having capabilities and feature such as those described herein with reference to FIG. 25.

Referring to FIGS. 25 and 26, Epicurve analysis can permit visualizing the progression of a disease over time in the population considered. Simulations can be run on synthetic entities at a given time resolution, e.g., a day or week. The epicurves generated are plots of infected cases per day during the simulation trajectory. Epicurves can be used to investigate Modes of Transmission, Cases first exposed, Exposure duration, Nature of epidemics (point/propagated), Primary cases or Secondary cases, Secondary attack rates, Incubation period and Infectious period, or Case-fatality ratio (indicating how fatal is the infectious disease).

Various aspects provide analysis features useful for the computation of estimates of R. Various aspects compute Wallinga likelihood estimations of daily R values from the simulated transmission tree(s), disaggregated by demographics or geographics (e.g., the average number of children infected by a single infectious child). Various aspects provide comparisons of summary features of the daily R curve, e.g. maximum slope or slope near R=1. Various aspects perform statistical analysis of the influence of input parameters on these summary features. Various examples permit comparing daily R values such as Estimated_R, calculated using Wallinga estimate on transmission trees, with Actual_R, calculated as an instantaneous derivative of the number of new infections each day from simulation data on epicurves. Wallinga estimates can be used to infer generation times. In some examples, the generation times used in simulation can be used in deriving Estimated R for studying the disease characteristics. Various examples can permit assessing likely outcomes of disease progressions with applied interventions over large networks.

Various examples estimate relations between R (Estimated_R) and ρ (Growth rate—Actual_R) in a fully-mixed population by estimating Growth rate ρ using a 10-day regression window to filter background noise from the early phase of the epidemic. This can permit more accurately estimating R in the face of complex, time-varying real-world epicurves.

The plots, such as: Actual Effective R, Estimate of Effective R, Slope of Actual Effective R, Slope of Estimated Effective R are now available to view data with these estimates. R curves can clearly show the intervention's effect, and may show that a proposed intervention may not, by itself, be sufficient to stop the outbreak. Epicurves can suggest that the intervention changes the extent of the vulnerable population (the eventual attack rate) more than might be expected on the basis of the change in R.

FIG. 27 shows an architectural diagram of an example analysis system. The system can permit submitting jobs on a computer cluster. Job submission can entail at least one of the following. 1. Create input files needed to run the Job. 2. Place the executable on cluster that will read input from inputs files and produce some output. 3. Submit the job on cluster using QSUB command 4. Monitor the progress of Job and notify once the job gets completed. 5. Verify whether Job execution was successful or were there any errors. 6. In case of errors, inform the application about the reason of error in execution 7. In case of successful execution, copy the output from cluster to application server. The illustrated middleware can encapsulate steps in the job lifecycle and provide a straightforward interface to submit jobs on the cluster and determine the status of submitted jobs.

The illustrated example middleware (referred to without limitation as “Enterprise Middleware”) is a heterogeneous system including components designed based on technologies like JMS, DROOLS, and EJB etc. Throughout this discussion, other components or technologies having corresponding functionality can be substituted for JAVA, DROOLS, TOMCAT, or other specifically-named examples. In Enterprise Middleware system, communication between various components and parallel execution form the foundation of each component. Apart from maintaining the Job lifecycle, Enterprise Middleware also has recovery mechanism embedded in it. Fault tolerance, job overloading, and Cluster resource management are highlights of this middleware solution. Enterprise Middleware provides a simple REST based API (REST is a nonlimiting example), which can be consumed for executing job on cluster. It also provides mechanism by which the output generated at the end of job execution can be transferred to the application server if the environment is setup in such a manner. An example system discussed herein can include at least one of the following components. A. Middleware Service: a. Job Service; b. Callback Service; c. Database Service. B. Job Scheduler (Resource Manager). C. Queue Messaging System: a. Rules Queue (Drools Engine); b. Execution Queue. D. HPC Adapter. E. Cluster: a. Cluster Services; b. HPC Scheduler; c. Heartbeat Services. In some examples, a Database Service exposes REST based API for performing CRUD database operations and APIs for Heartbeat update operations. These API's are called by different components for updating Job status.

In some examples, a job-manager component can have at least one of the following characteristics or functions. Exposes REST based API for consumption by UI layer. Audits logs for middleware objects. Job object and its status details are mentioned in domain package. Exception handling implementation for middleware. Responsible for placing any messages on queue. Resource allocation for processing of jobs belonging to a particular entity. Responsible for exposing methods for consumption by MDB and Callback Service (e.g. to update data library 122 or other databases). Implementing a task throttling system to hold tasks at the source to avoid a large number of tasks from entering the system at once, overwhelming certain components such as the queuing system. Feeding enough to the system to improve throughput while maintaining stability.

In some examples, a messaging component can have at least one of the following characteristics or functions. Listens to messages on the middleware queue. Communicates with business layer and HPC via HPC adapter layer.

In some examples, a rules component can have at least one of the following characteristics or functions. Listens to messages on the rules queue. Business rules are fired by the Rules Service API. Updating the database with job status and task as well as processing messages on Rules Queue.

In some examples, a cluster-services component can have at least one of the following characteristics or functions. REST services are exposed for processing job on cluster for specific tasks. According to the resource allocated, business logic is executed for that particular job.

In some examples, a heartbeat component can have at least one of the following characteristics or functions. Service for polling the cluster statistics like memory usage, processes, and CPU utilization.

In some examples, a scheduling component can have at least one of the following characteristics or functions. Service in this project is responsible for polling job status and informs the callback service present in Job Manager, on job completion.

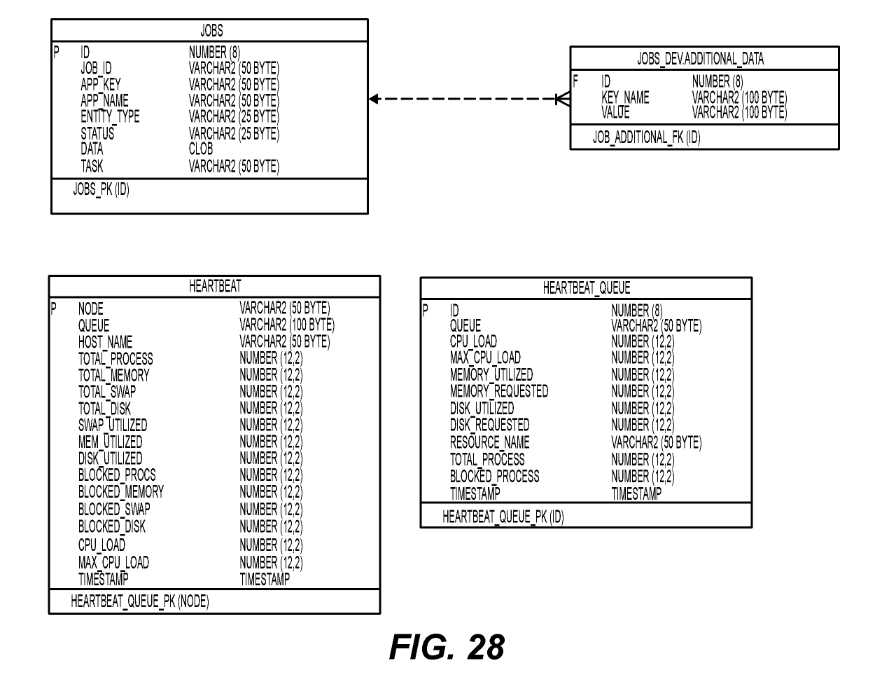

FIG. 28 shows a database schema showing example job and heartbeat tables in a cluster-management system. The Job Service can use these tables. This service acts like an Entry point to Middleware. Job Service provides two API's namely: submitJob( ) and getJobStatus( ). These API's are REST based API such that any application can consume them. This service injects properties into Job object before updating the Job object into database. The properties can include the following.

middleware.url: This property defines which Middleware instance is processing the request. It contains base URL of Job Service, which is used by different components for purposes like—database services, callback services etc.

update.job.endpoint: This property defines the URL endpoint of updating Job object in database. At runtime various components use this property in combination with middleware.url to update the Job status in database.

The service checks whether a Job object exists in Jobs database by comparing its UUID (Universally Unique IDentifier) field. If the Job object doesn't exists then the service assigns the Job object new UUID and then inserts it into the database. If Job is an existing Job object from database, then the service also updates properties of the object before inserting it into database, e.g., the following. resourceName: This property defines on which Cluster the Job will be executed. clusterBaseDir: This property defines the base path on the cluster where the job will create its input and output files.

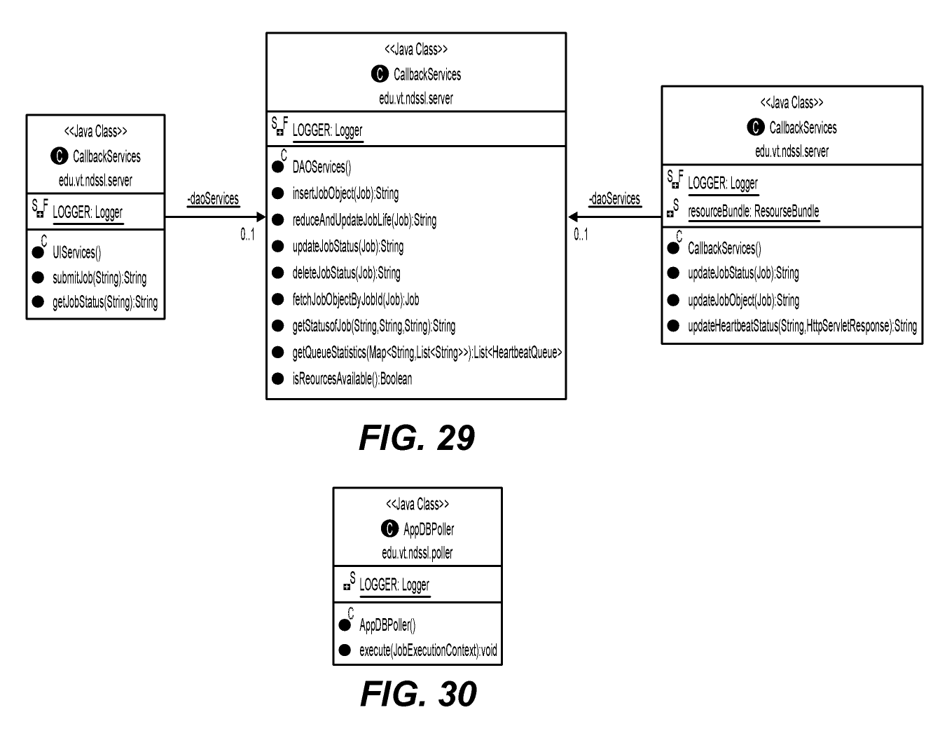

FIG. 29 shows a class diagram of an Application Programming Interface, API, for submitting jobs to a cluster. FIG. 29 can be an example of an API provided by middleware described herein. The API can be provided by a callback service. This service can expose REST based API for consumption by HPC Scheduler and Heartbeat Services. The API's exposed are updateJobStatus( ) and updateHeartbeatStatus( ) (right-hand end). The updateJobStatus( ) API updates the status of the Job into database and puts the Job back on Rules Queue for further processing. updateHeartbeatStatus( ) API updates the heartbeat status of Queue on the Cluster into database. This information is used while allocating Cluster to new Job. The insertJob( ) API saves an object as new Job object if doesn't exists in or else updates the existing Job object.

FIG. 30 shows a class diagram of an API for scheduling jobs or polling job status.

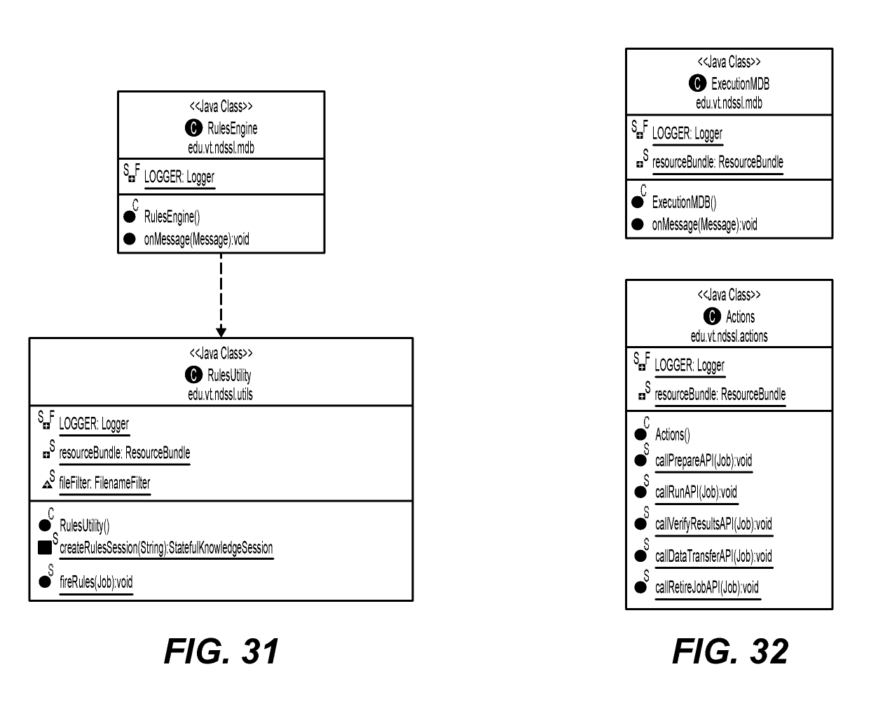

FIG. 31 shows a class diagram of an API for defining rules to be used in executing jobs.

FIGS. 31 and 32 can be implemented by a messaging system, e.g., having a message queue.

FIG. 32 shows a class diagram of an API for use in executing jobs.

Referring to FIGS. 31 and 32, a Job Scheduler can put Job objects onto a Rules Queue. It picks Job objects from database whose status is either of the following values: Posted, Restart, PrepareTaskComplete, PrepareTaskFail, RunTaskComplete, RunTaskFail, VerifyResultsComplete, and VerifyResultsFailed. If a Job is in Posted state, then it assigns Cluster resource to the Job object and updates the Job in database before putting it on Rules Queue. The Cluster resource to use can be determined, e.g., based on predetermined selection criteria for a Queue, e.g., based on Memory and CPU utilization. Also Job Scheduler puts only limited number of Job on Rules Queue. If the number of Job already in progress is equal to the threshold, then Job Scheduler doesn't put any more new Job on Rules Queue. This component can be executed, e.g., after every fixed interval of time.

A Rules Queue & Services can have multiple functions. It implements a JMS Queue, a Drools Engine, and an MDB that subscribes to the JMS Queue. The reason it is called Rules Queue is because all the applications using Middleware can add their business rules (flows) for Job object. This component acts as a decision engine, which decides based on Job's parameter what the next logical step of Job should be. Every application creates a Drools file (.drl) and provides it to this Rules engine. Rules Engine at run time fires all the available rules on Job object put on the Rules Queue. The logic to fire rule on Job is placed inside the overridden onMessage( ) method of the Rules MDB. Once a rule matches a Job, then in the Action part of the rule, some of the properties of Job are changed such that it will proceed to the next steps. Then this updated Job is put in database and written onto Execution Queue.

An Execution Queue & Services component is for executing the Job based on the rules applied and sending the job to the Cluster for processing by invoking the Cluster services API, e.g., via an API URL. The Cluster URL is provided by HPC Adapter. Once the job is given to Cluster for further processing, the database update is called with the updated Job status.

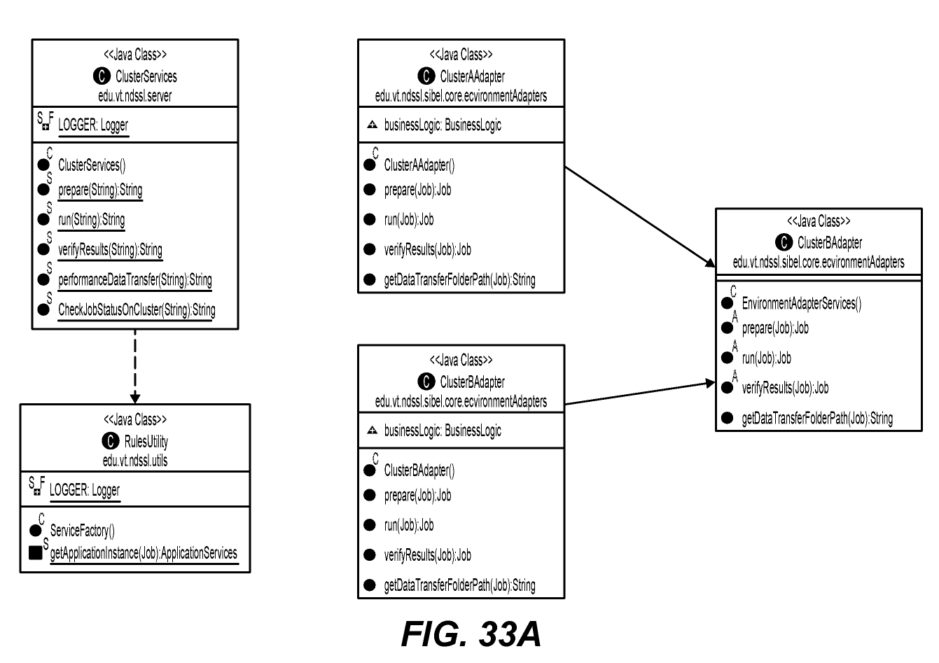

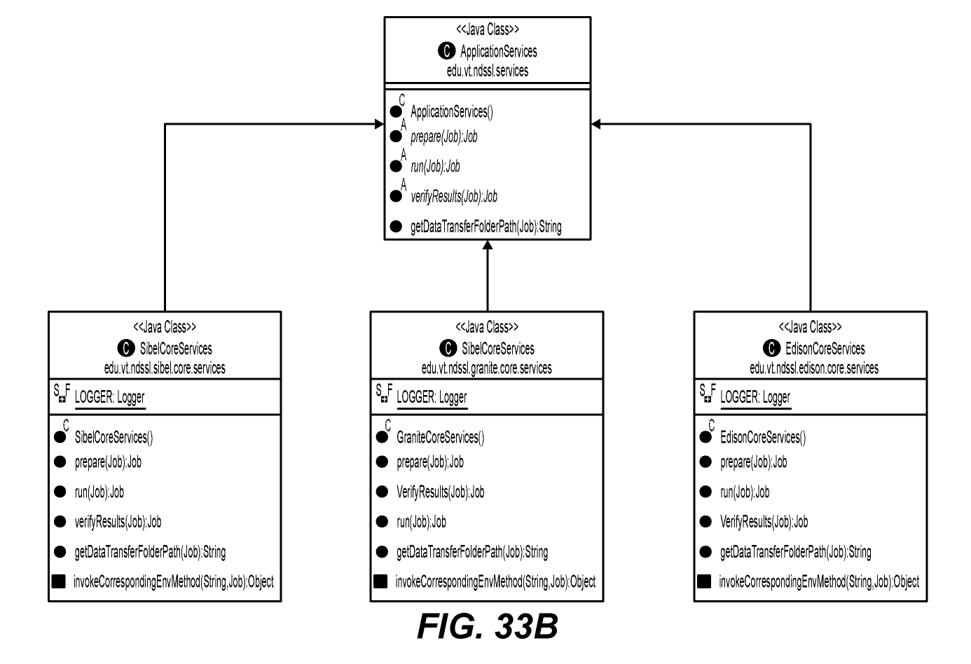

FIGS. 33A and 33B show a class diagram of an API for a high-performance computing (HPC) cluster. An HPC Adapter provides Cluster URLs based on value of “resourceName” and “entityTask” properties of the Job object passed. A Cluster Services component acts like wrapper on actual High Performance Computing (HPC) resources. Cluster Services exposes REST APIs, which are implemented in ApplicationServices class of servicePlugin.jar file. This helps in maintaining compatibility between various applications and also at the same time helps in keeping ClusterServices as broadly applicable as possible. Every application wanting to utilize HPC as a resource can provide a Java Archive (“jar”) file to the ClusterServices. This jar file can contain code that will help in transforming application specific Java object into input files that the executable on cluster can use. This jar can also contain logic to verify the results generated by the executable of the application & some more APIs. Along with this jar file, application can provide parameters such as the following, e.g., via a cluster.properties file.

<APPLICATION_NAME>: This property defines which class inside the Jar extends the ApplicationServices.java class. At runtime, ClusterServices will try to create object of this class. Based on the “applicationName” attribute of Job object, corresponding jar will be loaded and will try to instantiate its class.

<APPLICATION_NAME>.baseDir: This property defines the base directory where all the files related to a particular application will be created on the HPC.

At runtime, when a Job object is received by Cluster Services for the first time, Cluster Services can inject properties such as the following in the Job object.

cluster.url: This property, like “middleware.url” defines the base URL of the cluster on which the Job was executed. This is used by Recovery mechanism in case due to some error the Job doesn't complete its flow.

check.jobStatus.endpoint: This property defines the name of the API to be called after prepending the value of the property “cluster.url”.

clusterBaseDir: This property is used by application specific properties present in the Jar. Application code needs to create all the file/folder structure it needs to create inside the folder of the value of this property. This helps in keeping files of different Job of Same Application but different instance (aka Same Application Multiple Instance aka SAMI).

An HPC Scheduler component can implement various scheduling techniques or algorithms, e.g., a Scheduled Executor algorithm that executes with fixed delay of time. The HPC Scheduler can notify the Callback Services of status changes of jobs on the cluster. It polls Cluster for jobs of particular user, which is configurable, and sends update to Callback Services if there is any change in status of any of the Job. HPC Scheduler has a retry mechanism, wherein if a Callback Service is unavailable and a Job has status as ‘C’ on cluster then it will retry to send the ‘C’ status of that job again after some time interval. This storage of failed communication of Jobs status is in-memory and is not persisted in database. Also Scheduler has capability of notifying more than one Callback Service.

A Heartbeat Services module can also be a Scheduled Executor or implement another scheduling technique. Heartbeat services can provide information about Cluster like CPU usage, Memory usage, Disk usage, I/O, etc., at every particular interval of time. This information also indicates that the HPC resource is available for use. Resource Manager uses this information while deciding which HPC resource to submit a new Job to. Heartbeat services and HPC Scheduler are bundled together as single war file and deployed in same container as Cluster Services.

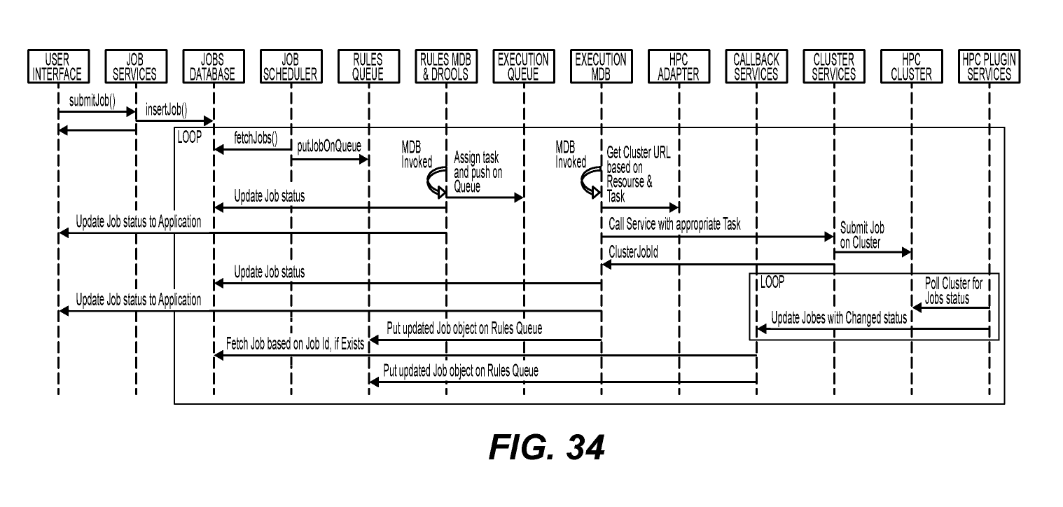

FIG. 34 shows a flow of operations involved in executing a job, e.g., using components shown in FIGS. 27-33B. Depicted is a workflow of submitting a Job in the Enterprise Middleware.

1. When any application calls the submitJob( ) API of Job services, Job services inserts the Job in Middleware database by calling insertJob( ) API and returns the Job UUID to application. The Job status is changed to POSTED.

2. Job Scheduler polls Middleware database for Jobs with status as POSTED or RESTART and puts them on Rules queue. Job Scheduler also assigns the Cluster resource to Job before submitting it on Rules Queue.

3. The Rules MDB consumes this Job object and fires the business rule as defined in the .drl files of each application. The Rules services assigns task to Job object, updates the Job object to database and puts the Job on Execution Queue for further processing. Rules service also updates the application with the Job status if Job has application callback service specified.

4. Execution MDB consumes the Job object put on Execution Queue. Execution MDB calls the HPC Adapter to get appropriate Cluster URL based on the Cluster resources allocated to the Job. Once the Cluster URL is obtained, Execution Queue calls the Cluster URL with the Job object for processing. Execution Queue updates the Middleware database with the response Job object received from Cluster. It also updates the Job status to application and puts the Job back on Rules Queue.

5. Cluster services processes the Job and submits a corresponding Job on a cluster for execution. The Cluster job ID it gets in return from HPC Cluster is updated in the Job object and sent back in response.

6. HPC Plugin Services updates Callback Services about status change of Jobs of particular user. Callback services checks if a Job with such Cluster Job id exists or not. If it exists then it updates the status and puts the Job back on Rules Queue.

7. Steps 2 to 6 are executed in loop till no rules are fired for a Job.

FIG. 35 shows an architectural diagram of an illustrative system. The illustrated user interface component provides interface elements for performing various tasks of the system, such as managing experiments, cells, analysis parameters, and/or other functional aspects of the system. In some implementations, the user interface component may provide a network-based (e.g., web-based) interface for end users of the application. For example, the user interface component may execute on front end 114 or other components of client 124. The user interface layer may interface with Representational State Transfer (REST) APIs, which in turn may interface with REST APIs exposed by the middleware, in some embodiments. In various implementations, the user interface component, which can be implemented by or within interaction module 246, provides interfaces for one or more of the following: creating, saving, and running experiments (e.g., receiving parameters as discussed herein with reference to blocks 304, 312, 436, 512, 524, 636, 642, 802, 904, 1002, 1014, 1022, or 1030); creating and viewing analysis outcomes of experiments (e.g., as discussed herein with reference to blocks 434, 902, 912, or 1108); creating and saving disease models, initial conditions associated with the experiment, triggers (e.g., a set of one or more conditions initiating onset of an intervention), regimens (e.g., interventions involving multiple/repeated steps, such as pharmaceutical treatments), and/or interventions; archiving old experiments, analysis, disease models, initial conditions, triggers, and/or regimens; and/or receiving feedback from the end user regarding the application and/or providing administrative functions, such as activating/deactivating users or changing user authorizations.

The “SIBEL TOMCAT” component, which can be implemented by the tool 128 running on the server 126, can provide backend services (e.g., RESTful services) for managing experiments, cells, analysis, etc. In some implementations, the system uses APACHE TOMCAT® as a container for deploying a web application. The component may deploy REST services (e.g., implemented using ORACLE Jersey) that are called by the user interface component to perform operations. The REST services give calls to a data manager that interacts with the application database to perform operations (e.g., create/read/update/delete, CRUD, operations).

The middleware component interacts with cluster services to execute jobs on the cluster, which may be implemented by the platform 130. The middleware may be a heterogeneous system including components designed based on various technologies (e.g., JMS, DROOLS, EJB, etc.). In some implementations, the middleware component provides a REST-based API that can be utilized for executing jobs on the cluster. In some implementations, the middleware component provides a mechanism by which the output generated at the end of job execution is transferred to a user application server if the environment is configured to allow such a transfer.

The cluster component receives job requests, sends the jobs to be performed, and extracts output of data. A cluster represents a set of one or more nodes where execution of jobs takes place. In some implementations, the cluster component may be implemented as a Torque implementation of Portable Batch System (PBS). In some implementations, a master node chooses one or more nodes to which a job is to be assigned, and may provide an API to check the status of a job.

Various implementations may include features designed to improve the stability and robustness of the system. For example, a task throttling system may hold tasks at the source to avoid a large number of tasks from entering the system at once, overwhelming certain components such as the queuing system. Instead, enough tasks are fed to the system to ensure increased throughput while maintain stability. Some implementations may additionally or alternatively include features to improve the interactivity and flexibility of the system. For example, some implementations allow analysts to view results quickly (e.g., immediately) and interactively, greatly speeding up the interpretation of results. In some implementations, multiple epidemiology applications may be combined into an integrated system and/or adding new areas may be automated, which may reduce or eliminate the use of error-prone, time-consuming manual addition of new areas.

In some implementations, an experiment component may be provided (e.g., within the SIBEL TOMCAT component) that allows the users to define various parameters of experiments and obtain information regarding the experiments. According to various implementations, the experiment component may provide features described herein. Additionally or alternatively, the experiment component may provide one or more of the below features.

A cell display may be provided in which different cells (experiment runs), e.g., defined according to different parameters, may be illustrated. The cell display may provide a view of differentiating factors for each cell up-front instead of comparing the parameters for each cell. In some such implementations, details of parameters of the cell can be seen by selecting a “view cell details” link.

In some implementations, an analysis component may be provided (e.g., within the SIBEL TOMCAT component) that defines various aspects of the performed analysis and/or generates output representative of the results of the simulation. According to various implementations, the analysis component may provide features described herein, or one or more of the following features. In some examples, the analysis may be created on the fly without having to submit analysis jobs on the cluster. This may reduce the time to visualize an analysis. In some examples, interactive analysis curves or other visual (e.g., textual, graphical, etc.) output data may be generated. Rather than, or in addition to, a static output image, users may change various filters/parameters, and the output data may be dynamically modified based on the changes. Examples are discussed herein, e.g., with reference to blocks 524, 904, or 1110. In some implementations, a subpopulation selection may be provided as one of the filter options, such that a user can selectively apply or remove particular subpopulations from the output results and dynamically view the modifications to the output. In some implementations, an analysis listing/summary page may provide a preview of what the output data looks like so the user can view the analysis list and obtain some information without selecting a particular analysis and viewing a detailed page for that analysis.

Analysis output data may be saved to a single output file, such as a spreadsheet (e.g., in CSV/TSV format), which can be used as input for further processing.

An up-front display of the experiment status may be provided such that, when the experiment is running, an experiment status indicator is updated on the user interface to keep the user informed as to the progress of the experiment. In some implementations, the status may include a progress bar that informs the user of a current state of the experiment, how much of the experiment is completed, how much of the experiment remains, time elapsed since the beginning of the experiment, estimated time to completion of the experiment, etc.

A cell display may be provided in which different cells (e.g., defined according to different parameters, such as efficacy levels, levels of compliance with treatment protocols, etc.) may be illustrated and, in some implementations, the cell display may provide a view of differentiating factors for each cell up-front instead of comparing the parameters for each cell. In some such implementations, details of parameters of the cell can be seen by selecting a “view cell details” link.

FIG. 36 shows an example synthetic-population graph (left) including, as components, a social-contact graph (center) and a people-location graph (right).

FIG. 37 shows an example of spread of an epidemic through a synthetic-population graph over time. Circles represent nodes and lines represent edges. Lightly-hatched circles represent uninfected entities, medium-density circles represent infected entities, and darkly-hatched circles represent recovered entities.

Disease models (e.g., FIGS. 12, 14) indicate how a pathogen affects a person and helps trace its propagation through a population. This defines effects of the pathogen on its host as a series of transitions among finite states, e.g., Susceptible, Infected, and Recovered in the SIR model. For running simulations, any Infectious Disease such as: Influenza, Hepatitis, or Gastritis can be defined with the specification of a relatively small number of parameters. Parameters can include at least one of the following.

Transmissibility—Transmissibility is a function of contact duration and contact frequency calibrated to yield specific attack rate in population. Disease severity differs for different strains causing disease and is marked by increase in Transmissibility values. Also temporal variations in transmissibility require definition of different disease models for a particular disease under study. Transmissibility is often ≦0.0001, though this is not required.

Incubation Period Probability—The time period between exposure to the infectious agent and detection of the first signs or symptoms in an individual in population is defined as the Incubation period. The period may be as short as minutes to as long as thirty years depending upon the nature of the exposed pathogen. Incubation period is specific for every disease. The Incubation Period probability values are defined per day as probability that a person from a population becomes exposed and harbors the latent contagious pathogen on that day after exposure to the pathogen. The number of days for which probability values are provided can also be entered as a parameter.

Infectious Period Probability—The time period during which infected entities are able to transmit infection to any susceptible host or vector they come in contact is defined as the Infectious period. Both Symptomatic and asymptomatic individuals can be the possible source of infection dissemination in the population. Infectious Period Probabilities can be defined for each day of infectious period. This is probability that infected from a population are capable of transmitting infection to any other susceptible when in contact. The number of days for which probability values are provided can also be entered as a parameter.

Symptomatic Proportion: what percentage of the infected population exhibits symptoms.

FIGS. 38-43 show examples of computer modeling of interactions among multiple entities, e.g., as discussed herein with reference to at least FIGS. 1-11. These and other examples are described herein with reference to n U.S. Pat. No. 8,423,494, titled “Complex Situation Analysis System,” filed Apr. 14, 2010, which claims priority to U.S. Provisional Patent Application No. 61/169,570, entitled “Complex Situation Analysis and Support,” filed Apr. 15, 2009, and U.S. Provisional Patent Application No. 61/323,748, filed Apr. 13, 2010, titled “Situation Analysis System,” all of which are incorporated herein by reference in their entireties. Statements made in the referenced patent and applications may be specific to a particular example embodiment, or a specific aspect of the example embodiment, and should not be construed as limiting other example embodiments described herein. Features described with regard to one type of example embodiment may be applicable to other types of example embodiments as well; it should be appreciated that the features discussed in the referenced patent and applications are not limited to the specific case models with respect to which they are discussed.

Computer-generated models are frequently used to replicate various real-life scenarios. Such models, for example, may be used to model traffic congestion in a particular area during a particular time of day. Using these models, researchers can estimate the effect that a change in certain variables related to the models may have on the outcome of the scenarios being replicated. Example scenarios can include events as described herein, e.g., epidemics or other occurrences having consequences that may occur over the course of the event.

Computer models may be limited in their usefulness by various factors, including the availability of information with which to construct the network underlying the model. Social contact networks are a type of network representing interactions between entities within a population. Large-scale social contact networks may be particularly complicated to model because of the difficulty in collecting reliable data regarding entities and social contacts within the population. Some social contact network models have addressed this difficulty by utilizing only small data sets in constructing the social contact network. In some types of network models (e.g., the Internet, the power grid, etc.), where the real network structure is not easily available due to commercial and security concerns, methods have been developed to infer the network structure by indirect measurements. However, such methods may not apply to large-scale social contact networks (e.g., large heterogeneous urban populations) because of the variety of information sources needed to build them.

Accordingly, various examples include a complex situation analysis system that generates a social contact network, uses edge brokers and service brokers, and dynamically adds brokers. An example system for generating a representation of a situation is disclosed. The example system comprises one or more computer-readable media including computer-executable instructions that are executable by one or more processors to implement an example method of generating a representation of a situation. The example method comprises receiving input data regarding a target population. The example method further comprises constructing a synthetic data set including a synthetic population based on the input data. The synthetic population includes a plurality of synthetic entities. In some examples, each synthetic entity has a one-to-one correspondence with an entity in the target population, although this is not required. In some examples, each synthetic entity is assigned one or more attributes based on information included in the input data. The example method further comprises receiving activity data for a plurality of entities in the target population.

In some examples, the example method further comprises generating activity schedules for each synthetic entity in the synthetic population. Each synthetic entity is assigned at least one activity schedule based on the attributes assigned to the synthetic entity and information included in the activity data. An activity schedule describes the activities of the synthetic entity and includes a location associated with each activity. The example method can further comprise receiving additional data relevant to the situation being represented. The additional data is received from at least two distinct information sources. The example method can further comprise modifying the synthetic data set based on the additional data. Modifying the synthetic data set includes integrating at least a portion of the additional data received from each of the at least two distinct information sources into the synthetic data set based on one or more behavioral theories related to the synthetic population. The example method can further comprise generating a social contact network, e.g., social-interaction graph, based on the synthetic data set. The social contact network can be used to generate the representation of the situation.

Referring generally to FIGS. 38-43, a situation analysis system for representing complex systems is shown and described, according to various example embodiments. The situation analysis system is configured to build a synthetic data set including a synthetic population representing a target population of interest in an experiment. At least one of the synthetic data set or the synthetic population can be, or be included in, a data library 122. A synthetic population may be a collection of synthetic entities (e.g., humans, plants, animals, insects, cells within an organism, etc.), each of which represents an entity in a target population in an abstract fashion such that the actual entity in the target population is not individually identifiable (e.g., for anonymity and/or security purposes) but the structure (e.g., time-varying interaction structure) and properties (e.g., statistical properties) of the target population are preserved in the synthetic population. The situation analysis system is configured to modify the synthetic data set to include information regarding interactions between synthetic entities that are members of the synthetic population. The synthetic data set can be used to generate a social contact network (e.g., represented as a graph) representing a situation associated with the experiment, which can in turn be used to analyze different decisions and courses of action that may be made in relation to the experiment. The situational analysis system may allow a user to efficiently study very large interdependent societal infrastructures (e.g., having greater than 10 million interacting elements) formed by the interaction between infrastructure elements and the movement patterns of entities in the population of interest.

FIG. 38 shows an organizational chart 100 for a situation analysis system 102, according to at least one example embodiment. Situation analysis system 102 is an integrated system for representation and support of complex situations. System 102 is configured to construct a synthetic data set including a synthetic population representing an actual population of interest and utilize various data sources (e.g., surveillance data, simulations, expert opinions, etc.) to construct a hypothetical representation of a situation. System 102 can then use simulation-based methods to determine outcomes consistent with the hypothesis and use the determined outcomes to confirm or disprove the hypothesis. In various embodiments, system 102 may be configured to create representations of a situation (e.g., involving a large-scale urban infrastructure) involving a large number of interacting entities (e.g., at least ten million interacting entities). In some embodiments, system 102 may be scalable to represent interactions between 100-300 million or more interacting entities and five to fifteen billion interactions.

According to various embodiments, system 102 may be implemented as software (e.g., computer-executable instructions stored on one or more computer-readable media) that may be executed by one or more computing systems. System 102 may be implemented across one or more high-performance computing (“HPC”) systems (e.g., a group of two or more computing systems arranged or connected in a cluster to provide increased computing power). In some embodiments, system 102 may be implemented on HPC architectures including 20,000 to 100,000 or more core systems. System 102 may be implemented on wide-area network based distributed computing resources, such as the TeraGrid or the cloud. In further embodiments, one or more components of system 102 may be accessible via mobile communication devices (e.g., cellular phones, PDAs, smartphones, etc.). In such embodiments, the mobile communication devices may be location-aware and one or more components of system 102 may utilize the location of the digital device in creating the desired situation representation.

In the example embodiment of FIG. 38, situation analysis system 102 is shown to include several subsystems. Synthetic data set subsystem 104 is configured to construct a synthetic population based on an actual population of interest for the situation being represented. Throughout much of the present disclosure, the synthetic population is discussed as representing a population of human beings in a particular geographic area. However, it should be appreciated that, according to various embodiments, the synthetic population may represent other types of populations, such as other living organisms (e.g., insects, plants, etc.) or objects (e.g., vehicles, wireless communication devices, etc.). Synthetic data set subsystem 104 may be used to represent populations including hundreds of millions to billions of interacting entities or individuals. Once a synthetic population has been constructed, synthetic data set subsystem 104 may utilize data from one or more different data sources to construct a detailed dynamic representation of a situation. The data sources utilized in constructing the representation may be dependent upon the situation being analyzed.

Surveillance subsystem 106 is configured to collect and process sensor and/or surveillance information from a variety of information sources (e.g., surveillance data, simulations, expert opinions, etc.) for use in creating and/or modifying the synthetic data set. The data may be received from both proprietary (e.g., commercial databases, such as those provided by Dun & Bradstreet) and publicly available sources (e.g., government databases, such as the National Household Travel Survey provided by the Bureau of Transportation Statistics or databases provided by the National Center for Education Statistics). Surveillance subsystem 106 may be used to integrate and/or classify data received from diverse information sources (e.g., by the use of voting schemes). Standard classification schemes used in machine learning and statistics (e.g., Bayes classifiers, classification and regression trees, principal components analysis, support vector machines, clustering, etc.) may be used by surveillance subsystem 106 depending on the desired application. In some embodiments, surveillance subsystem 106 may allow the flexibility to utilize new techniques developed for a specific application. The data collected and processed by surveillance subsystem 106 may be used by synthetic data set subsystem 104 and/or other subsystems of system 102 to create, modify, and/or manipulate the synthetic data set and, accordingly, the situation representation. Synthetic data set subsystem 104 may in turn provide cues to surveillance subsystem 106 for use in orienting surveillance and determining what data should be obtained and/or how the data should be processed.

Decision analysis subsystem 108 is configured to analyze various possible courses of action and support context-based decision making based on the synthetic data set, social contact network and/or situation representation created by synthetic data set subsystem 104. Decision analysis subsystem 108 may be used to define a scenario and design an experiment based on various alternatives that the user wishes to study. The experiment design is utilized by the other subsystems of system 102, including synthetic data set subsystem 104, to build and/or modify the synthetic data set (including, e.g., the synthetic population) and construct the social contact network used to represent the situation. Decision analysis subsystem 108 uses information related to the synthetic data set and/or situation representation received from synthetic data set subsystem 104 to support decision making and analysis of different possible courses of action. Experiment design, decision making, analysis of alternatives, and/or other functions of decision analysis subsystem 108 may be performed in an automated fashion or based on interaction with and input from one or more users of system 102.

In some embodiments, various subsystems of system 102 may utilize one or more case-specific models provided by case modeling subsystem 110. Case modeling subsystem 110 is configured to provide models and/or algorithms based upon the scenario at issue as defined by decision analysis subsystem 108. According to various embodiments, example case models may be related to public health (e.g., epidemiology), economics (e.g., commodity markets), computing networks (e.g., packet switched telecommunication networks), civil infrastructures (e.g., transportation), and other areas. In some embodiments, portions of multiple case models may be used in combination depending on the situation the user desires to represent.

FIG. 39A shows a flow diagram illustrating the flow and structure of information using system 102, according to at least one example embodiment. At block 202, unstructured data is collected by surveillance subsystem 106 for use in forming the desired situation representation. The data may be collected from various proprietary and/or public sources, such as surveys, government databases, proprietary databases, etc. Surveillance subsystem 106 processes the information into a form that can be utilized by synthetic data set subsystem 104.

At block 204, synthetic data set subsystem 104 receives the unstructured data, provides context to the data, and creates and/or modifies a synthetic data set, including a synthetic population data set, and constructs a social contact network used to form the desired situation representation. Synthetic data set subsystem 104 may provide context to the unstructured data using various modules that may be based on, for example, properties of the individuals or entities that comprise the synthetic population, previously known goals and/or activities of the members of the synthetic population, theories regarding the expected behavior of the synthetic population members, known interactions between the synthetic population members, etc. In some embodiments, unstructured data obtained from multiple sources may be misaligned or noisy and synthetic data set subsystem 104 may be configured to use one or more behavioral or social theories to combine the unstructured data into the synthetic data set. In various embodiments, synthetic data set subsystem 104 may be configured to contextualize information from at least ten distinct information sources. Synthetic data set subsystem 104 may be configured to construct multi-theory networks, such that synthetic data set subsystem 104 includes multiple behavioral rules that may be utilized by various components of synthetic data set subsystem 104 to construct and/or modify the synthetic data set depending on the situation being represented and the types of interactions involved (e.g., driving behavior, disease manifestation behavior, wireless device use behavior, etc.). Synthetic data set subsystem 104 may also be configured to construct multi-level networks, such that separate types of social contact networks (e.g., transportation networks, communications networks) may be created that relate to distinct types of interactions but are coupled through common synthetic entities and groups. Because context is provided to the unstructured information through the use of behavioral theories and other factors, in some embodiments synthetic data set subsystem 104 may be configured to incorporate information from new data sets into the synthetic data set as they become available for use by system 102. For example, synthetic data set subsystem 104 may be configured to incorporate usage data regarding new wireless communication devices.

Once context has been provided to the unstructured data, the relevant data is integrated into the synthetic data set, which is provided by situational awareness module 104 at block 206. According to various embodiments, the synthetic data set provided at block 206 may be modified (e.g., iteratively) to incorporate further data from surveillance subsystem 106, for example based on experiment features or decisions provided by decision analysis subsystem 108. As further questions are posed via decision analysis subsystem 108 and further data is integrated into the synthetic data set, system 102 may require fewer computing resources to produce a desired situation representation. In some embodiments, the synthetic information resource may be stored or preserved and utilized (e.g., by the same or a different user of system 102) to form representations of other (e.g., similar) situations. In such embodiments, fewer computing resources may be required to create the newly desired situation representation as one or more types of information needed to create the representation may already be incorporated into the previously created synthetic data set.

FIG. 39B shows a flow diagram of a process 220 that may be used by system 102 to construct a synthetic data set. At step 222, system 102 receives input data regarding a target population of interest in forming the desired situation representation. For example, if the desired situation representation relates to the spread of an illness in Illinois, the input data may include information regarding people living in or near the state of Illinois. The input data may be collected by surveillance subsystem 106 and processed for use by synthetic data set subsystem 104. The input data may be any of various types of data received from public and/or proprietary sources. For the purposes of this example embodiment, the input data is data from the U.S. Census.

Synthetic data set subsystem 104 uses the input data to construct a synthetic population based on the received input data (step 224). The synthetic population includes a plurality of interacting synthetic entities, which may be living organisms (e.g., humans, animals, insects, plants, etc.) and/or inanimate objects (e.g., vehicles, wireless communication devices, infrastructure elements, etc.). In some embodiments, the synthetic population may model all entities within an area (e.g., geographic area) of interest, such that each synthetic entity in the synthetic population represents an actual entity in the location (e.g., geographic location) of interest. The synthetic entities may be assigned characteristics based on information reflected in the input data. In the example noted above, wherein the synthetic entities represent human beings and the input data is data from the U.S. Census, the demographic data reflected in the U.S. Census may be used to generate the synthetic population (e.g., age, income level, etc.).

The synthetic entities may also be placed in one or more blocks or groups with other synthetic entities. For example, synthetic entities representing human beings may be placed in households with other synthetic entities based on the census data. The households may be placed geographically in such a way that the synthetic population reflects the same statistical properties as the underlying census data (i.e., the synthetic population is statistically indistinguishable from the census data). Because the synthetic population is composed of synthetic entities created using census demographic data and not actual entities or individuals, the privacy and security of the actual entities within the population of interest can be protected. In other embodiments, the synthetic entities may be grouped into other types of synthetic blocks or groups based on characteristics other than household membership (e.g., genus, species, device type, infrastructure type, etc.). In some embodiments, a synthetic data set may not previously exist and synthetic data set subsystem 104 may create a new synthetic data set including the constructed synthetic population. In other embodiments, a previously existing synthetic data set may be modified to include part or all of the created synthetic population.

System 102 may also obtain or receive a set of activity or event templates including activity data for entities or groups of entities in the target population (step 226). For example, activity templates related to a human population may include activity data for households in the geographic area of interest. The activity templates may be based on information from one or more sources, such as travel surveys collected by the government, marketing surveys (e.g., proprietary surveys conducted by marketing agencies), digital device tracking data (e.g., cellular telephone or wireless communication device usage information), and/or other sources. The activity data may be collected and processed by surveillance subsystem 106 and used by synthetic data set subsystem 104 to construct or modify a social contact network based on the synthetic population. In some embodiments, data may be collected from multiple sources, which may or may not be configured to be compatible with one another, and surveillance subsystem 106 and/or synthetic data set subsystem 104 may be configured to combine and process the data in a way that may be used by synthetic data set subsystem 104 to create and/or modify the synthetic data set. The activity templates may describe daily activities of the inhabitants of the household and may be based on one or more information sources such as activity or time-use surveys. The activity templates may also include data regarding the times at which the various daily activities are performed, priority levels of the activities, preferences regarding how the entity travels to the activity location (e.g., vehicle preference), possible locations for the activity, etc. In some embodiments, an activity template may describe the activities of each full day (i.e., 24 hours) for each inhabitant of the associated household in minute-by-minute or second-by-second detail.

Once the activity templates are received, synthetic data set subsystem 104 matches each synthetic group (e.g., household) with one of the survey groups (e.g., survey households) associated with the activity templates (step 228). The synthetic groups may be matched with survey groups (e.g., using a decision tree) based on information (e.g., demographic information) contained in the input data (e.g., census data) and information from the activity surveys (e.g., number of workers in the household, number of children in the household, ages of inhabitants, etc.). Synthetic data set subsystem 104 then assigns each synthetic group the activity template of its matching survey group.

Once activity templates have been assigned to each synthetic group, a location is assigned for each synthetic group and each activity reflected in the synthetic group's activity template (step 230). The locations may be assigned based on observed land-use patterns, tax data, employment data, and/or other types of data. Locations may be assigned in part based on an identity or purpose of the activity, which, in the example where the synthetic population represents a human population, may include home, work, and school or college, shopping, and/or other identities. Locations for the activities may be chosen using data from a variety of databases, including commercial and/or public databases such as those from Dun & Bradstreet (e.g., for work, retail, and recreation locations) and the National Center for Educational Statistics (e.g., for school and college locations). In some embodiments, the locations may be calibrated against observed travel-time distributions for the relevant geographic area. For example, travel time data in the National Household Travel Survey may be used to calibrate locations. Once locations for each activity have been determined, an activity schedule is generated for each synthetic entity describing the activities of the synthetic entity, including times and locations (step 232). The activity templates and/or activity schedule may be based in part on the experiment and/or desired situation representation. The synthetic data set may be modified to include the activity schedules, including locations.

In some embodiments, system 102 may be configured to receive further data based on the desired situation representation (step 234). Referring to the example above, if the desired situation representation is related to spread of an illness in Illinois, the further data may include information regarding what areas of Illinois have recorded infections, what the level of infection is in those areas, etc. The received further data may be used to modify, or add information to, the synthetic data set (step 236). In various embodiments, steps 234 and 236 may be repeated one or more times (e.g., iteratively) to integrate additional information that is relevant to the desired situation representation into the synthetic data set. At step 238, a social contact network (e.g., represented as a graph) may be created based on the entities and interactions reflected in the synthetic data set. The resultant social contact network can be used to model the desired situation representation such that appropriate decisions can be made using decision analysis subsystem 108.

FIG. 39C shows an example of the flow of information described in FIGS. 39A and 39B using system 102, according to at least one example embodiment. The example shown in FIG. 39C is a possible flow of information to create a synthetic data set. FIG. 39C illustrates several example input data sets 250 that may be used by system 102 to construct a synthetic data set, including a synthetic population. FIG. 39C also illustrates several example modules 252 (e.g., software modules) that may be used by system 102 to manipulate the input data sets and integrate the input data into the synthetic data set. Modules 252 may be a part of synthetic data set subsystem 104, case modeling subsystem 110, or other components of system 102. FIG. 39C also illustrates several output data sets 254 that may result from processing performed by modules 252 on input data sets 250. One or more of output data sets 254 may in turn be utilized by various modules 252 to form and/or further modify the synthetic data set. Each of output data sets 254 may be saved as separate data files or as part of the synthetic data set, such that previous experiments directed to similar questions may require fewer calculations to generate the desired situation representation.

In the example shown in FIG. 39C, census data 256 is used by population synthesizer 258 to form a synthetic population 260 for the relevant geographic area. In other embodiments, the data used by population synthesizer 258 to form synthetic population 260 may include marketing surveys, satellite images, and other data. The information included in census data 256 may include demographic data such as income, age, occupation, etc. that may be used by population synthesizer to assign each synthetic entity to a synthetic group or block. For example, synthetic entities representing people may be assigned to synthetic households based on land use data (e.g., value of house, type of house, such as single-family, multi-family, etc.).

Activity generator 264 then uses synthetic population 260 and traveler survey data 262 to form activity schedules 266 for each of the synthetic entities in the synthetic population. Traveler survey data 262 may include surveys conducted by government entities and may include activity participation and travel data for all members of households in the target area. In other embodiments, activity generator 264 may use other data, such as marketing surveys (e.g., commercial surveys conducted by marketing firms), digital device tracking data (e.g., usage data regarding wireless communication devices), and other information to create activity schedules 266. In some embodiments, activity generator 264 may also utilize location information to construct activity schedules 266, such as locations of activities (e.g., including land use and/or employment information). The location information may be included as part of census data 256, traveler survey 262, or one or more other data sources. In various embodiments, activity schedules 266 may be assigned to synthetic entities based on synthetic groups to which the synthetic entities belong. Activity generator 264 is also configured to assign a location to each activity in each activity schedule 266. Locations may be assigned using various methods. One method is to utilize a distance-based distribution that accounts for the reduction in likelihood that an activity location is accurate the further away from an anchor location (e.g., home, work, school, etc.) it is. Locations may be assigned using an iterative process, wherein locations are assigned to activities and compared to the activity time data in the relevant activity schedule 266 to determine if the time needed to travel between locations matches time data reflected in the activity schedule 266. If not, locations may be reassigned iteratively until the time data matches. Synthetic population 260 and activity schedules 266 may be integrated as part of a synthetic data set.

Additional modules are provided in FIG. 39C that are directed to modifying the synthetic data set and/or producing additional output data sets 254. Route planner 270 is configured to receive information from activity schedules 266, transit usage data 268, and transportation network data 274 and generate vehicle data 272 (e.g., vehicle ownership information for each synthetic individual and/or synthetic group) and traveler plans 278 (e.g., information regarding the travel behavior of or travel routes used by each of the synthetic entities in the synthetic population to fulfill the activities reflected in activity surveys 266). According to one embodiment, the transit usage data may include survey data obtained from a publicly available source (e.g., administrative data from a government source) and may include, for example, data regarding transit activity and usage in the relevant geographic area, such as type of transit used, time of day transit is used, average commute time, average delay due to traffic, and other data. Transportation network data 274 may also include data obtained from a publicly available source (e.g., a U.S. Department of Transportation or Bureau of Transportation Statistics database), and the data may include, for example, streets databases, transit density and type information, traffic counts, timing information for traffic lights, vehicle ownership surveys, mode of transportation choice surveys and measurements, etc. Traveler plans 278 produced by route planner 270 may include, for example, vehicle start and finish parking locations, vehicle path through transportation network 274, expected arrival times at activity locations along the path, synthetic entities present in the vehicle at one or more points along the path, transit mode changes (e.g., car to bus), and/or other information. In one embodiment, route planner 270 may be configured to generate traveler plans 278 that may be multi-modal, such that a synthetic entity may use multiple modes of transportation to arrive at various activities reflected in activity survey 266 (e.g., a car to take a child to school, a train to get to and from work, and a car to shop).

Traffic simulator 276 is configured to use information from vehicle data 272, traveler plans 278, transit data 268, and transportation network 274 to generate a traffic simulation 284 (e.g., a time-dependent simulation of traffic for the relevant geographic area). Traffic simulation 284 may simulate the flow of traffic over the entire range of times reflected in activity surveys 266 or a portion of the time range. In one embodiment, traffic simulator 276 may be configured to simulate traffic on a second-by-second basis. Traffic simulator 276 is configured to generate traffic simulation 284 based on the detailed travel routes reflected in traveler plans 278, which in turn are based in part on activity schedules 266, such that traffic simulation 284 simulates traffic conditions based on transit patterns related to the activities of each synthetic individual reflected in activity schedules 266. Traffic simulator 276 may be configured to check the generated traffic simulation 284 against transit information from transit data 268 and/or transportation network 274 to determine the reasonableness and/or accuracy of the simulation. For example, traffic simulator 276 may check the amount of traffic in a particular area at a particular time reflected in traffic simulation 284 against traffic count information received from transportation network 274. If the values produced using the simulation are not comparable to the corresponding traffic counts for the relevant area, route planner 270 may be configured to generate a different set of traveler plans 278. In one embodiment, the traveler plan generation and traffic simulation process may be repeated until the traffic simulation 284 corresponds to the information from transit data 268 and transportation network 274 within a given (e.g., user-specified) tolerance.

FIG. 39D shows an example flow of information that may be used to allocate portions of wireless spectrum, according to at least one example embodiment. As shown, the example embodiment of FIG. 39D is an extension of the example embodiment shown in FIG. 39C. The embodiment shown in FIG. 39D may be used, for example by the Federal Communications Commission (“FCC”), to allocate portions of a limited wireless spectrum, such as the radio frequency spectrum.

Session generation module 287 is configured to generate a time and location-based representation of demand for spectrum. Session generation module 287 is configured to receive session input data 286 and utilize the input data, together with the synthetic data set created by the example embodiment shown in FIG. 39C, to simulate the spectrum demand. Session generation module 287 may receive device ownership data in session input data 286 describing the types of devices owned by members of the target population (e.g., cell phones) and assign devices to entities in the synthetic population based on information (e.g., age, income level, etc.) contained in the device ownership data. In one embodiment, the device ownership data may be a survey such as the National Health Interview Survey collected by the Centers for Disease Control and Prevention. Session input data 286 may also contain data regarding call sessions (e.g., call arrival rate, call duration, etc.) for each cell in the relevant geographic area. A cell may be defined for each tower serving spectrum in the geographic area and may be based on the coverage area of the associated tower. The call session data included in session input data 286 may be aggregated data for each cell. Using the call session data, session generation module 287 may generate and assign call sessions, including times, to entities in the synthetic population. Session input data 286 may also include spatial or geographic data regarding each of the cells in the geographic area, which session generation module 287 may use, together with data from transportation network 274 and/or activity location data from the synthetic data set, to determine call volumes for each service providers tower in the geographic area. The call volumes may be used by session generation module 287 to generate a simulation of the spectrum demanded at each tower, which is provided in spectrum demand simulation 288.

Market simulation module 291 is configured to utilize the generated spectrum demand simulation 288 to determine a proposed spectrum license allocation 292. Market simulation module 291 may receive input data from clearing data 289. Clearing data 289 may include market clearing mechanism data describing the market clearing mechanism(s) (e.g., auction, Dutch auction, ascending bid auction, etc.) used by the supplier to allocate spectrum. Clearing data 289 may also include physical clearing mechanism data describing any physical clearing mechanisms used to address physical limitations to spectrum allocation (e.g., frequency interference between adjacent cells). Market simulation module 291 may also receive information from market rules data 290. Market rules data 290 may include information regarding requirements of one or both of the supplier(s) (e.g., the FCC) and the service provider(s) (e.g., cellular voice and data service providers, radio stations, television stations, etc.) regarding the use of the spectrum. Market simulation module 291 may utilize the spectrum demand simulation 288, clearing data 289, and market rules data 290 to generate a proposed spectrum license allocation 292 that allocates the available spectrum in an efficient manner.

FIG. 40 shows a hierarchical block diagram 300 illustrating components of synthetic data set subsystem 104, according to at least one example embodiment. According to the example embodiment shown in FIG. 40, synthetic data set subsystem 104 includes a management module 305, a population construction module 310, and a network construction module 315. Management module 305 is generally configured to manage the flow of information in synthetic data set subsystem 104 and direct construction of the desired situation representation. Population construction module 310 is configured to construct and/or modify a synthetic population representing entities in a population of interest in creating the desired situation representation. Network construction module 315 is configured to generate a social contact network (e.g., represented as a graph, such as a hypergraph) based on the interactions between synthetic entities in the synthetic population and to measure and analyze the generated network.

Management module 305 is configured to manage the flow of information in synthetic data set subsystem 104 and organize the construction of a synthetic data set for use in creating a desired situation representation. In various embodiments, the use of management module 305 and/or other components of system 102 may be based on the use of service-oriented architectures. Service-oriented architectures provide a flexible set of services that may be used by multiple different kinds of components and applications. Service-oriented architectures allow different components of system 102 to publish their services to other components and applications. The use of service-oriented architectures may provide for improved software reuse and/or scalability of system 102.

In the illustrated example embodiment, management module 305 controls the flow of information through the use of different types of brokers. Brokers are software modules, or agents, that operate with a specific purpose or intent. In some embodiments, the brokers may be algorithmic (i.e., implemented as high level abstractions rather than as ad hoc constructions that are used in grid-based computing systems). The two primary types of brokers utilized to manage the flow of information are edge brokers 345 and service brokers 350. Edge brokers 345 mediate access to a particular resource (e.g., simulation, data, service, etc.) so that resources need not communicate directly with one another. Service brokers 350 receive high-level requests (e.g., a request for data) and spawn any edge brokers 345 needed to service the requests. If information is required to fulfill a request that is not immediately available to an edge broker 345 (e.g., results of a simulation, data from another database, etc.), a new service broker 350 may be spawned to produce the required information. Multiple service brokers 350 may collaborate to solve a larger problem requiring the utilization of a variety of resources. In some embodiments, service brokers 350 may also provide a resource discovery function, locating resources needed to fulfill a request (e.g., data, resources, models or simulations, etc.).

In various embodiments, brokers may be used to solve a problem or access resources that span across many organizations and locations. If all communication occurs between brokers rather than directly between services, users need not have knowledge of the entire problem being addressed or be aware of or have access to all resources needed to solve the problem. In some embodiments, by using a trusted third party to host the computation, one user or organization may provide a proprietary model that uses proprietary data from a second party without either organization needing to have a trust relationship with the other.

Edge brokers 345 and service brokers 350 may have a number of components. Both edge brokers 345 and service brokers 350 may have an information exchange on which data and requests may be placed for sharing with other brokers and/or applications. An information exchange accepts requests for service and offers the service. If a preexisting edge broker 345 is capable of fulfilling the request, that edge broker 345 may offer to fulfill the request and may be selected by the information exchange. If no preexisting edge broker 345 offers to fulfill the request, one or more new brokers may be spawned to fulfill the request. The spawned, or child, broker (e.g., an edge broker) obtains specifications for the required information from the information exchange of the parent broker (e.g., a service broker), and returns results by writing to the parent broker's information exchange. The information exchange of an edge broker 345 allows data and requests to be shared among all applications served by the edge broker 345. The information exchange of a service broker 350 may be shared among all edge brokers 345 connected to the service broker 350, such that all connected edge brokers 345 can directly share information via the information exchange of service broker 350.

Edge brokers 345 may also have additional components. Edge brokers 345 may have an edge broker interface that provides a universal interface for querying and using the services and/or applications that are made available through the edge brokers 345. Edge brokers 345 may also have a service wrapper that allows legacy applications to be used within the framework of management module 305 by taking requests from the information exchange, formatting them in a way that the application can understand, requesting computational resources, running the application using the resources, gathering the results of the application, and making the results available on the information exchange. Edge brokers 345 may further include a service translator that allows applications that are not able to access the information exchange to be used within the framework of management module 305 by translating requests from the information exchange into service calls and placing the results of the service calls on the information exchange. Further, edge brokers 345 may include one or more user interfaces configured to provide direct access (e.g., user access) to the applications served by the broker. The user interfaces may be specific to the purpose of the broker or associated applications. In some embodiments, user interfaces may be provided for some edge brokers 345 and not provided for others.

FIG. 41A shows a flow diagram illustrating an example data retrieval and broker spawning process 400, according to at least one example embodiment. In an initial step, a request is made (e.g., for access to particular data) by a requirer 402. An edge broker 404 responds to the request and collects certain data relevant to the request that it is able to access. Edge broker 404 determines that it is unable to access certain information required to complete the request and spawns service broker 406 to retrieve the required information that it is unable to access. Service broker 406 spawns an edge broker 408 to run a simulation needed to complete the request. In order to run the simulation, edge broker 408 requires information from sources to which it does not have access and, accordingly, edge broker 408 spawns service broker 410 to retrieve the needed information. Service broker 410 in turn spawns edge brokers 412 and 414 to collect the information and write it to the information exchange of service broker 410.

In addition to the simulation results provided by edge broker 408, service broker 406 determines that additional data is needed to complete the request. In some embodiments, management module 305 may include coordination brokers that may spawn one or more service brokers and provide even higher-level coordination than service brokers for fulfilling requests. In the example shown in FIG. 41A, service broker 406 spawns a coordination broker 416, which in turn spawns two service brokers 418 and 422 to collect the required information. Service brokers 418 and 422 spawn edge brokers 420 and 424, respectively, to retrieve the remaining information.

FIGS. 41B-41D show, respectively, three example broker structures illustrating different ways of partitioning information using brokers, according to example embodiments. In the example structure 440 shown in FIG. 41B, an edge broker 442 spawns a service broker 444, which in turn spawns two edge brokers 446 and 448. Service broker 444 is the parent of edge brokers 446 and 448 and has access to all the information resources available to edge brokers 446 and 448. The example structure 460 shown in FIG. 410 includes the same edge brokers 442, 446, and 448 and service broker 444 as in structure 440 and also includes a service broker 462. However, in structure 460 service broker 444 is only the parent of edge broker 446. Edge broker 446 spawns service broker 462, which in turn spawns edge broker 448. In structure 460, service broker 462 has access to all the information resources available to edge broker 446 but does not have access to the information resources of edge broker 448. Service broker 462, the parent of edge broker 448 in structure 460, has access to the information resources of edge broker 448. The example structure 480 shown in FIG. 41D includes the same brokers as in FIG. 410 and also includes a coordination broker 482. Service broker 444 spawns edge broker 446 and also spawns coordination broker 482. Coordination broker 482 spawns service broker 462, which spawns edge broker 448. In structure 480, coordination broker 482 and service broker 462 have access to all of the information resources available to edge broker 448, but service broker 444 does not have access to the information resources available to edge broker 448 except as they may be represented to service broker 444 by coordination broker 482. As can be seen from comparison of structures 440, 460, and 480, access to information resources can be controlled and partitioned in different ways based on the relationship between brokers and how brokers are spawned.

FIG. 41E shows a diagram of a control structure 490 relating to management module 305, according to at least one example embodiment. Control structure 490 includes a management module level 492, a grid middleware level 494, a computation and data grid level 496, and a machine resource level 498. As shown in control structure 490, edge brokers at management module level 492 interact with grid middleware in grid middleware level 494 to provide access to information resources. Grid middleware utilized by the edge brokers may include Globus, CondorG, Narada, etc. Edge brokers may also interact directly with lower-level resources, such as computational and/or data resources in computation and data grid level 496 or physical machine resources in machine resource level 498.

According to different embodiments, communication can be performed in different ways, depending on the performance needed and the quantity of data to be exchanged. In one embodiment, exchange of data can be mediated completely through levels of brokers, following the interaction paths shown in the examples above. If higher performance is needed, edge brokers connected to the same service broker may be allowed to directly access the service brokers information exchange, allowing data to be placed on or retrieved from the information exchange with no intermediate steps. If higher performance yet is desired, a service address may be communicated between two components and the components may use the service to directly exchange data. The service may be a web service, a communication protocol such as HTTP or FTP, a specialized protocol designed to transfer large amounts of data, or another type of service. The components may use the service to negotiate a communication protocol that they both understand.

Referring back to FIG. 40, management module 305 may also include several types of brokers directed to specific purposes. Management module 305 may include one or more data brokers 355 to manage data utilized by management module 305, including storing, retrieving, organizing, and/or cataloguing the data. Data broker 355 may interact with any broker requiring access to data associated with management module 305. Data broker 355 may offer general interfaces (e.g., where data can be accessed without prior knowledge of data location, organization, storage method, format, etc., such as through using exchanges of metadata with the client) and/or specific interfaces (e.g., an SQL query to a relational database) to access data.

Data broker 355 may include a request component that provides a user interface that can be used to interact with management module 305 data. In one embodiment, the user interface is a graphical user interface provided in a web browser that allows a user to browse, select, modify, and store data. Input may be provided via a form (e.g., an HTML form) submitted via the web browser, and output may include forms submitted back to the user via the web browser and requests submitted to a data service component of data broker 355, discussed below, via the information exchange of data broker 355.

Data broker 355 may also include a data service component that serves as a database-type-specific manager for management module 305 data. The data service component may service both database-independent and database-specific requests. Each data broker 355 may require a separate data service component for each type of database being serviced by the data broker 355. For example, if a data broker 355 is configured to service both relational databases and XML repositories, the data broker may require at least two separate data service component instances. The data service component may receive requests for data, metadata, data updates, etc. and provide response submissions, requested data, metadata, data modifications, etc. Output data may be placed in a database table, placed in a URL, provided directly to a user's web browser, or stored and/or communicated in another way.

Management module 305 may also include one or more data set construction brokers 360 configured to construct and manage input data sets used by management module 305. Data set construction may include at least three phases: (1) identifying data for extraction/modification, (2) for selected data, performing data set-specific construction operations and extracting subsets of the selected data, and (3) for selected data, outputting resultant data sets. The first two phases may be generally applicable to all tasks addressed by data set construction broker 360. In some embodiments, the third phase may be application-specific and may be determined at least in part based on the needs of the desired application.

In some embodiments, data set construction broker 360 may provide interactive and automated capabilities in which new behavior can be acquired by recording and abstracting sequences of interactive operations. First, users may interactively explore available data, extract data, create or modify data operations, develop chained operation sequences, save result data subsets for future use, and/or perform other tasks. Further, scripts may be selected from a catalogued library, automating the data set creation process. Additionally, an automated template generation component may be activated whereby sequences of interactive operations are recorded, aggregated into scripts, parameterized for more general use, and catalogued in a library.

Data set construction broker 360 may include a request component through which a user may interact with and/or manipulate management module 305 input data sets. The request component of data set construction broker 360 may share properties similar to that of data broker 355 (e.g., web browser interface). The request component may also include subcomponents such as a database request subcomponent, a broker-specific request subcomponent, a script request subcomponent, and a data extraction request subcomponent. The database request subcomponent is configured to provide an interface to guide a user through building database-independent requests for data and/or data updates. In some embodiments, the database request subcomponent may utilize database metadata provided through a web browser interface to build the requests. The broker-specific subcomponent is configured to provide data set-specific user interfaces for data set construction (e.g., customized based on the input data, such as transportation-related data, epidemic-related data, etc.). The script request subcomponent is configured to provide control of generation and parameterization of data set construction scripts. The data extraction request subcomponent is configured to work with other subcomponents to facilitate generation of chained sequences of database operations to construct a management module 305 input data set. Data set construction broker 360 may also include a core service component, including subcomponents (e.g., database service, broker-specific service, script service, or data extraction service) directed to processing requests received from the subcomponents of the request component of data set construction broker 360.

Management module 305 may further include one or more entity brokers 365 configured to assist in the creation and modification of the synthetic population. Entity broker 365 functions as an edge broker for accessing services of population construction module 310. Entity broker 365 has knowledge of and access to the services of population construction module 310 and publishes those services on its information exchange. Entity broker 365 includes the same components of an edge broker (e.g., information exchange, interface, service translator, service wrapper, etc.) and may also include specialized components for managing interactions between management module 305 and population construction module 310. Greater detail regarding population construction and modification is provided below with reference to the components of population construction module 310.

Management module 305 may include further specialized brokers as needed to perform various functions of management module 305. In various embodiments, management module 305 may include one or more model brokers 370 configured to provide access to models and simulations, one or more resource brokers 375 configured to manage requests for computational resources, and/or one or more security brokers 380 configured to provide security (e.g., authentication and authorization) services within management module 305.

Population construction module 310 is configured to construct and/or modify the synthetic population used by management module 305, network construction module 315, and/or other components of synthetic data set subsystem 104 to create the desired situation representation. The synthetic population includes synthetic entities that may represent entities in a real geographic area (e.g., the United States) or a virtual universe. Each synthetic entity has a set of characteristics or attributes that may be assigned based on information from one or more input data sets (e.g., the U.S. Census). Each synthetic entity may be assigned to one or more subpopulations of the synthetic population (e.g., military unit, factory workers for a specific factory, students or teachers at a specific school, etc.). Further, each synthetic entity may be associated with a sequence of actions that may define what the actions are and where and when the actions occur. The interactions between synthetic entities in the synthetic population may be based at least in part on the activity sequences of the synthetic entities. Population construction module 310 receives requests from management module 305 and responds to the requests through one or more entity brokers. Population construction module 310 may also utilize external data (e.g., received from surveillance subsystem 106) and/or information about the experiment or desired situation representation (e.g., received from management module 305 and/or decision analysis subsystem 108) in constructing and modifying the synthetic population. In one embodiment, all information required to generate the synthetic population may be collected via entity brokers.

Population construction module 310 may include several component modules. Population generation module 320 is configured to generate the synthetic population for use in constructing the desired situation representation. Population generation module 320 may be configured to construct the synthetic population by performing steps shown in FIG. 39B (e.g., steps 222 through 232). External input data used to initially construct the synthetic population (e.g., define the synthetic entities that comprise the synthetic population) may be based upon the type of synthetic population being constructed. For example, synthetic population representing a population of humans may be derived from census data, survey data, etc. Attributes assigned to each synthetic entity may also be based upon the population type. A synthetic human population derived from census or marketing data may be assigned attributes such as age, income, vehicle ownership, gender, education level, etc. A synthetic insect population may be assigned attributes such as genus and genotype. Synthetic entities may be assigned to one or more groups, which may also be dependent upon the type of population. For example, synthetic entities in a synthetic human population may be grouped by household, occupation, communication device ownership, income level, etc. Synthetic entities in a synthetic plant population may be grouped by genetic modification or growth requirements. Synthetic entities in a synthetic insect population may be grouped by resistance to a particular insecticide or probability to transmit a disease.

Population generation module 320 may also assign activity templates and generate activity schedules in a manner similar to that described above with respect to FIG. 39B (e.g., steps 226 through 232). Activity sequence assignments may be made based on attributes of the synthetic entities in the synthetic population, group memberships of the synthetic entities, external data, random assignments, and/or other methods. Activity sequences may provide start times, durations and/or end times, and locations for each of the actions in the sequences. The locations may include geographic coordinates (e.g., an absolute identifier) in a real or virtual coordinate system or a location identifier (e.g., a relative identifier) that has meaning in the universe of the population.

Population editing module 325 is configured to modify and/or add information about synthetic entities in the synthetic population. Requests for modification may be made by management module 305 and conveyed to population editing module 325 by an entity broker. Based on a request, population editing module 325 may select one or more entities or groups from the synthetic population and add or modify attributes of the selected entities or groups. Population editing module 325 may utilize external data and/or scenario information in interpreting the requests and/or modifying the attributes.

Subpopulation module 330 is configured to define subpopulations from the synthetic population and apply modifications to the subpopulations. In some embodiments, synthetic entities may be members of multiple subpopulations. Subpopulation module 330 receives requests for creation or modification of subpopulations from management module 305 via an entity broker and generates a modification plan (e.g., sets of modifications to action sequences, attributes, etc.) that can be executed by management module 305, population construction module 310, and/or other modules of synthetic data set subsystem 104. Scenario information and/or external data may be used to process subpopulation requests and/or produce the modification plan.

In one embodiment, subpopulation module 330 may be configured to modify action sequences associated with one or more subpopulations of synthetic entities. The subpopulation to be modified may be based on a function of the demographics or attributes associated with the synthetic population and/or external data that is specific to the scenario being studied. Demographics may include, for example, income, home location, worker status, susceptibility to disease, etc. Examples of external data may include the probability that entities of a certain demographic class take airline trips or whether a specific plot of land has been sprayed with a pesticide. Once the subpopulation to be modified is identified, replacement activity sequences are identified for the subpopulation. The selected replacement activity sequences may be identified from a set of possible replacement activity sequences based on external data and/or information regarding the scenario being studied. Replacement activity sequences may include activities performed in a city other than a home city, military assignments, withdrawal to home during a pandemic, or other activities. In some embodiments, subpopulation module 330 may be configured to define multiple representations of one or more synthetic entities (e.g., having different attributes and/or activity sequences) and to determine which representation to select based on the external data and/or scenario information.

FIG. 42 shows a flow diagram for a process 500 that may be used by population construction module 310 to create and/or modify a synthetic population, according to at least one example embodiment. Process 500 begins with an entity broker monitoring the information exchange (step 505) and listening for requests (step 510). Once the entity broker receives a request, the type of the request is determined (steps 515 and 520). If the request is for a service not provided by population construction module 310, the entity broker posts the request to the information exchanges (step 525) and responds to management module 305 (step 530).

If the request is an entity request, or a request for a service provided by population construction module 310, it is determined whether the synthetic population and/or synthetic entity associated with the request already exists (step 535). If not, population generation module 320 generates the synthetic population and/or synthetic entity (step 540) and proceeds to step 545. If the synthetic population and/or synthetic entity already exists, process 500 proceeds to step 545. At step 545, it is determined whether the request is to modify the synthetic population. If the request does not include modifying the synthetic population, the desired information about the population is provided and formatted (step 550) and presented to management module 305 (step 530). If the request includes modifying the synthetic population, it is determined whether the creation or modification of a subpopulation has been requested (step 555). If not, population editing module 325 makes any requested changes or additions to the attributes of one or more of the synthetic entities of the synthetic population (step 560), and the entity broker formats the results (step 550) and posts the results to management module 305 (step 530). If the request includes creating or modifying a subpopulation, subpopulation module 330 performs the request subpopulation creation/modification (step 570), and the entity broker formats the results (step 550) and posts the results to management module 305 (step 530).

Referring again to FIG. 40, network construction module 315 is configured to generate a social contact network based on the interactions between synthetic entities in the synthetic population and to measure and analyze the generated network. Network construction module 315 may include a network generation module 335 and a network analysis module 340. Network generation module 335 is configured to generate a social contact network (e.g., represented as a graph such as a hypergraph) based on the interactions between synthetic entities from the synthetic population. The graphs generated by network generation module 335 may be time-dependent or static projections of time-dependent graphs. Each vertex of the graphs represents an entity related to the interactions between entities of the synthetic population and can be linked to attributes, group assignments, actions sequences, and/or other characteristics associated with the entity. Each edge of the graphs represents an interaction between synthetic entities and can be linked to an action from which it is derived. Network generation module 335 may also be configured to translate the desired situation representation into a mathematical specification of the simulation associated with the situation and generate the graph based on the mathematic specification of the simulation. Network generation module 335 may utilize entity brokers and/or other brokers to obtain population information and publish information about the generated graphs.

In one example embodiment, the situation being represented may relate to determining participation in a cellular phone connection. The vertices of the resulting graph may represent people, locations, and cellular towers. Edges may connect all vertices representing people on a particular cellular phone call, locations of those people, and cellular towers involved in the call.

Network analysis module 340 is configured to compute structural measurements on the graphs generated by network generation module 335. Types of measurement methods may include degree distribution, RO-distribution, shortest path distribution, shattering, expansion, betweenness, etc. The measurements performed by network analysis module 340 provide quantitative methods to compare different graphs and, accordingly, different situation representations (e.g., corresponding to different decisions and/or different action choices presented in decision analysis subsystem 108). The measurements may require less computational power than performing a complete simulation and may allow a more efficient understanding of the dynamics of the situation being represented. The measurements performed by network analysis module 340 may be used (e.g., in combination with features of other components of system 102 in some embodiments) to infer statistical and protocol level interactions, rank various (e.g., user-defined) policies in an order, and/or infer any inherent uncertainty in the output.

FIG. 43 shows a sample user interface 600 that may be utilized by a user to interact with system 102 is shown, according to at least one example embodiment. User interface 600 may be one user interface provided with regard to representing the spread of a disease in a particular geographic area. User interface 600 includes several fields that may be used to receive input from the user and/or provide information to the user. Name field 602 allows the user to view and edit the name of the experiment being conducted. Status field 604 presents the current status (e.g., incomplete, completed, etc.) of the experiment. Owner field 606 allows the user to view and edit the owner or creator of the experiment. Description field 608 provides a description of various characteristics of the experiment. Replicate field 610 allows the user to view and edit the number of replicates, or independent computer runs or cycles for a fixed set of input parameters, associated with the experiment. Cell field 612 allows the user to view and edit the number of cells, or scenarios for a specific set of input parameters, associated with the experiment. Time field 614 allows the user to view and edit the amount of time (e.g., number of days) that the experiment covers. Region field 616 permits the user to specify the relevant geographic region for the experiment. Region field 616 may include several predefined geographic regions from which the user can select (e.g., through a drop-down menu). Disease field 618 allows the user to specify the disease or diseases being studied in the experiment. Disease field 618 may include several predefined diseases from which the user can select. Initial conditions field 620 permits the user to select the conditions present at the onset of the experiment and may include several predefined conditions from which the user can select.

Intervention field 622 allows the user to select from one or more available intervention methods to define the methods that are enabled in the experiment. Intervention tabs 624 include tabs for each selected intervention method. In one embodiment, tabs may be displayed for all available intervention methods but only the tabs selected in intervention field 622 may be active. In the displayed example embodiment, the vaccination intervention tab has been selected and a vaccination menu is displayed. The vaccination menu includes a subpopulation field 626 that may be used to select some or all of the subpopulations defined by subpopulation module 330 to receive the defined vaccination intervention. Compliance field 628 allows the user to specify parameters regarding compliance of the selected subpopulation(s) in obtaining vaccinations (e.g., percent of selected entities that obtain vaccination, initial vaccination percentage, final vaccination percentage, etc.). Trigger field 630 allows the user to specify when the vaccination intervention is triggered in the experiment (e.g., the day of the experiment on which the vaccination is provided to the selected subpopulation(s)). Efficacy field 632 permits the user to define how effective the vaccine is in fighting the disease (e.g., percent of selected population for which the vaccine is effective, initial effectiveness, final effectiveness, etc.).

User interface 600 is only one possible interface that may be provided by system 102. A wide variety of options and information may be provided to the user based on the type of experiment being conducted. The user interfaces presented to the user may be modified to include different and/or additional information and options based on the models in case modeling subsystem 110. In some embodiments, users may be permitted to select the level of detail with which to specify the parameters of the experiment (e.g., permit system 102 to define certain parameters of the experiment using default values). Other example user interfaces and components thereof are described herein, e.g., with reference to FIG. 12-27 or 35.

### Example Clauses

Various examples include one or more of, including any combination of any number of, the following example features. Throughout these clauses, parenthetical remarks are for example and explanation, and are not limiting. Parenthetical remarks given in this Example Clauses section with respect to specific language apply to corresponding language throughout this section, unless otherwise indicated.

A: A method comprising (e.g., under control of a processing unit): receiving attributes of a synthetic population (e.g., as or as part of a query, e.g., from a front end); selecting a synthetic-population graph from a data library based at least in part on the attributes, wherein the synthetic-population graph comprises nodes and labeled edges between the nodes (e.g., at least one labeled edge; labels can include, e.g., locations or other items shown in FIG. 36); receiving data of an intervention designed to counteract or mitigate an epidemic; simulating a course of the epidemic in the synthetic-population graph to produce an epidemic estimate (e.g., results for at least one “cell” in FIG. 21 or 23-26), based at least in part on the intervention.

B: The method according to paragraph A, wherein the epidemic estimate comprises at least one of: a curve indicating a number of the nodes marked as infected over the course of the simulation (e.g., an epicurve); an R curve indicating a reproductive number (estimated or actual) of the epidemic over the course of the simulation; a curve indicating a slope of any of the above-described curves as a function of simulation time; an estimated generation time of the epidemic; or an estimated growth rate of the epidemic.

C: The method according to paragraph B, further comprising: receiving second attributes of a second synthetic population (e.g., a subset of the synthetic population); and determining a second epidemic estimate (e.g., results for a subset of the synthetic population that was simulated) based at least in part on the second attributes and the synthetic-population graph.

D: The method according to any of paragraphs A-C, further comprising: determining the epidemic estimate further based at least in part on a first randomization value; and simulating the course of the epidemic in the synthetic-population graph to produce at least one second epidemic estimate, wherein: each second epidemic estimate is determined based at least in part on the intervention and a respective randomization value; and at least one of the respective randomization values is different from the first randomization value (e.g., running replicates).

E: The method according to paragraph D, further comprising causing presentation, via a user interface, of a representation that is based at least in part on: the epidemic estimate; and at least one of the second epidemic estimates.

F: The method according to any of paragraphs A-E, further comprising: receiving data of a second intervention; and simulating the course of the epidemic in the synthetic-population graph to produce a second epidemic estimate based at least in part on the second intervention (e.g., testing multiple interventions).

G: The method according to paragraph F, further comprising causing presentation, via a user interface, of a representation that is based at least in part on: the epidemic estimate; and the second epidemic estimate.

H: The method according to any of paragraphs A-G, wherein: the method further comprises determining a first subset of nodes of the synthetic-population graph, wherein the first subset of nodes represents an initial infected population; and the simulating further comprises: modifying edges of the synthetic-population graph based at least in part on the intervention to produce a modified synthetic-population graph; determining spread of the epidemic in the modified synthetic-population graph based at least in part on a predetermined disease model (e.g., specified by a user or loaded from a database); and determining the epidemic estimate based at least in part on the spread of the epidemic.

I: The method according to paragraph H, further comprising: receiving the data of the intervention via a user interface (e.g., a Web browser); and receiving an indication of the predetermined disease model via the user interface.

J: A method comprising (e.g., under control of a processing unit): receiving attributes of a synthetic population; selecting a synthetic-population graph from a data library based at least in part on the attributes; receiving data of an intervention designed to affect a course of an event (e.g., an extended event that goes on over a period of time, or a point-in-time event with extended consequences); and simulating the course of the event in the synthetic-population graph to produce an estimate of the event, based at least in part on the intervention.

K: The method according to paragraph J, wherein: the synthetic-population graph comprises nodes, edges between at least some of the nodes, and labels associated with at least some of the edges; and the simulating comprises selectively propagating information about consequences of the event (e.g., infection; can include outcomes, results, or changes in event state, e.g., disease progress) along edges of a first subset of the edges based at least in part on at least some corresponding labels of the labels of the synthetic-population graph.

L: The method according to paragraph K, further comprising selectively modifying at least some of the labels of the synthetic-population graph based at least in part on the intervention.

M: The method according to any of paragraphs J-L, wherein: the synthetic-population graph comprises nodes, parameters associated with at least some of the nodes, and edges between at least some of the nodes; and the simulating comprises: determining data of consequences of the event; and selectively modifying at least some of the parameters (e.g., of the entities) based at least in part on the data of the consequences of the event.

N: The method according to any of paragraphs J-M, comprising: receiving a query; and determining at least one first simulation based at least in part on the query, wherein the simulating comprises running the at least one first simulation.

O: The method according to any of paragraphs J-N, wherein simulating comprises: modifying a first subset of nodes of the synthetic-population graph at a first simulated time based at least in part on the intervention and on attributes of nodes of the first subset of nodes; and modifying a second, different subset of nodes of the synthetic-population graph at a second, different simulated time based at least in part on the intervention and on attributes of nodes of the second subset of nodes (e.g., different nodes may change state at different times).

P: The method according to any of paragraphs J-O, further comprising: causing the estimate of the event to be presented via a user interface; receiving second attributes of a second synthetic population (e.g., dynamically; can be a subset of the synthetic population); determining a second estimate of the event based at least in part on the second attributes and on at least one of the estimate of the event or the synthetic population; and causing the second estimate of the event to be presented via the user interface (e.g., dynamically, in response to user controls; see, e.g., FIG. 25 or 26).

Q: A method comprising (e.g., under control of a processing unit): receiving input data associated with a target population; constructing a synthetic data set based on the input data, wherein the synthetic data set includes data of a plurality of synthetic entities corresponding with the target population; assigning entity attributes to individual entities of the plurality of synthetic entities based at least in part on the input data; receiving activity data associated with the target population; generating a social-contact graph by generating graph edges between individual entities of the plurality of synthetic entities based at least in part on corresponding ones of the entity attributes and on the activity data; receiving population attributes of a synthetic population; selecting a synthetic-population graph from the social-contact graph based at least in part on the population attributes; receiving data of an intervention designed to counteract or mitigate an event; and simulating a course of the event in the synthetic-population graph to produce an estimate of the event, based at least in part on the intervention.

R: The method according to paragraph Q, wherein: the synthetic-population graph comprises nodes, parameters associated with at least some of the nodes, and edges between at least some of the nodes; and the simulating comprises: determining data of consequences of the event; and selectively modifying at least some of the parameters based at least in part on the data of the consequences of the event.

S: The method according to paragraph Q or R, further comprising: presenting the estimate of the event via a user interface; receiving second population attributes of a second synthetic population; determining a second estimate of the event based at least in part on the second population attributes and on at least one of the estimate of the event or the synthetic population.

T: The method according to any of paragraphs Q-S, further comprising: in association with at least one of the constructing, the assigning, the generating, or the simulating, generating a request for a service; and fulfilling, by a broker software module, the request for the service; wherein the broker software module is selected from the group consisting of: a data broker configured to manage data used in constructing the synthetic data set; a data set construction broker configured to manage at least one of construction and modification of one or more input data sets; and an entity broker configured to manage at least one of creation and modification of the synthetic population.

U: A computer-readable medium, e.g., a computer storage medium, having thereon computer-executable instructions, the computer-executable instructions upon execution configuring a computer to perform operations as any of paragraphs A-I recites.

V: A device comprising: a processing unit; and a computer-readable medium, e.g., a computer storage medium, having thereon computer-executable instructions, the computer-executable instructions upon execution by the processing unit configuring the device to perform operations as any of paragraphs A-I recites.

W: A system comprising: means for processing; and means for storing having thereon computer-executable instructions, the computer-executable instructions including means to configure the system to carry out a method as any of paragraphs A-I recites.

X: A computer-readable medium, e.g., a computer storage medium, having thereon computer-executable instructions, the computer-executable instructions upon execution configuring a computer to perform operations as any of paragraphs J-P recites.

Y: A device comprising: a processing unit; and a computer-readable medium, e.g., a computer storage medium, having thereon computer-executable instructions, the computer-executable instructions upon execution by the processing unit configuring the device to perform operations as any of paragraphs J-P recites.

Z: A system comprising: means for processing; and means for storing having thereon computer-executable instructions, the computer-executable instructions including means to configure the system to carry out a method as any of paragraphs J-P recites.

AA: A computer-readable medium, e.g., a computer storage medium, having thereon computer-executable instructions, the computer-executable instructions upon execution configuring a computer to perform operations as any of paragraphs Q-T recites.

AB: A device comprising: a processing unit; and a computer-readable medium, e.g., a computer storage medium, having thereon computer-executable instructions, the computer-executable instructions upon execution by the processing unit configuring the device to perform operations as any of paragraphs Q-T recites.

AC: A system comprising: means for processing; and means for storing having thereon computer-executable instructions, the computer-executable instructions including means to configure the system to carry out a method as any of paragraphs Q-T recites.

AD: The device as any of paragraphs V, Y, or AB, wherein the processing unit comprises at least one of: an FPGA, an ASIC, a PLD, a GPU (or GPGPU) and accompanying program memory, or a CPU and accompanying program memory.

### CONCLUSION

Various examples permit flexible, effective simulation an analysis of events such as epidemics. A tested system according to various examples herein achieved the following performance characteristics: (i) Number of concurrent logged users: 50; (ii) Number of Experiments created: 12240; (iii) Number of jobs created: 73440; (iv) Duration of run: 60 minutes; (v) Throughput of web server: 559 requests per minute. A tested system was operated on a 76-node Linux cluster of 1 GHz-class processors. A social-interaction graph or SP graph of the United States can include, e.g., about 300 million nodes and about 10¹²-10¹³ edges.

In a tested example, an experiment was run to study progression of emerging infectious diseases through population networks in the United States. The experiment was a hepatitis simulation to analyze efficacy of interventions using the Epifast algorithm. The disease model was a Hepatitis A virus strain, the region was Chicago (size: 5.5 million individuals), and the duration was 120 days. The example Disease model is set for Hepatitis A viral strain with Transmissibility at 0.00008, indicating the population is at a very high risk of infection. Two interventions were simulated: vaccination and social distancing measures to control disease spread. Vaccine 1 was applied with Compliance 40% and 70% efficacy on Adults. Social Distancing was applied with Compliance swept from 70-90%. Experiments were run with 10 replicates of each cell.

Example data transmissions (parallelograms) and example blocks in the process diagrams herein represent one or more operations that can be implemented in hardware, software, or a combination thereof to transmit or receive described data or conduct described exchanges. In the context of software, the illustrated blocks and exchanges represent computer-executable instructions that, when executed by one or more processors, cause the processors to transmit or receive the recited data. Generally, computer-executable instructions, e.g., stored in program modules that define operating logic, include routines, programs, objects, modules, components, data structures, and the like that perform particular functions or implement particular abstract data types. Except as expressly set forth herein, the order in which the operations or transmissions are described is not intended to be construed as a limitation, and any number of the described operations or transmissions can be executed or performed in any order, combined in any order, subdivided into multiple sub-operations or transmissions, and/or executed or transmitted in parallel to implement the described processes.

Other architectures can be used to implement the described functionality, and are intended to be within the scope of this disclosure. Furthermore, although specific distributions of responsibilities are defined above for purposes of discussion, the various functions and responsibilities might be distributed and divided in different ways, depending on particular circumstances. Similarly, software can be stored and distributed in various ways and using different means, and the particular software storage and execution configurations described above can be varied in many different ways. Thus, software implementing the techniques described above can be distributed on various types of computer-readable media, not limited to the forms of memory that are specifically described.

Conditional language such as, among others, “can,” “could,” “might” or “may,” unless specifically stated otherwise, are understood within the context to present that certain examples include, while other examples do not include, certain features, elements or steps. Thus, such conditional language is not generally intended to imply that certain features, elements or steps are in any way required for one or more examples or that one or more examples necessarily include logic for deciding, with or without user input or prompting, whether certain features, elements or steps are included or are to be performed in any particular example.

The word “or” and the phrase “and/or” are used herein in an inclusive sense unless specifically stated otherwise. Accordingly, conjunctive language such as, but not limited to, at least one of the phrases “X, Y, or Z,” “at least X, Y, or Z,” “at least one of X, Y or Z,” and/or any of those phrases with “and/or” substituted for “or,” unless specifically stated otherwise, is to be understood as signifying that an item, term, etc., can be either X, Y, or Z, or a combination of any elements thereof (e.g., a combination of XY, XZ, YZ, and/or XYZ). Any use herein of phrases such as “X, or Y, or both” is for clarity of explanation and does not imply that language such as “X or Y” excludes the possibility of both X and Y, unless such exclusion is expressly stated. As used herein, language such as “one or more Xs” shall be considered synonymous with “at least one X” unless otherwise expressly specified. Any recitation of “one or more Xs” signifies that the described steps, operations, structures, or other features may, e.g., include, or be performed with respect to, exactly one X, or a plurality of Xs, in various examples, and that the described subject matter operates regardless of the number of Xs present.

Furthermore, although the subject matter has been described in language specific to structural features or methodological acts, it is to be understood that the subject matter defined in the appended claims is not necessarily limited to the specific features or acts described. Rather, the specific features and acts are disclosed as example forms of implementing the claims. Moreover, in the claims, any reference to a group of items provided by a preceding claim clause is a reference to at least some of the items in the group of items, unless specifically stated otherwise.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and are considered to be within the scope of the disclosure.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

It should be noted that the orientation of various elements may differ according to other example embodiments, and that such variations are intended to be encompassed by the present disclosure.

The construction and arrangement of elements shown in the various example embodiments is illustrative only. Other substitutions, modifications, changes, and omissions may also be made in the design and arrangement of the various example embodiments without departing from the scope of the present disclosure.

The present disclosure contemplates methods, systems and program products on any non-transitory (i.e., not merely signals in space) machine-readable media for accomplishing various operations. The embodiments of the present disclosure may be implemented using existing integrated circuits, computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although figures and/or description provided herein may show a specific order of method steps, the order of the steps may differ from what is depicted. Also two or more steps may be performed concurrently or with partial concurrence. In various embodiments, more, less or different steps may be utilized with regard to a particular method without departing from the scope of the present disclosure. Such variation will depend on the software and hardware systems chosen and on designer choice. All such variations are within the scope of the disclosure. Likewise, software implementations can be accomplished with standard programming techniques with rule based logic and other logic to accomplish the various connection steps, processing steps, comparison steps and decision steps.

1. A method comprising, under control of a processing unit:
receiving attributes of a synthetic population;
selecting a synthetic-population graph from a data library based at least in part on the attributes, wherein the synthetic-population graph comprises nodes and labeled edges between the nodes;
receiving data of an intervention designed to counteract or mitigate an epidemic;
simulating a course of the epidemic in the synthetic-population graph to produce an epidemic estimate, based at least in part on the intervention.

2. The method according to claim 1, wherein the epidemic estimate comprises at least one of:
a curve indicating a number of the nodes marked as infected over the course of the simulation;
an R curve indicating a reproductive number of the epidemic over the course of the simulation;
a curve indicating a slope of any of the above-described curves as a function of simulation time;
an estimated generation time of the epidemic; or
an estimated growth rate of the epidemic.

3. The method according to claim 2, further comprising:
receiving second attributes of a second synthetic population; and
determining a second epidemic estimate based at least in part on the second attributes and the synthetic-population graph.

4. The method according to claim 1, further comprising:
determining the epidemic estimate further based at least in part on a first randomization value; and
simulating the course of the epidemic in the synthetic-population graph to produce at least one second epidemic estimate, wherein:
each second epidemic estimate is determined based at least in part on the intervention and a respective randomization value; and
at least one of the respective randomization values is different from the first randomization value.

5. The method according to claim 4, further comprising causing presentation, via a user interface, of a representation that is based at least in part on:
the epidemic estimate; and
at least one of the second epidemic estimates.

6. The method according to claim 1, further comprising:
receiving data of a second intervention; and
simulating the course of the epidemic in the synthetic-population graph to produce a second epidemic estimate based at least in part on the second intervention.

7. The method according to claim 6, further comprising causing presentation, via a user interface, of a representation that is based at least in part on:
the epidemic estimate; and
the second epidemic estimate.

8. The method according to claim 1, wherein:
the method further comprises determining a first subset of nodes of the synthetic-population graph, wherein the first subset of nodes represents an initial infected population; and
the simulating further comprises:
modifying edges of the synthetic-population graph based at least in part on the intervention to produce a modified synthetic-population graph;
determining spread of the epidemic in the modified synthetic-population graph based at least in part on a predetermined disease model; and
determining the epidemic estimate based at least in part on the spread of the epidemic.

9. The method according to claim 8, further comprising:
receiving the data of the intervention via a user interface; and
receiving an indication of the predetermined disease model via the user interface.

10. A method comprising, under control of a processing unit:
receiving attributes of a synthetic population;
selecting a synthetic-population graph from a data library based at least in part on the attributes;
receiving data of an intervention designed to affect a course of an event; and
simulating the course of the event in the synthetic-population graph to produce an estimate of the event, based at least in part on the intervention.

11. The method according to claim 10, wherein:
the synthetic-population graph comprises nodes, edges between at least some of the nodes, and labels associated with at least some of the edges; and
the simulating comprises selectively propagating information about consequences of the event along edges of a first subset of the edges based at least in part on at least some corresponding labels of the labels of the synthetic-population graph.

12. The method according to claim 11, further comprising selectively modifying at least some of the labels of the synthetic-population graph based at least in part on the intervention.

13. The method according to claim 10, wherein:
the synthetic-population graph comprises nodes, parameters associated with at least some of the nodes, and edges between at least some of the nodes; and
the simulating comprises:
determining data of consequences of the event; and
selectively modifying at least some of the parameters based at least in part on the data of the consequences of the event.

14. The method according to claim 10, comprising:
receiving a query; and
determining at least one first simulation based at least in part on the query,
wherein the simulating comprises running the at least one first simulation.

15. The method according to claim 10, wherein simulating comprises:
modifying a first subset of nodes of the synthetic-population graph at a first simulated time based at least in part on the intervention and on attributes of nodes of the first subset of nodes; and
modifying a second, different subset of nodes of the synthetic-population graph at a second, different simulated time based at least in part on the intervention and on attributes of nodes of the second subset of nodes.

16. The method according to claim 10, further comprising:
causing the estimate of the event to be presented via a user interface;
receiving second attributes of a second synthetic population;
determining a second estimate of the event based at least in part on the second attributes and on at least one of the estimate of the event or the synthetic population; and
causing the second estimate of the event to be presented via the user interface.

17. A method comprising, under control of a processing unit:
receiving input data associated with a target population;
constructing a synthetic data set based on the input data, wherein the synthetic data set includes data of a plurality of synthetic entities corresponding with the target population;
assigning entity attributes to individual entities of the plurality of synthetic entities based at least in part on the input data;
receiving activity data associated with the target population;
generating a social-contact graph by generating graph edges between individual entities of the plurality of synthetic entities based at least in part on corresponding ones of the entity attributes and on the activity data;
receiving population attributes of a synthetic population;
selecting a synthetic-population graph from the social-contact graph based at least in part on the population attributes;
receiving data of an intervention designed to counteract or mitigate an event; and
simulating a course of the event in the synthetic-population graph to produce an estimate of the event, based at least in part on the intervention.

18. The method according to claim 17, wherein:
the synthetic-population graph comprises nodes, parameters associated with at least some of the nodes, and edges between at least some of the nodes; and
the simulating comprises:
determining data of consequences of the event; and
selectively modifying at least some of the parameters based at least in part on the data of the consequences of the event.

19. The method according to claim 17, further comprising:
presenting the estimate of the event via a user interface;
receiving second population attributes of a second synthetic population;
determining a second estimate of the event based at least in part on the second population attributes and on at least one of the estimate of the event or the synthetic population.

20. The method according to claim 17, further comprising:
in association with at least one of the constructing, the assigning, the generating, or the simulating, generating a request for a service; and
fulfilling, by a broker software module, the request for the service;
wherein the broker software module is selected from the group consisting of:
a data broker configured to manage data used in constructing the synthetic data set;
a data set construction broker configured to manage at least one of construction and modification of one or more input data sets; and
an entity broker configured to manage at least one of creation and modification of the synthetic population.
